(19) United States
(12) Patent Application Publication
(10) Pub. No.: US 2025/0267750 A1
(43) Pub. Date: Aug. 21, 2025

(54) UE MOBILITY

(71) Applicant: Samsung Electronics Co., Ltd., Suwon-si (KR)

(72) Inventors: Emad Nader Farag, Flanders, NJ (US); Eko Onggosanusi, Coppell, TX (US); Md. Saifur Rahman, Plano, TX (US); Dalin Zhu, Allen, TX (US)

(21) Appl. No.: 19/044,590

(22) Filed: Feb. 3, 2025

Related U.S. Application Data
(60) Provisional application No. 63/553,997, filed on Feb. 15, 2024.
(60) Provisional application No. 63/567,273, filed on Mar. 19, 2024.
(60) Provisional application No. 63/572,742, filed on Apr. 1, 2024.
(60) Provisional application No. 63/692,998, filed on Sep. 10, 2024.

(51) Int. Cl. H04W 76/20; H04W 16/28; H04W 24/10; H04W 72/1273; H04W 72/231

(52) U.S. Cl. CPC H04W 76/20; H04W 16/28; H04W 24/10; H04W 72/1273; H04W 72/231

(57) ABSTRACT

Methods and apparatuses for user equipment (UE) mobility. A method of operating a UE includes receiving configuration information related to transmission configuration indication (TCI) states, receiving configuration information related to measurement reference signals (RSs) for N cells, where N is >1, receiving information indicating associations of the TCI states to subsets of the N cells, respectively, and receiving a first TCI state from the TCI states. The first TCI state indicates a spatial relation associated with a first cell from the N cells. The first cell is a serving cell. The method further includes determining a first subset of cells from the subsets of the N cells based on the first TCI state, performing measurement of RSs associated with the determined first subset, and transmitting a report based on the measured RSs.

### CROSS-REFERENCE TO RELATED AND CLAIM OF PRIORITY

The present application claims priority under 35 U.S.C. § 119(e) to U.S. Provisional Patent Application No. 63/553,997 filed on Feb. 15, 2024; U.S. Provisional Patent Application No. 63/567,273 filed on Mar. 19, 2024; U.S. Provisional Patent Application No. 63/572,742 filed on Apr. 1, 2024; and U.S. Provisional Patent Application No. 63/692,998 filed on Sep. 10, 2024, which are hereby incorporated by reference in their entirety.

### TECHNICAL FIELD

The present disclosure relates generally to wireless communication systems and, more specifically, the present disclosure relates to methods and apparatuses for user equipment (UE) mobility.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to UE mobility.

In one embodiment, a user equipment (UE) is provided. The UE includes a transceiver configured to receive configuration information related to transmission configuration indication (TCI) states, receive configuration information related to measurement reference signals (RSs) for N cells, where N is >1, receive information indicating associations of the TCI states to subsets of the N cells, respectively, and receive a first TCI state from the TCI states. The first TCI state indicates a spatial relation associated with a first cell from the N cells. The first cell is a serving cell. The UE further includes a processor operably coupled to the transceiver. The processor is configured to determine a first subset of cells, from the subsets of the N cells, based on the first TCI state and perform measurement of RSs associated with the determined first subset. The transceiver is further configured to transmit a report based on the measured RSs.

In another embodiment, a base station (BS) is provided. The BS includes a transceiver configured to transmit configuration information related to TCI states, transmit configuration information related to measurement RSs for N cells, where N is >1, transmit information indicating associations of the TCI states to subsets of the N cells, respectively, and transmit a first TCI state from the TCI states. The first TCI state indicates a spatial relation associated with a first cell from the N cells. The first cell is a serving cell. The BS further includes a processor operably coupled to the transceiver. The processor is configured to determine a first subset of cells from the subsets of the N cells based on the first TCI state. The transceiver is further configured to receive a report based on the measured RSs.

In yet another embodiment, a method of operating a UE is provided. The method includes receiving configuration information related to TCI states, receiving configuration information related to measurement RSs for N cells, where N is >1, receiving information indicating associations of the TCI states to subsets of the N cells, respectively, and receiving a first TCI state from the TCI states. The first TCI state indicates a spatial relation associated with a first cell from the N cells. The first cell is a serving cell. The method further includes determining a first subset of cells from the subsets of the N cells based on the first TCI state, performing measurement of RSs associated with the determined first subset, and transmitting a report based on the measured RSs.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIG. 7 illustrates a diagram of an example radio access network (RAN) protocol stack according to embodiments of the present disclosure;

FIG. 8 illustrates a diagram of example functional split points/options according to embodiments of the present disclosure;

FIG. 9 illustrates a diagram of example functional split points/options according to embodiments of the present disclosure;

FIG. 10 illustrates a diagram of an example synchronization signal/physical broadcast channel (SS/PBCH) block according to embodiments of the present disclosure;

FIG. 11A illustrates a flowchart of an example contention based random access (CBRA) procedure according to embodiments of the present disclosure;

FIG. 11B illustrates a flowchart of an example contention free random access (CFRA) procedure according to embodiments of the present disclosure;

FIG. 12A illustrates a flowchart of an example CBRA procedure according to embodiments of the present disclosure;

FIG. 12B illustrates a flowchart of an example CFRA procedure according to embodiments of the present disclosure;

FIG. 13 illustrates examples of a UE moving on a trajectory located in co-located and distributed port groups (PGs) according to embodiments of the present disclosure;

FIG. 14 illustrates an example system for UE switching/connecting to a different RU according to embodiments of the present disclosure;

FIG. 15 illustrates an example system for serving cells according to embodiments of the present disclosure;

FIG. 16 illustrates a diagram of example UE mobility according to embodiments of the present disclosure;

FIGS. 17A, 17B, and 17C illustrate a diagram of example radio access network (RAN) configurations according to embodiments of the present disclosure;

FIG. 18 illustrates a diagram of an example RAN configuration according to embodiments of the present disclosure;

FIG. 19 illustrates a diagram for example UE mobility according to embodiments of the present disclosure;

FIGS. 20A, 20B, and 20C illustrate diagrams for example UE mobility according to embodiments of the present disclosure;

FIGS. 21A, 21B, and 21C illustrate diagrams of example cell to remote unit (RU) mapping according to embodiments of the present disclosure;

FIG. 22 illustrates a diagram of an example entity associated with spatial domain transmission filters (beams) according to embodiments of the present disclosure;

FIG. 23 illustrates a diagram of example UE mobility according to embodiments of the present disclosure;

FIG. 24 illustrates a diagram of example spatial resource units according to embodiments of the present disclosure;

FIG. 25 illustrates a diagram of example spatial resource unit update timings according to embodiments of the present disclosure;

FIG. 26 illustrates a diagram of an example message for activation according to embodiments of the present disclosure; and

FIG. 27 illustrates a diagram of an example message for activation according to embodiments of the present disclosure.

### DETAILED DESCRIPTION

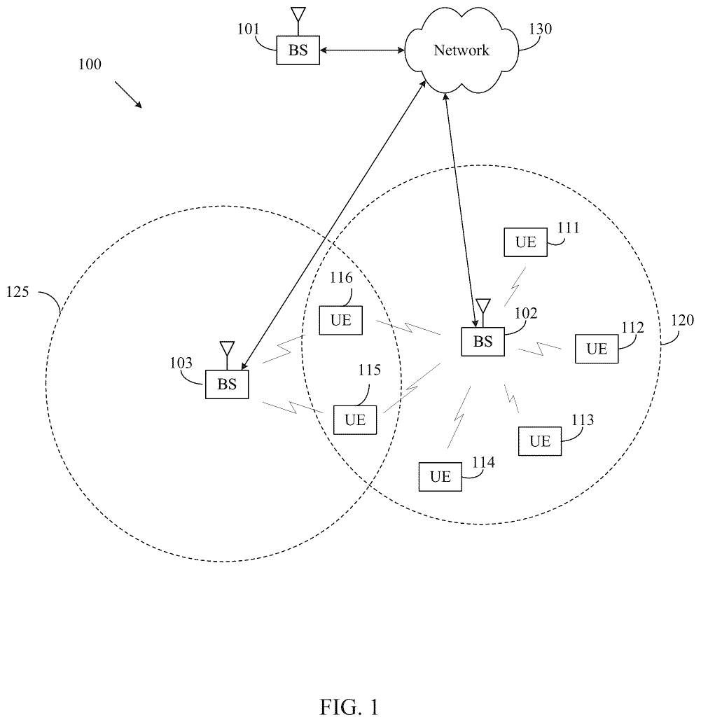

FIGS. 1-27, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1]3GPP TS 38.211 v18.1.0, “NR; Physical channels and modulation;” [REF 2]3GPP TS 38.212 v18.1.0, “NR; Multiplexing and channel coding;” [REF 3]3GPP TS 38.213 v18.1.0, “NR; Physical layer procedures for control;” [REF 4]3GPP TS 38.214 v18.1.0, “NR; Physical layer procedures for data;” [REF 5]3GPP TS 38.321 v18.0.0, “NR; Medium Access Control (MAC) protocol specification;” and [REF 6]3GPP TS 38.331 v18.0.0, “NR; Radio Resource Control (RRC) protocol specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103 (collectively forming a BS system). The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for UE mobility. In certain embodiments, one or more of the gNBs 101-103 include circuitry, programing, or a combination thereof to support UE mobility.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

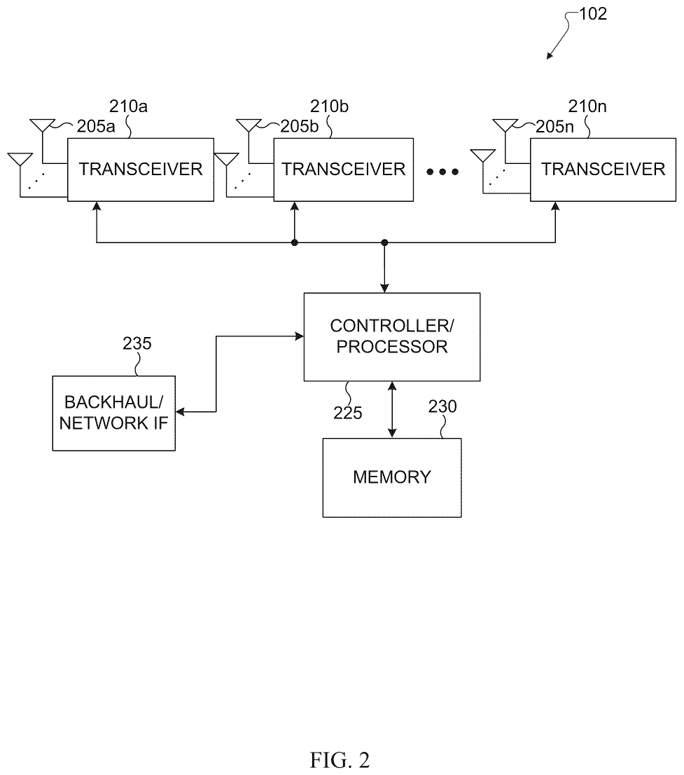

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as supporting UE mobility. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The backhaul or network interface 235 could support communications over any suitable wired or wireless connection(s). For example, when the gNB 102 is implemented as part of a cellular communication system (such as one supporting 5G/NR, LTE, or LTE-A), the backhaul or network interface 235 could allow the gNB 102 to communicate with other gNBs over a wired or wireless backhaul connection. When the gNB 102 is implemented as an access point, the backhaul or network interface 235 could allow the gNB 102 to communicate over a wired or wireless local area network or over a wired or wireless connection to a larger network (such as the Internet). The backhaul or network interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

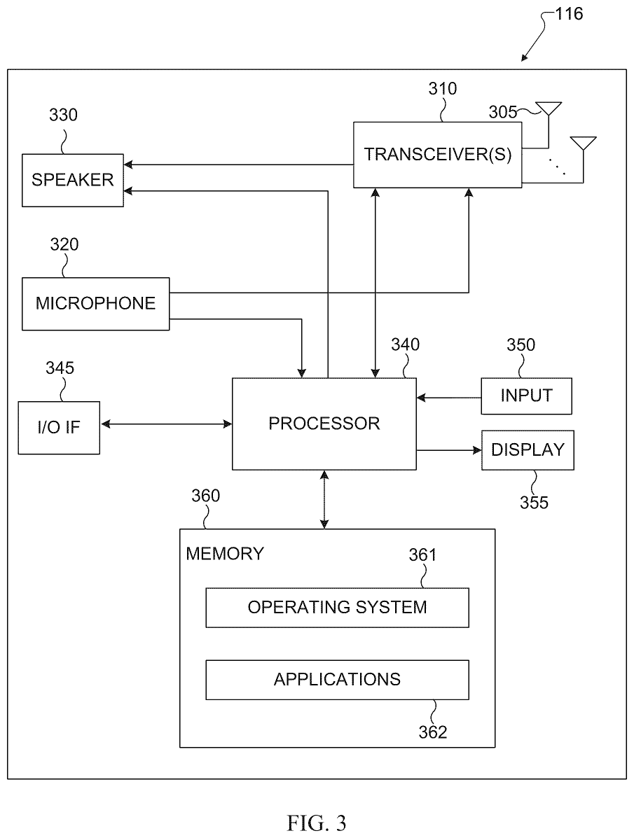

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to perform UE mobility, as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

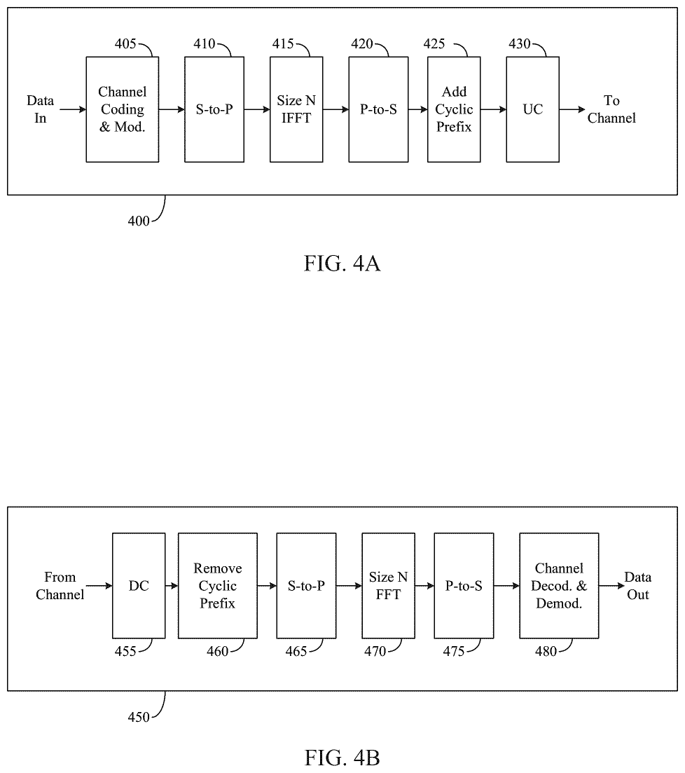

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 supports UE mobility as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

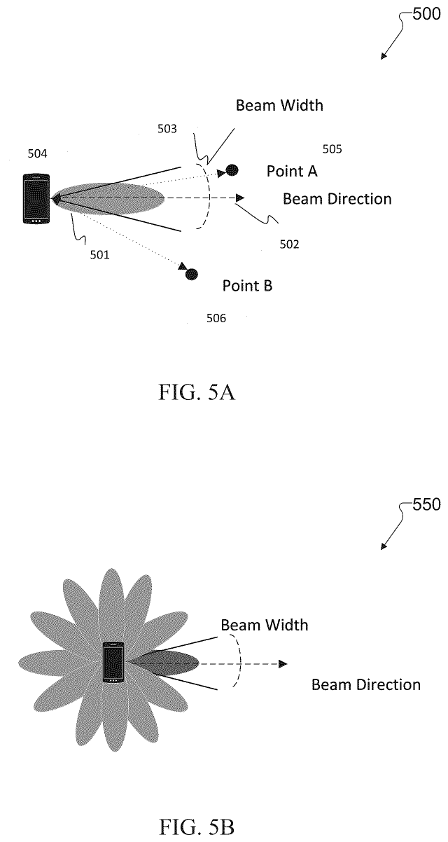

As illustrated in FIG. 5A, in a wireless system 500, a beam 501 for a device 504 can be characterized by a beam direction 502 and a beam width 503. For example, the device 504 (or UE 116) transmits RF energy in a beam direction 502 and within a beam width 503. The device 504 receives RF energy in a beam direction 502 and within a beam width 503. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While in FIG. 5B, for illustrative purposes, a beam is in 2D, it should be apparent to those skilled in the art, that a beam can be 3D, where a beam can be transmitted to or received from any direction in space.

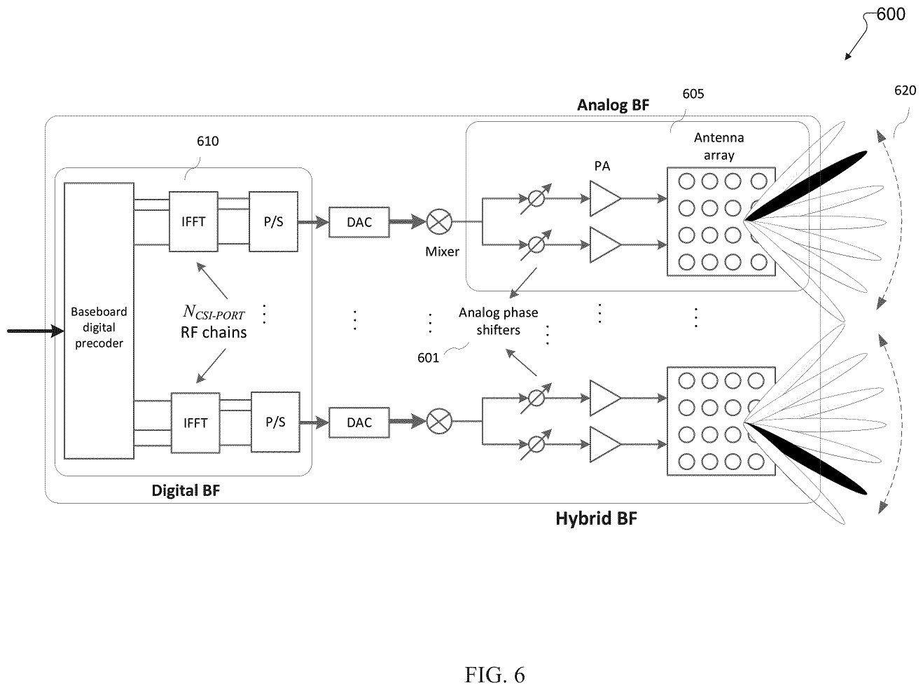

FIG. 6 illustrates an example of a transmitter structure 600 for beamforming according to embodiments of the present disclosure. In certain embodiments, one or more of gNB 102 or UE 116 includes the transmitter structure 600. For example, one or more of antenna 205 and its associated systems or antenna 305 and its associated systems can be included in transmitter structure 600. This example is for illustration only, and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for purposes of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz. In this case, the system can employ only analog beams. Due to the O₂ absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 600 for beamforming is for illustration only and other embodiments can be used without departing from the scope of the present disclosure.

In this disclosure, [DEF1] a beam can be determined by any of:
A transmission configuration indication (TCI) state, that establishes a quasi-colocation (QCL) relationship or spatial relation between a source reference signal (e.g. synchronization signal block (SSB) and/or CSI-RS) and a target reference signal
A spatial relation information that establishes an association to a source reference signal, such as SSB or CSI-RS or sounding reference signal (SRS).

Alternatively, [DEF2] a beam can be determined by any of:
A port with a static/fixed (e.g. for FR1) or dynamic virtualization (e.g. FR2, FR3), or
A port group (PG) comprising multiple ports, with a dynamic indication/assignment of one (or two) ports from the multiple ports and associated QCL property=QCL TypeD or spatial relation.

In either case, the ID of the source reference signal or TCI state or spatial relation or the one (or two) port(s) identifies the beam.

According to [DEF1], the TCI state and/or the spatial relation reference RS can determine a spatial Rx filter for reception of downlink channels at the UE, or a spatial Tx filter for transmission of uplink channels from the UE. The TCI state and/or the spatial relation reference RS can also determine a spatial Tx filter for transmission of downlink channels from the gNB, or a spatial Rx filter for reception of uplink channels at the gNB.

Likewise, for [DEF2], the port with dynamic virtualization and/or the PG with dynamic indication of one (or two) ports can determine a spatial Rx filter or port or PG for reception of downlink channels at the UE, or a spatial Tx filter or port or PG for transmission of uplink channels from the UE. The port with dynamic virtualization and/or the PG with dynamic indication of one (or two) ports can also determine a spatial Tx filter or a port or a PG for transmission of downlink channels from the gNB, or a spatial Rx filter or a port or a PG for reception of uplink channels at the gNB (e.g., the BS 102).

Rel-17 introduced the unified TCI framework, where a unified or main or indicated TCI state is signaled to the UE. The unified or main or indicated TCI state can be one of:
1. In case of joint TCI state indication, wherein a same beam or port/PG is used for DL and UL channels, a joint TCI state that can be used at least for UE-dedicated DL channels and UE-dedicated UL channels.
2. In case of separate TCI state indication, wherein different beams or ports/PGs are used for DL and UL channels, a DL TCI state that can be used at least for UE-dedicated DL channels.
3. In case of separate TCI state indication, wherein different beams or ports/PGs are used for DL and UL channels, a UL TCI state that can be used at least for UE-dedicated UL channels.

The unified (main or indicated) TCI state is TCI state of UE-dedicated reception on physical downlink shared channel (PDSCH)/physical downlink control channel (PDCCH) or dynamic-grant/configured-grant based physical uplink shared channel (PUSCH) and dedicated physical uplink control channel (PUCCH) resources.

The unified TCI framework also applies to intra-cell beam management, wherein, the TCI states have a source RS that is directly or indirectly associated, through a quasi-co-location relation, e.g., spatial relation, with an SSB or port/PG of a serving cell (e.g., the TCI state is associated with a TRP of a serving cell). The unified TCI state framework also applies to inter-cell beam management, wherein a TCI state can have a source RS that can be directly or indirectly associated, through a quasi-co-location relation, e.g., spatial relation, with an SSB or port/PG of cell that has a physical cell identity (PCI) different from the PCI of the serving cell (e.g., the TCI state is associated with a TRP of a cell having a PCI different from the PCI of the serving cell).

Quasi-co-location (QCL) relation, can be quasi-location with respect to one or more of the following relations [38.214—section 5.1.5]:
Type A, {Doppler shift, Doppler spread, average delay, delay spread}
Type B, {Doppler shift, Doppler spread}
Type C, {Doppler shift, average delay}
Type D, {Spatial Rx parameter} or port/PG

In addition, quasi-co-location relation and source reference signal or port/PG can also provide a spatial relation for UL channels, e.g., a DL source reference signal or ports/PGs provides information on the spatial domain filter or port/PG to be used for UL transmissions, or the UL source reference signal or ports/PGs provides the spatial domain filter to be used for UL transmissions, e.g., same spatial domain filter for UL source reference signal and UL transmissions.

The unified (main or indicated) TCI state applies at least to UE dedicated DL and UL channels. The unified (main or indicated) TCI can also apply to other DL and/or UL channels and/or signals e.g. non-UE dedicated channel and sounding reference signal (SRS).

A UE is indicated a TCI state by MAC CE when the MAC CE activates one TCI state code point. The UE applies the TCI state code point after a beam application time from the corresponding hybrid automatic repeat request acknowledgement (HARQ-ACK) feedback. A UE is indicated a TCI state by a DL related downlink control information (DCI) format (e.g., DCI Format 1_1, or DCI format 1_2) or an UL related DCI format (e.g. format 0_1 or 0_2), wherein the DCI format includes a “transmission configuration indication” field that includes/indicates a TCI state code point out of the TCI state code points activated by a MAC CE. A DL related DCI format (or an UL related DCI format) can be used to indicate a TCI state when the UE is activated with more than one TCI state code points. The DL related DCI format can be with a DL assignment for PDSCH reception or without an DL assignment. Likewise, the UL related DCI format can be with a UL grant for PUSCH transmission or without an UL grant. A TCI state can also be indicated in a purpose designed channel or DCI Format for TCI state indication. A TCI state (TCI state code point) indicated/included in a DL related DCI format or UL related DCI format or purpose design channel or DCI Format for TCI state indication is applied after a beam application time from the corresponding HARQ-ACK feedback.

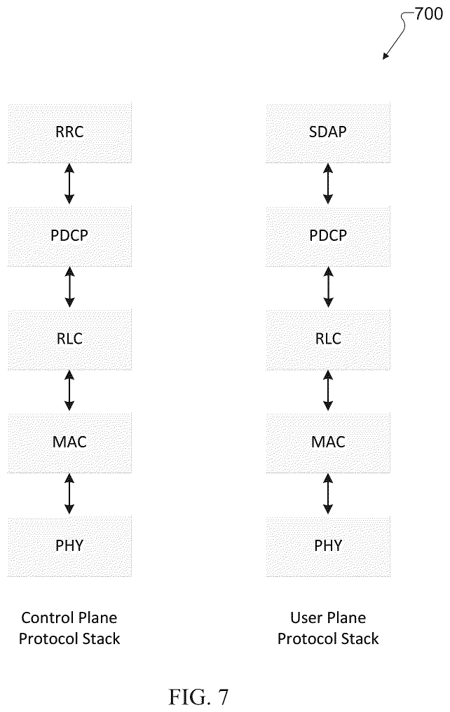

FIG. 7 illustrates a diagram of an example RAN protocol stack 700 according to embodiments of the present disclosure. For example, protocol stack 700 can be implemented by the BS 102 and the UE 116 of FIG. 1. This example is for illustration only and other embodiments can be used without departing from the scope of the present disclosure.

FIG. 7 illustrates an example of the protocol stack of NR networks including physical (PHY) layer, medium access control (MAC) layer, radio link control (RLC) layer, packet data convergence protocol (PDCD) layer, for control plane there is radio resource control (RRC) layer, and for user plane there is service data adaptation protocol (SDAP) layer.

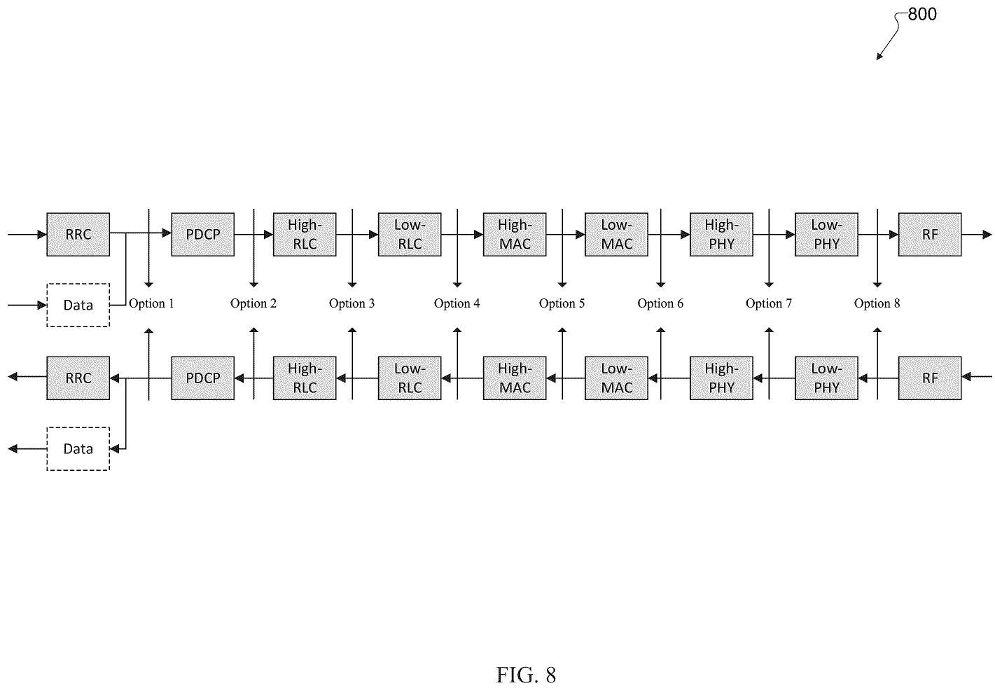

FIG. 8 illustrates a diagram of example functional split points/options 800 according to embodiments of the present disclosure. For example, functional split points/options 800 may be implemented by the BS 102 of FIG. 2. This example is for illustration only and other embodiments can be used without departing from the scope of the present disclosure.

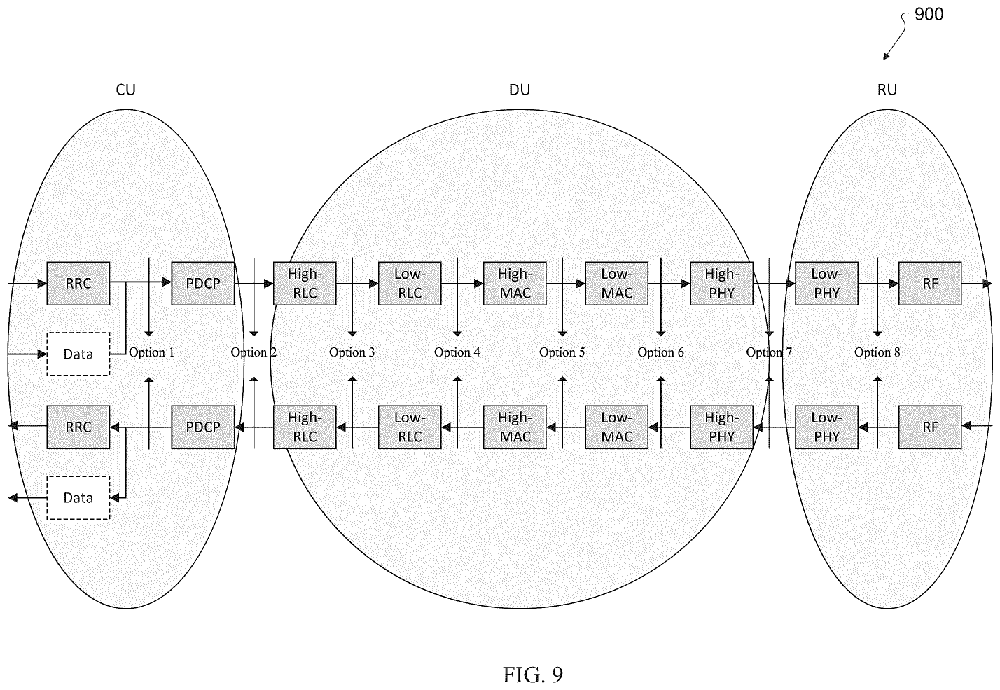

FIG. 9 illustrates a diagram of example functional split points/options 900 according to embodiments of the present disclosure. For example, functional split points/options 900 may be implemented by the BS 103 of FIG. 1. This example is for illustration only and other embodiments can be used without departing from the scope of the present disclosure.

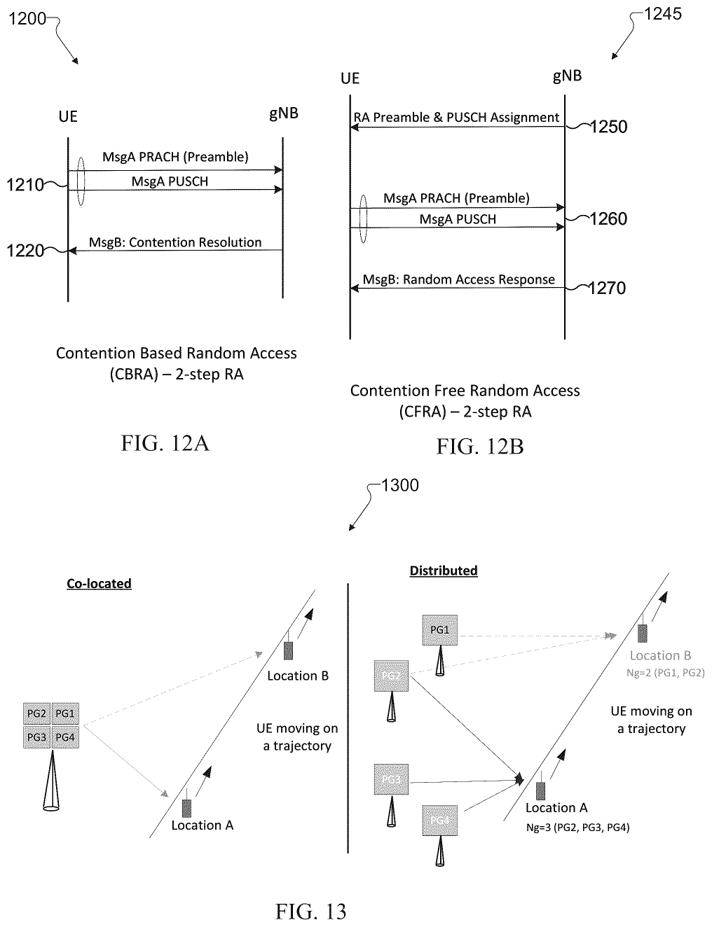

There can be different mappings of the layers of the protocol stack to actual devices implementing these functionalities. In one example, layers of the protocol stack can be mapped to a single device. In another example, the layers of the protocol stack can be split across multiple devices. 3GPP [TR 38.801] evaluated different functional split points between a central unit (CU) containing the higher layers of the protocol stack and a distributed unit (DU) containing the lower layers of the protocol stack. The functional split options evaluated by 3GPP are illustrated in FIG. 8 (TR 38.801—FIG. 12.1.1-1). For example, with functional split option 2, a CU contains the RRC and packet data convergence protocol (PDCP) layers, while a DU contains the RLC, MAC and PHY layers.

Multiple split options are also feasible, for example, in additional to the higher layer split between the CU and DU (e.g., functional split option 2), there can be a split within the DU. For example, the DU can be split into DU and remote unit (RU). The O-RAN alliance has been evaluating a lower layer functional split, where the lower PHY and the RF reside in a remote unit (RU), while the higher PHY and layers herein reside in the DU or CU. The lower level split being evaluated by the O-RAN alliance is similar to functional split option 7 of FIG. 8. There are various sub-options being evaluated for option 7 to define where the split occurs within the physical layer occurs. FIG. 9 illustrates an example protocol stack with two functional split points, the first between the CU and the DU and the second between the DU and the RU.

In NR/5G, a geographical area served by the network (e.g., the network 130) can be partitioned into cells as mentioned herein. For example, a cell can be associated with a synchronization signal, physical broadcast channel (PBCH) block (SS/PBCH block). Within a cell, other common channels and/or signals can be transmitted to users in the cell. In another example, a cell is served by one or more TRPs or by one or more RUs.

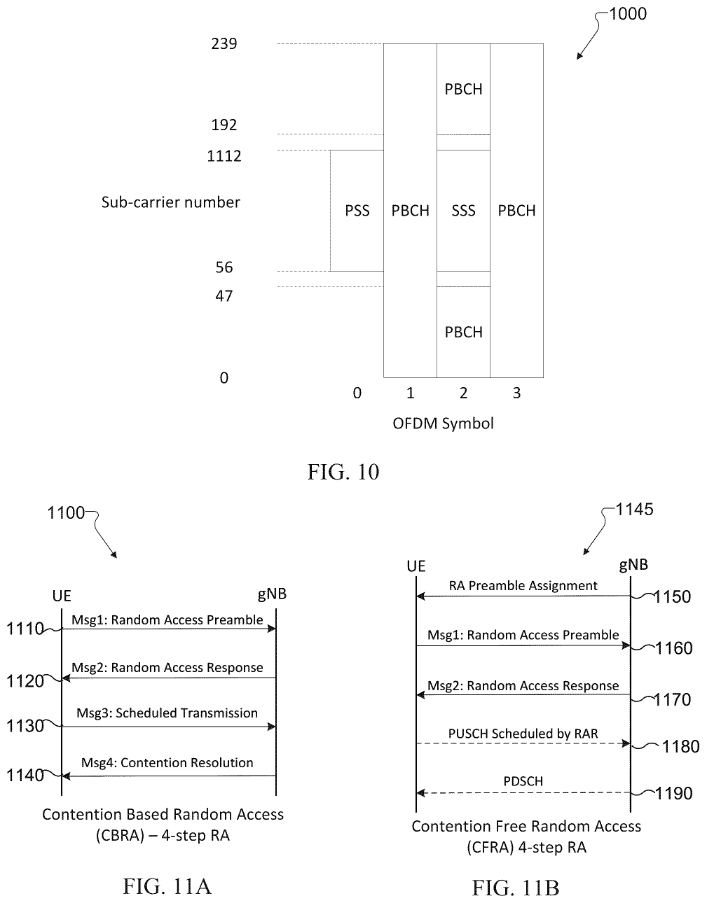

FIG. 10 illustrates a diagram of an example SS/PBCH block 1000 according to embodiments of the present disclosure. For example, SS/PBCH block 1000 can be utilized by any of the UEs 111-116 of FIG. 1. This example is for illustration only and other embodiments can be used without departing from the scope of the present disclosure.

In NR/5G, a UE performs the cell search procedure to acquire time and frequency synchronization within a cell and to detect the physical layer Cell ID (PCI) of the cell. To perform cell search, the UE receives the following signals and channel: (1) the primary synchronization signal (PSS), (2) the secondary synchronization signal (SSS) and (3) the physical broadcast channel (PBCH). A PSS/SSS/PBCH block (SS/PBCH block) is referred to as SSB and includes 4 consecutive symbols, and 20 resource blocks (240 subcarriers), as illustrated in FIG. 10.

SSBs are organized in groups or bursts of up to N SSBs, transmitted within half a frame, each SSB within the group or burst has an index i, where i=0, 1, . . . , N−1, within each group or burst of SSBs, the SSBs are time-division multiplexed and arranged in increasing order of i, with increasing time. For carrier frequencies less than or equal to 3 GHz, N=4. For carrier frequencies in FR1 that are larger than 3 GHz, N=8. For carrier frequencies in FR2, N=64. The SSB indices actually transmitted are provided by ssb-PositionsInBurst in system information block one (SIB1) or in ServingCellConfigCommon.

SSBs are transmitted periodically, where the allowed periodicities are {5, 10, 20, 40, 80, 160} ms. In addition to cell search, SSBs can also be used for beam management related procedures, such as new beam acquisition, beam measurements, and beam failure detection and recovery. Each SSB with index i can be associated with a spatial domain filter (or beam).

NR introduced a physical random access channel (PRACH) to be used, among other cases, when the UE wants to communicate with the network and doesn't have uplink resources. For example, the physical random access channel can be used during initial access. The PRACH includes a preamble format comprising one or more preamble sequences transmitted in a PRACH Occasion (RO).

NR supports four different preamble sequence lengths:
Sequence length 839 used with sub-carrier spacings 1.25 kHz and 5 kHz with unrestricted or restricted sets.
Sequence length 139 used with sub-carrier spacings 15 kHz, 30 kHz, 60 kHz and 120 kHz with unrestricted sets.
Sequence length 571 used with sub-carrier spacing 30 kHz with unrestricted sets.
Sequence length 1151 used with sub-carrier spacing 15 kHz with unrestricted sets.

RACH preambles are transmitted in time-frequency resources PRACH Occasions (ROs). Each RO determines the time and frequency resources in which a preamble is transmitted, the resources allocated to an RO in the frequency domain (e.g., number of physical resource blocks (PRBs)) and the resource allocated to an RO in the time domain (e.g., number of OFDMA symbols or number of slots), depend or the preamble sequence length, sub-carrier spacing of the preamble, sub-carrier spacing of the PUSCH in the UL bandwidth part (BWP), and the preamble format. Multiple PRACH Occasions can be FDMed in one-time instance. This is indicated by higher layer parameter msg1-FDM. The time instances of the PRACH Occasions are determined by the higher layer parameter prach-ConfigurationIndex, and Tables 6.3.3.2-2, 6.3.3.2-3, and 6.3.3.2-4 of TS 38.211 v18.1.0.

SSBs are associated with ROs. The number of SSBs associated with one RO can be indicated by higher layer parameters such as ssb-perRACH-OccasionAndCB-PreamblesPerSSB and ssb-perRACH-Occasion. The number of SSBs per RO can be {⅛,¼,½,1,2,4,8,16}. When the number of SSBs per RO is less than 1, multiple ROs are associated with the same SSB index. SS/PBCH block indexes provided by ssb-PositionsInBurst in SIB1 or in ServingCellConfigCommon are mapped to valid PRACH occasions in the following order [38.213 v18.1.0]:
First, in increasing order of preamble indexes within a single PRACH occasion.
Second, in increasing order of frequency resource indexes for frequency multiplexed PRACH occasions.
Third, in increasing order of time resource indexes for time multiplexed PRACH occasions within a PRACH slot.
Fourth, in increasing order of indexes for PRACH slots.

The association period starts from frame 0 for mapping SS/PBCH block indexes to PRACH occasions.

FIG. 11A illustrates a flowchart of an example CBRA procedure 1100 according to embodiments of the present disclosure. For example, CBRA procedure 1100 can be performed by the UE 116 and the gNB 102 and/or network 130 in the wireless network 100 of FIG. 1. This example is for illustration only and other embodiments can be used without departing from the scope of the present disclosure.

The procedure begins in 1110, a UE transmits a Msg1: random access preamble to a gNB. In 1120, the gNB transmits a Msg2: random access response to the UE. In 1130, the UE transmits a Msg3: scheduled transmission to the gNB. In 1140, the gNB transmits Msg4: contention resolution to the UE.

FIG. 11B illustrates a flowchart of an example CFRA procedure 1145 according to embodiments of the present disclosure. For example, CFRA procedure 1145 can be performed by the UE 116 and the gNB 103 and/or network 130 in the wireless network 100 of FIG. 1. This example is for illustration only and other embodiments can be used without departing from the scope of the present disclosure.

The procedure begins in 1150, a gNB transmits a RA preamble assignment to a UE. In 1160, the UE transmits a Msg1: random access preamble to the gNB. In 1170, the gNB transmits a Msg2: random access response to the UE. In 1180, the gNB transmits Msg4: content resolution to the UE. Then the UE may transmit PUSCH scheduled by RAR, to the gNB (1180) and the gNB may transmit PDSCH to the UE (1190).

FIG. 12A illustrates a flowchart of an example CBRA procedure 1200 according to embodiments of the present disclosure. For example, CBRA procedure 1200 can be performed by the UE 115 and the gNB 102 and/or network 130 in the wireless network 100 of FIG. 1. This example is for illustration only and other embodiments can be used without departing from the scope of the present disclosure.

The procedure begins in 1210, a UE transmits MsgA PRACH (preamble) and MsgA PUSCH to a gNB. In 1220, the gNB transmits MsgB: contention resolution to the UE.

FIG. 12B illustrates a flowchart of an example CFRA procedure 1245 according to embodiments of the present disclosure. For example, CFRA procedure 1245 can be performed by the UE 115 and the gNB 103 and/or network 130 in the wireless network 100 of FIG. 1. This example is for illustration only and other embodiments can be used without departing from the scope of the present disclosure.

The procedure begins in 1250, a gNB transmits a RA preamble and PUSCH assignment to a UE. In 1260, the UE transmits MsgA PRACH (preamble) and MsgA PUSCH to the gNB. In 1270, the gNB transmits MsgB: random access response to the UE.

A random access procedure can be initiated by a PDCCH order, by the MAC entity, or by RRC.

There are two types of random access procedures, type-1 random access procedure and type-2 random access procedure.

Type-1 random access procedure also known as four-step random access procedure (4-step RACH), is as illustrated in FIGS. 11A and 11B;
In step 1, the UE transmits a random access preamble, also known as Msg1, to the gNB. The gNB attempts to receive and detect the preamble.
In step 2, the gNB upon receiving the preamble transmits a random access response (RAR), also known as Msg2, to the UE including, among other fields, a time adjustment (TA) command and a RAR uplink grant for a subsequent PUSCH transmission.
In step 3, the UE after receiving the RAR, transmits a PUSCH transmission scheduled by the grant of the RAR and time adjusted according to the TA received in the RAR. Msg3 or the PUSCH scheduled by the RAR UL grant can include the RRC setup request message.
In step 4, the gNB upon receiving the RRC setup request message, allocates downlink and uplink resources that are transmitted in a downlink PDSCH transmission to the UE.

After the last step, the UE can proceed with reception and transmission of data traffic.

Type-1 random access procedure (4-step RACH) can be contention based random access (CBRA) or contention free random access (CFRA). The CFRA procedure ends after the random access response, the following messages are not part of the random access procedure. For CFRA, in step 0, the gNB indicates to the UE the preamble to use.

Rel-16, introduced a new random access procedure; Type-2 random access procedure, also known as 2-step random access procedure (2-step RACH), is as illustrated in FIGS. 12A and 12B, that combines the preamble and PUSCH transmission into a single transmission from the UE (e.g., the UE 116) to the gNB, which is known as MsgA. Similarly, the RAR and the PDSCH transmission (e.g. Msg4) are combined into a single downlink transmission from the gNB to the UE, which is known as MsgB.

FIG. 13 illustrates examples of a UE moving on a trajectory 1300 located in co-located and distributed PGs according to embodiments of the present disclosure. For example, UE moving on a trajectory 1300. For example, UE moving on a trajectory 1300 can be implemented by any of the UEs 111-116 of FIG. 1. This example is for illustration only and can be used without departing from the scope of the present disclosure.

In NR/5G, as a UE in RRC_CONNECTED mode moves around, the UE can connect to the network through different cells or different beams. There are two types of network controlled mobility procedures for UEs in RRC_CONNECTED mode: (1) Cell Level Mobility, also referred to as handover, that requires RRC signaling to be triggered and the UE changes its serving cell from a source serving cell to a target serving cell, and (2) Beam Level Mobility, that includes intra-cell beam level mobility and inter-cell beam level mobility and doesn't require explicit RRC signaling to be triggered. Alternatively, (2) can be PG-based mobility, as illustrated in FIG. 13. While the user moves from a location A to another location B, the set of PGs is updated from {PG2, PG3, PG4} to {PG1, PG2}. Consequently, a seamless beam-based (as opposed to cell-based) mobility is feasible especially for RRC-connected UEs.

To improve handover procedures, 3GPP introduced several handover enhancements which include:
Dual Active Protocol Stack (DAPS): The source gNB connection is maintained, i.e., a UE continues DL data reception from the source gNB and UL data transmission to the source gNB, after reception of the RRC message for handover, and until the source gNB is released after successful random access to the target gNB.
Conditional Handover (CHO): RRC configures handover parameters, however, the handover procedure is not executed by the UE until certain condition(s) are met at the UE. The UE evaluates the execution condition(s) upon receiving the CHO configuration, and stops evaluating the execution condition(s) once a handover is executed.
L1/L2 Triggered Mobility (LTM). The gNB prepares and provides candidate cell(s) configuration(s) to the UE. The physical layer provides measurement reports that include reference signal received power (RSRP) of SS/PBCH blocks of candidate cell(s). Based on the measurement reports, the gNB can change the serving cell to a target cell through a cell switch command signaled via MAC CE. The UE switches to the target cell following the cell switch command. The benefit of cell switch command is to reduce handover latency.

Embodiments of the present disclosure recognizes the need to provide for mobility of a user in RRC-CONNECTED mode moving across the network as it moves from one cell to the next by providing a low latency low overhead framework to transfer users between RUs serving the cells the user is moving across.

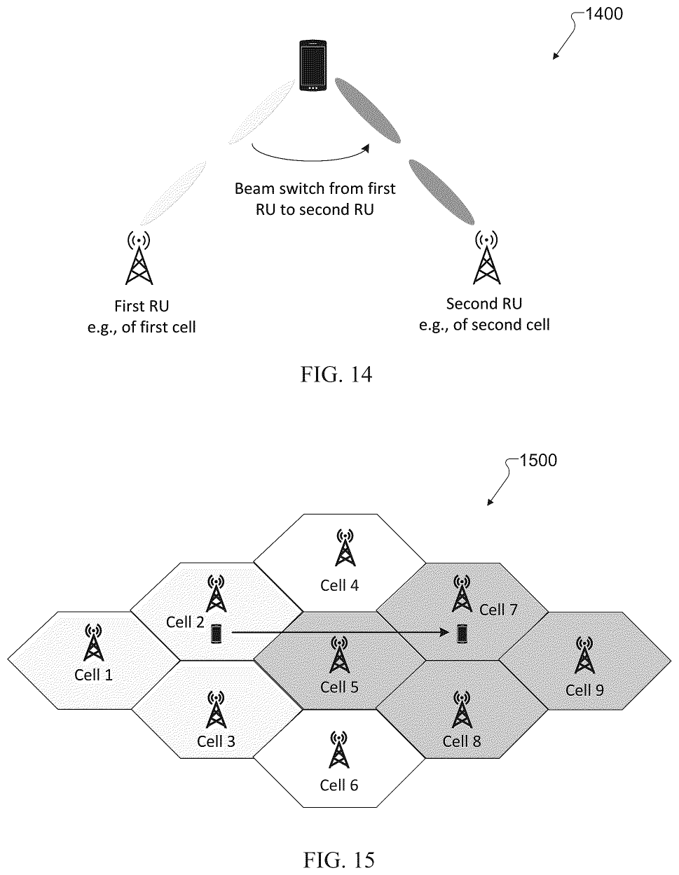

FIG. 14 illustrates an example system 1400 for UE switching/connecting to a different RU or cell according to embodiments of the present disclosure. For example, system 1400 can be implemented in the wireless network 100 of FIG. 1. This example is for illustration only and other embodiments can be used without departing from the scope of the present disclosure.

A UE can receive and transmit dedicated channels and/or signals that are intended for the UE, or common channels and/or signals e.g., intended for UEs in a cell or part of a cell. The spatial domain filters (beams or port/PG) used to receive and/or transmit dedicated channels and/or signals can be different from the beams or port/PG used to receive and/or transmit common channels and/or signals. In this disclosure, how the beam or port/PG of dedicated and common channels and/or signals is determined and updated as the UE moves through the network is evaluated.

As mentioned herein, a geographical area served by a network is partitioned into cells. Cells can be mapped to or associated with RUs, DUs or CUs. A UE can connect to the network through one or more RUs associated with a serving cell. Or depending on propagation channel conditions, a UE can connect through RUs not associated with the serving cell. As a UE moves within the geographical area covered by the network, the cell through which the UE connects to the network changes, and hence the RU(s) through which the UE connects to the network change. For example, for dedicated channels or signals, a change in RU can be signaled to the UE as a change in a spatial domain filter (beam or port/PG), the UE communicates to the network through a first RU using a first spatial domain filter (beam or port/PG) as illustrated in FIG. 14, the UE is then signaled a second spatial domain transmission filter (beam or port/PG) associated with a second RU to communicate to the network through the second RU. There are a few aspects to evaluate here; first, how does the UE determine the spatial domain filters (beams or port/PGs) of the second RU, this includes configuration and activation of such beams or port/PGs, also taking into account that the UE can be continuously moving hence new beams or port/PGs are continuously being configured and activated for new RUs (or cells served by those RUs) the UE is moving closer to. Second, how is the UE signaled a change in a spatial domain transmission filter (beam or port/PG) from the first RU to the second RU, evaluate latency and overhead aspects. Third, as the UE moves to RUs associated with new cells, a serving cell change (or switch or handover) can take place, it is desirable to have such cell switch occur in a seamless way with minimum disruption to UE traffic and with high resilience and reliability. In one example, there is no cell switch command, but the UE switches from a first RU associated with a first cell to a second RU associated with a second cell by switching beams, i.e., through a beam indication command as included in FIG. 14.

FIG. 15 illustrates an example system 1500 for serving cells according to embodiments of the present disclosure. For example, system 1500 can be implemented in the wireless network 100 of FIG. 1. This example is for illustration only and other embodiments can be used without departing from the scope of the present disclosure.

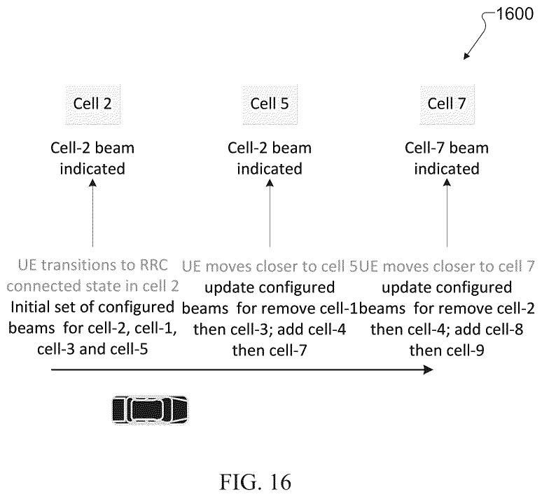

FIG. 16 illustrates a diagram of example UE mobility 1600 according to embodiments of the present disclosure. For example, UE mobility 1600 can be implemented by any of the UEs 111-116 of FIG. 1. This example is for illustration only and other embodiments can be used without departing from the scope of the present disclosure.

Another aspect to evaluate is the common channels the UE is receiving. Common channels are received by UEs of a cell or part of a cell or by UEs served by an RU or part of the UEs served by an RU (for example UEs associated with a certain beam or a group of beams or port/PGs). The UE can be configured to receive common channels of a serving cell and neighboring cells. As the UE moves throughout the geographical area served by the network, the common channels received by the UE can change based on its location within the geographical area as illustrated in FIG. 15. In FIG. 15, as an example, a UE moves from serving cell 2, where the UE receives common channels associated with cell 1, cell 2, cell 3 and cell 5, to serving cell 7, where the UE receives common channels associated with cell 5, cell 7, cell 8 and cell 9.

FIG. 16, illustrates one example of mobility for the UE of FIG. 15. The UE transitions to the connected mode in cell 2. The UE can be configured with beams associated with the cells in the neighborhood of the UE. For example, these can be beams associated with cell-1, cell-3 and cell-5 in addition to cell-2. A configuration with a beam is used, for example, to mean one or more of the following:
Configuration with a reference signal (e.g., CSI-RS or SSB) used for beam measurement, wherein the reference signal is associated with a spatial domain filter corresponding to a beam.
Configuration with a reference signal (e.g., CSI-RS or SSB) used for beam indication, wherein the reference signal is associated with a spatial domain filter corresponding to a beam.
Configuration with a TCI state or spatial relation information used for beam indication, wherein the TCI state or spatial relation information can include a reference signal for (1) quasi-co-location (QCL) (e.g., QCL Type A or Type B or Type C or Type D), or (2) spatial relation information/beam indication, and the reference signal is associated with a spatial domain filter or QCL type corresponding to a beam.

The UE can provide measurement reports for the configured beams (e.g., measurement reference signals). Based on measurements/measurement reports, the network (e.g., gNB), and/or the UE can activate a subset of beams (e.g., reference signals or TCI states as mentioned herein). Furthermore, based on the measurements/measurement reports, the network (e.g., gNB), and/or the UE can indicate one or more beams (e.g., reference signals or TCI states as mentioned herein). As the UE moves, the configured beams can be updated. For example, as the UE moves closer to cell 5 and into cell 5, configured beams can be added for cell 4 and cell 7, and configured beams can be removed for cell 1 and cell 3. Based on the updated configuration of beams and measurement reports, beams are activated or deactivated, and new beams can be indicated to UE through which the UE communicates with the network. For example, as the UE moves closer to cell 5, the indicated beam (e.g., TCI state or reference signal) can be associated with cell 5. As the UE moves closer to cell 7 and into cell 7, configured beams can be added for cell 8 and cell 9, and configured beams can be removed for cell 2 and cell 4. Based on the updated configuration of beams and measurement reports, beams are activated or deactivated, and new beams can be indicated to UE through which the UE communicates with the network. For example, as the UE moves closer to cell 7, the indicated beam (e.g., TCI state or reference signal) can be associated with cell 7. In this example, the UE changes the cell (e.g., serving cell) (or TRP or RU) through which it communicates to the network based on beam measurement and reporting and beam indication (e.g., beam-based mobility).

In the example of FIG. 16, the configuration (e.g., initial configuration and/or addition and/or removal) of beams (e.g., measurement reference signals, or beam indication reference signals or TCI states), can be following the examples of this disclosure based on (1) UE-dedicated or UE-specific signaling (e.g., RRC signaling or MAC CE signaling or L1 control signaling), or (2) UE-common (e.g., to a group of UEs or UEs in a cell or associated with an entity), using e.g., SIB signaling (e.g., common channels from the cell the UE is communicating with the network through or a neighbor cell), or RRC signaling or MAC CE signaling or L1 control signaling.

In one example, the reference signal for beam indication when the UE is in connected mode (e.g., when the UE is within a cell or when the UE is moving between cells (mobility)) can be separate (e.g., has separate configuration) from the reference signal for initial beam acquisition, e.g., when the UE is transitioning to the connected mode.

In one example, the reference signal for beam indication when the UE is in connected mode (e.g., when the UE is within a cell or when the UE is moving between cells (mobility)) can be from the same configuration as the reference signal for initial beam acquisition, e.g., when the UE is transitioning to the connected mode.

The present disclosure relates to a NR/5G and/or 6G communication system.

This disclosure evaluates aspects related to mobility in a network for user in connected mode, to reduce latency and overhead of signaling associated with mobility, reduce distribution time due to mobility and improve reliability and resilience. The following aspects are evaluated:
Configuration of UE to receive common channels of adjacent cells.
Configuration of reference signal or port/PGs for adjacent cells using common channel signaling.
Configuration of TCI state for adjacent cells using common channel signaling.
Mobility from a first RU of a first cell to a second RU of a second cell by switching beams, e.g., using beam indication.

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

In the following, both frequency division duplexing (FDD) and time division duplexing (TDD) are regarded as a duplex method for DL and UL signaling. In addition, full duplex (XDD) operation is possible, e.g., sub-band full duplex (SBFD) or single frequency full duplex (SFFD).

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure evaluates several components that can be used in conjunction or in combination with one another, or can operate as standalone schemes.

In this disclosure, RRC signaling (e.g., configuration by RRC signaling) includes (1) common information provided by common signaling, e.g., this can be system information block (SIB)-based RRC signaling (e.g., SIB1 or other SIB) or (2) RRC dedicated signaling that is sent to a specific UE wherein the information can be common/cell-specific information or dedicated/UE-specific information or (3) UE-group RRC signaling.

In this disclosure MAC CE signaling can be UE-specific e.g., to one UE or can be UE common (e.g., to a group of UEs or UEs of a cell or all UEs in a cell). MAC CE signaling can be DL MAC CE signaling or UL MAC CE signaling.

In this disclosure L1 control signaling includes: (1) DL control information (e.g., DCI on PDCCH or DL control information on PDSCH) and/or (2) UL control information (e.g., uplink control information (UCI) on PUCCH or PUSCH). L1 control signaling be UE-specific e.g., to one UE or can be UE common (e.g., to a group of UEs or to UEs of a cell or all UEs in a cell).

In this disclosure, configuration can refer to configuration by semi-static signaling (e.g., RRC or SIB signaling). In one example, a configuration can be applicable to multiple transmission instances, until a new configuration is received and applied.

In this disclosure, indication can refer to indication by dynamic signaling (e.g., L1 control (e.g., DCI Format) or MAC CE signaling). In one example, an indication can be for an associated occasion(s) (e.g., an occasion or multiple occasions associated with the indication).

In this disclosure a list with N elements can be denoted as L(i), where i can take N values, and L(i) can correspond to the element or entry associated with index i. In one example, i can take N arbitrary values. In one example, i=0, 1, . . . , N−1. In one example, i=1, 2, . . . , N. In one example, i is an identity of an element or entry in the list.

In the present disclosure, the term “activation” describes an operation wherein a UE receives and decodes first information provided by a first signal from the network (or gNB) and, based on the first information, the UE determines a starting point in time. The starting point can be a present or a future slot/subframe or symbol and the exact location is either implicitly or explicitly indicated, or is otherwise defined in the system operation or is configured by higher layers. Upon successfully decoding the first information, the UE responds according to an indication provided by the first information. The term “deactivation” describes an operation wherein a UE receives and decodes second information provided by a second signal from the network (or gNB) and, based on the second information from the signal, the UE determines a stopping point in time. The stopping point can be a present or a future slot/subframe or symbol and the exact location is either implicitly or explicitly indicated, or is otherwise defined in the system operation or is configured by higher layers. Upon successfully decoding the second information, the UE responds according to an indication provided by the second information. The first signal can be same as the second signal or the first information can be same as the second information, wherein a first part of the information can be associated with an “activation” operation and with first UEs or with first parameters for transmissions/receptions by a UE, and a second part of the information can be associated with a “deactivation” operation and with second UEs or with second parameters for transmissions/receptions by the UE. For example, the second information can be absent, and deactivation can be implicitly derived. For example, when a UE has received an activation information in a previous indication, and is not included among UEs with activation information in a next indication, the UE can determine the latter indication as an implicit deactivation indication.

In this disclosure, a time unit, for example, can be a symbol or a slot or sub-frame or a frame. In one example, a time-unit can be multiple symbols, or multiple slots or multiple sub-frames or multiple frames. In one example, a time-unit can be a sub-slot (e.g., part of a slot). In one example, a time-unit can be specified in units of time, e.g., microseconds, or milliseconds or seconds, etc.

In this disclosure, a frequency-unit, for example, can be a sub-carrier or a resource block (RB) or a sub-channel, wherein a sub-channel is a group of RBs, or a bandwidth part (BWP). In one example, a frequency-unit can be multiple sub-carriers, or multiple RBs or multiple sub-channels. In one example, a frequency-unit can be a sub-RB (e.g., part of a RB). A frequency-unit can be specified in units of frequency, e.g., Hz, or kHz or MHz, etc.

Terminology such as TCI, TCI states, SpatialRelationInfo, target RS, reference RS, and other terms is used for illustrative purposes and is therefore not normative. Other terms that refer to same functions can also be used.

A “reference RS” (e.g., reference source RS) corresponds to a set of characteristics of a DL beam or an UL TX beam, such as a direction, a precoding/beamforming, a number of ports, and so on. For instance, the UE can receive a source RS index/ID in a TCI state assigned to (or associated with) a DL transmission (and/or UL transmission), the UE applies the known characteristics of the source RS to the assigned DL transmission (and/or UL transmission). The source RS can be received and measured by the UE (in this case, the source RS is a downlink measurement signal such as NZP CSI-RS and/or SSB) with the result of the measurement used for calculating a beam report (e.g., including at least one L1-RSRP/L1-signal-to-interference-plus-noise ratio (SINR) accompanied by at least one channel quality indicator report interval (CRI) or synchronization signal block resource indicator (SSBRI)). As the NW/gNB receives the beam report, the NW can be better equipped with information to assign a particular DL (and/or UL) TX beam to the UE. Optionally or alternatively, the source RS can be transmitted by the UE (in this case, the source RS is an uplink measurement signal such as SRS). As the NW/gNB receives the source RS, the NW/gNB can measure and calculate the needed information to assign a particular DL (or/and UL) TX beam to the UE, for example in case of channel reciprocity.

In this disclosure, a beam or PG management reference signal refers to a reference signal, a UE can use for beam or PG management procedure. A beam or PG management procedure can include:
Initial beam or PG acquisition for identifying a beam or a beam pair (or port/PG pair) between two devices (e.g., UE and gNB/TRP or between two UEs) during channel setup or link establishment. This includes initial beam (port) sweeping (within a PG) to identify a beam (or port) pair between the two devices. This can also include identifying a beam or a beam pair (or port/PG pair) between a UE and new gNB/TRP in case of handover.
Beam or PG maintenance for refining and tracking the beam or PG as the UE moves around or the channel conditions change. This includes beam or PG measurement and reporting, and beam or port/PG indication signaling.
Beam or PG failure detection and recovery, an emergency-only procedure for determining when a beam has failed, and identifying a new beam to use instead. Beam failure events are typically rare and, in the unlikely event that a beam fails, beam recovery should be reliable and fast and before the link fails.

In one example, beam or PG management reference signals, also referred to as reference signals in this document can include:
A SS/PBCH block, which includes one or more synchronization signals carrying a cell ID (or a gNB/TRP ID or a RU ID), and a channel carrying minimum system information or part of the minimum system information, wherein the minimum system information is the information required by the UE to access the network (e.g., the network 130). In one example, the SS/PBCH block is not associated with PCI. In one example, the SS/PBCH is associated with PCI. In one example, the SS/PBCH block is a non-cell defining (NCD) SS/PBCH block. In one example, the SS/PBCH block is a cell defining (CD) SS/PBCH block.
Low-power synchronization signal (LP-SS). In one example, LP-SS which includes one or more synchronization signals carrying a cell ID (or a gNB/TRP ID or a RU ID). In one example, LP-SS is based on on-off keying modulation. In one example, LP-SS is received or transmitted on a low power radio separate from the main radio. In one example, the LP-SS is not associated with PCI. In one example, the LP-SS is associated with PCI.
Channel state information reference signal (CSI-RS). In one example, the CSI-RS is not associated with PCI. In one example, the CSI-RS is associated with PCI. In one example, the CSI-RS is QCLed with another CSI-RS. In one example, the CSI-RS is associated with PCI. In one example, the CSI-RS is QCLed with SS/PBCH block. In one example, the CSI-RS is QCLed with LP-SS. In one example, the CSI-RS has no source RS, e.g., the CSI-RS is the root of the QCL relation. In one example, the CSI-RS has one antenna port. In one example, the CSI-RS has more than one antenna port.

In one example, the CSI-RS and/or LP-SS and/or SS/PBCH block (e.g., non-cell defining synchronization signal (NCD-SS)/PBCH block) is transmitted from multiple RUs or multiple TRPs with single frequency network (SFN) properties. In one example, the same time and frequency resources and a same sequence is used to transmit CSI-RS and/or LP-SS and/or SS/PBCH block from multiple RUs or from multiple TRPs.

In one example of this disclosure, the reference signal for beam or PG management can include more than one reference signal.
A first reference signal for beam or PG management e.g., for initial beam or PG acquisition for initial access.
A second reference signal for beam or PG management e.g., for initial beam or PG acquisition for mobility (e.g., handover).
A third reference signal for beam or PG management e.g., for beam or PG maintenance (e.g., beam or PG tracking and/or beam or PG refinement)
A fourth reference signal for beam or PG management e.g., for beam or PG failure detection.
A fifth reference signal for beam or PG management e.g., for beam or PG failure recovery.

In one example, more than one of the reference signals mentioned herein can be same. For example, the first and the second reference signals can be same. For another example, the first and the second the fourth reference signals can be same. For another example, the second reference signal and the third reference signal are the same, for example, the UE uses a same reference signal for mobility and for beam maintenance.

In one example, there is one reference signal for beam or PG management. In one example, a reference signal can be used for beam or PG management and for other purposes such as tracking or channel state information (CSI) acquisition.

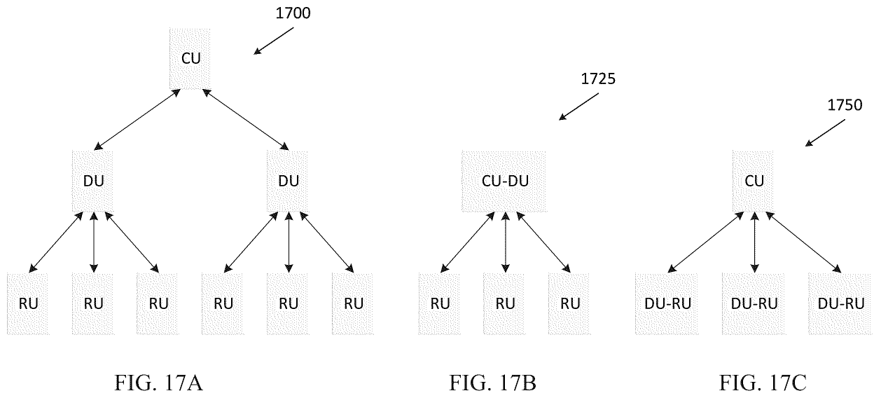

FIGS. 17A, 17B, and 17C illustrate a diagram of example RAN configurations 1700, 1725, and 1750, respectively, according to embodiments of the present disclosure. For example, RAN configurations 1700, 1725, and 1750, respectively, can be implemented by gNB 102 and/or network 130 in the wireless network 100 of FIG. 1. This example is for illustration only and other embodiments can be used without departing from the scope of the present disclosure.

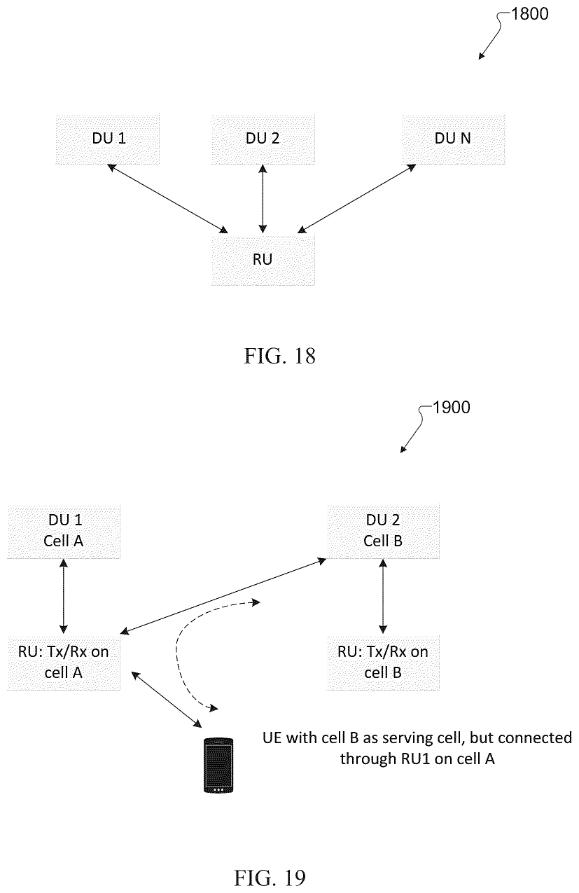

FIG. 18 illustrates a diagram of an example RAN configuration 1800 according to embodiments of the present disclosure. For example, RAN configuration 1800 can be implemented by gNB 103 and/or network 130 in the wireless network 100 of FIG. 1. This example is for illustration only and other embodiments can be used without departing from the scope of the present disclosure.

FIG. 19 illustrates a diagram for example UE mobility 1900 according to embodiments of the present disclosure. For example, UE mobility 1900 can be implemented in the wireless network 100 of FIG. 1. This example is for illustration only and other embodiments can be used without departing from the scope of the present disclosure.

In one example, a network can be deployed, wherein the network includes CUs, DUs and RUs. In one example, one CU can serve one or multiple DUs and one DU serve one or multiple RUs as illustrated in FIGS. 17A, 17B and 17C. In FIG. 17A, the CU, DU and RU can be separate entities. In FIG. 17B, the CU and DU are included in a same entity that is separate from the RU. In FIG. 17C, the DU and RU are included in a same entity that is separate from the CU. In one example, the CU, DU and RU are included in the same entity.

In one example, an RU (or O-RU) is functionally equivalent to a port or a PG (with QCL properties as described herein), and hence can be replaced with the term, “port or PG”. In the rest of the disclosure, the term RU is used for illustration purpose only, hence can be replaced with any functionally equivalent term such as a port or PG.

Likewise, the term beam can be functionally equivalent to a port or a PG (with QCL TypeD or spatial filter as described herein), and hence can be replaced with the term, “port or PG”. In the rest of the disclosure, the term beam is used for illustration purpose only, hence can be replaced with any functionally equivalent term such as a port or PG.

In one example, an RU can be connected to N DUs, as illustrated in FIG. 18. In one example, N=1. In one example, N=2. In one example, an RU can send or receive information from one DU at a time (e.g., in one slot or in one symbol). In one example, an RU can send or receive information simultaneously from multiple DUs. In one example of FIG. 18, an RU is equipped with multiple panels (e.g., N panels) and each panel can serve a different cell or sector, and the UE sends and receives information associated with each panel from a corresponding DU associated with a corresponding cell or sector. In one example of FIG. 18, an RU can be associated with cell A, the RU can send or received data to or from multiple DUs associated with different cells. For example, a first DU is associated with cell A, a second DU is associated with cell B, etc. In one example, a UE can have cell B as its serving cell, and hence anchored (e.g., having RLC and/or MAC and/or scheduler) in the second DU, and yet transmit or receive data on RU A for cell A, e.g., where cell A is a non-serving cell for the UE. This is illustrated in FIG. 19. Hence, a variant of FIG. 17 is to have RUs connected to multiple DUs to support the case where an RU communicates with a UE anchored in a DU with serving cell different from the serving cell of the RU.

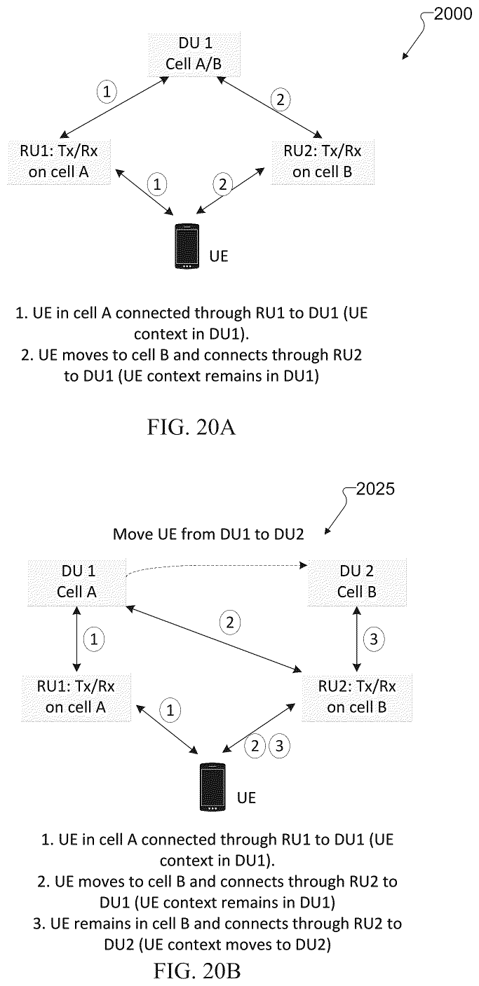

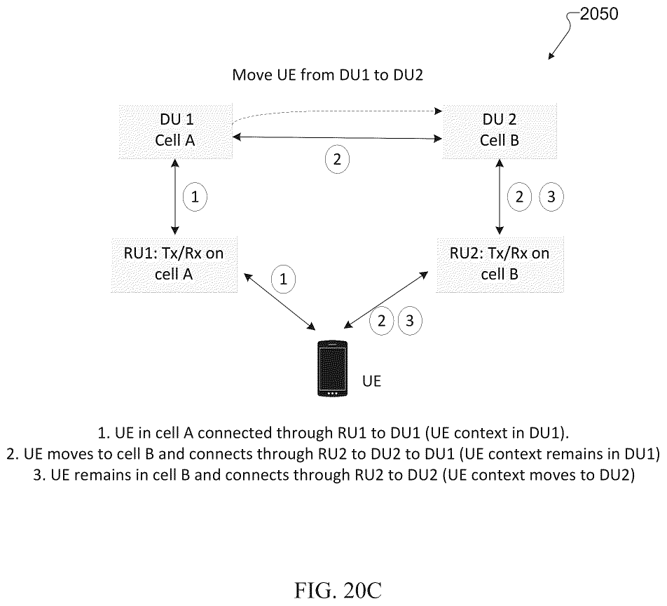

FIGS. 20A, 20B, and 20C illustrate diagrams for example UE mobility 2000, 2025, and 2050, respectively, according to embodiments of the present disclosure. For example, UE mobility 2000, 2025, and 2050, respectively, can be implemented in the wireless network 100 of FIG. 1. This example is for illustration only and other embodiments can be used without departing from the scope of the present disclosure.

FIG. 20A illustrates an example of a UE's mobility. In FIG. 20A, DU1 is associated with a first area (e.g., cell A) and with a second area (e.g., cell B). RU1 is associated with (e.g., provides coverage for) a first area (e.g., cell A). RU2 is associated with (e.g., provides coverage for) a second area (e.g., cell B). RU1 is connected to DU1. RU2 is connected to DU1. (1) Initially, the UE (e.g., the UE 116) communicates with the network through RU1, e.g., the UE is in the first area (e.g., cell A) associated with RU1, the UE is indicated a beam (e.g., a reference signal or TCI state) associated with RU1 (e.g., cell A). RU1 sends, receives data for the UE to/from DU1. In one example, the UE is anchored in DU1, in one example, the MAC/RLC/upper physical layer of the UE is in DU1, in one example, the UE context is in DU1. (2) In one example, the UE moves to the second area (e.g., cell B) associated with RU2, the UE is indicated a beam (e.g., a reference signal or TCI state) associated with RU2 (e.g., cell B). RU2 sends, receives data for the UE to/from DU1. In one example, the UE is anchored in DU1, in one example, the MAC/RLC/upper physical layer of the UE is in DU1, in one example, the UE context is in DU1. FIG. 20A is an example of intra-DU mobility.

FIG. 20B illustrates an example of a UE's mobility. In FIG. 20B, DU1 is associated with a first area (e.g., cell A). DU2 is associated with a second area (e.g., cell B). RU1 is associated with (e.g., provides coverage for) the first area (e.g., cell A). RU2 is associated with (e.g., provides coverage for) a second area (e.g., cell B). RU1 is connected to DU1 (can optionally connect to DU2 also). RU2 is connected to DU1 and DU2. (1) Initially, the UE communicates with the network through RU1, e.g., the UE is in a first area (e.g., cell A) associated with RU1, the UE is indicated a beam (e.g., a reference signal or TCI state) associated with RU1 (e.g., cell A). RU1 sends, receives data for the UE to/from DU1. In one example, the UE is anchored in DU1, in one example, the MAC/RLC/upper physical layer of the UE is in DU1, in one example, the UE context is in DU1. (2) In one example, the UE moves to the second area (e.g., cell B) associated with RU2, the UE is indicated a beam (e.g., a reference signal or TCI state) associated with RU2 (e.g., cell B). RU2 sends, receives data for the UE to/from DU1. In one example, the UE is anchored in DU1, in one example, the MAC/RLC/upper physical layer of the UE is in DU1, in one example, the UE context is in DU1. In one example, when the UE moves to the second area (e.g., cell B) part of the MAC processing (e.g., for scheduling, or resource allocation) is performed in DU2 associated with the second area (e.g., cell B). (3) In one example, a/the UE remains in the second area (e.g., cell B) associated with RU2. The MAC and/or RLC and/or upper physical layer of the UE is moved from DU1 to DU2. RU2 sends, receives data for the UE to/from DU2. In one example, the UE is anchored in DU2, in one example, the MAC/RLC/upper physical layer of the UE is in DU2, in one example, the UE context is in DU2. FIG. 20B is an example of inter-DU mobility. In one example, DU1 and DU2 are associated with a same CU, i.e., inter-DU/intra-CU mobility. In one example, DU1 and DU2 are associated with different CUs, i.e., inter-DU/inter-CU mobility.

FIG. 20C illustrates an example of a UE's mobility. In FIG. 20C, DU1 is associated with a first area (e.g., cell A). DU2 is associated with a second area (e.g., cell B). RU1 is associated with (e.g., provides coverage for) a first area (e.g., cell A). RU2 is associated with (e.g., provides coverage for) a second area (e.g., cell B). RU1 is connected to DU1. RU2 is connected to DU2. (1) Initially, the UE communicates with the network through RU1, e.g., the UE is in the first area (e.g., cell A) associated with RU1, the UE is indicated a beam (e.g., a reference signal or TCI state) associated with RU1 (e.g., cell A). RU1 sends, receives data for the UE to/from DU1. In one example, the UE is anchored in DU1, in one example, the MAC/RLC/upper physical layer of the UE is in DU1, in one example, the UE context is in DU1. (2) In one example, the UE moves to the second area (e.g., cell B) associated with RU2, the UE is indicated a beam (e.g., a reference signal or TCI state) associated with RU2 (e.g., cell B). RU2 sends, receives data for the UE to/from DU1 through DU2. In one example, the UE is anchored in DU1, in one example, the MAC/RLC/upper physical layer of the UE is in DU1, in one example, the UE context is in DU1. In variant example, the upper physical layer is in DU2 and the MAC/RLC is in DU1. In variant example, the upper physical layer is in DU2 and the MAC/RLC is split between DU1 and DU2. In variant example, the MAC/RLC/upper physical layer is split between DU1 and DU2. In one example, DU1 and DU2 are connected directly. In one example, the link between DU1 to DU2 is through a CU. In one example, the link between DU1 and DU2 is through multiple CUs. In one example, the link between DU1 to DU2 is through a DU. In one example, the link between DU1 and DU2 is through multiple DUs. In one example, when the UE moves to the second area (e.g., cell B) part of the MAC processing (e.g., for scheduling, or resource allocation) is performed in DU2 associated with the second area (e.g., cell B). (3) In one example, a/the UE remains in the second area (e.g., cell B) associated with RU2. The MAC and/or RLC and/or upper physical layer of the UE is moved from DU1 to DU2. RU2 sends, receives data for the UE to/from DU2. In one example, the UE is anchored in DU2, in one example, the MAC/RLC/upper physical layer of the UE is in DU2, in one example, the UE context is in DU2. FIG. 20C is an example of inter-DU mobility. In one example, DU1 and DU2 are associated with a same CU, i.e., inter-DU/intra-CU mobility. In one example, DU1 and DU2 are associated with different CUs, i.e., inter-DU/inter-CU mobility.

In one example, if DU1 and DU2 of FIG. 20B and FIG. 20C are associated with a same CU, use beam-based mobility (e.g., seamless mobility) as described in this disclosure, if DU1 and DU2 are associated with different CUs, LTM-based mobility can be used.

In one example, if DU1 and DU2 of FIG. 20B and FIG. 20C are associated with a same CU or with different CUs, use beam-based mobility (e.g., seamless mobility) as described in this disclosure.

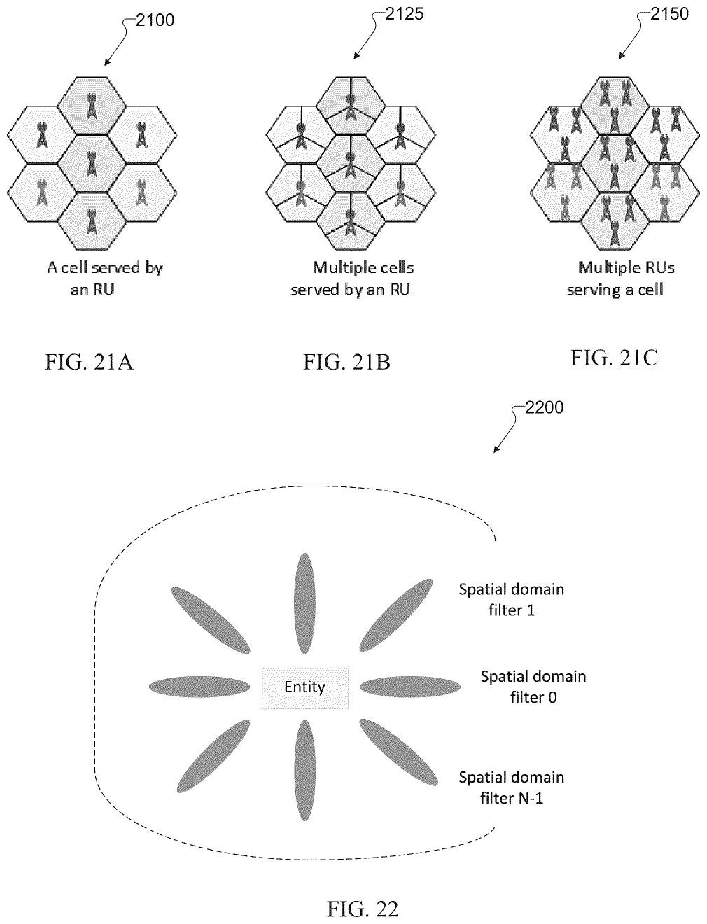

FIGS. 21A, 21B, and 21C illustrate diagrams of example cell to RU mapping 2100, 2125, and 2150, respectively, according to embodiments of the present disclosure. For example, cell to RU mapping 2100, 2125, and 2150, respectively, can be implemented in the wireless network 100 of FIG. 1. This example is for illustration only and other embodiments can be used without departing from the scope of the present disclosure.

As mentioned herein, a geographical area served by a network can be partitioned into cells. For example, a cell can be an area where common channels and signals have certain characteristics that are a function of or depend on the cell, for example a cell identity or other attribute of a cell. A characteristic can include (1) time and/or frequency resources, for example time and/or frequency resources of common channels or signals, (2) scrambling or spreading sequence, for example sequence identity used to scramble a common channel or signal, (3) power level, for example power level of a common channel or signal, (4) spatial domain transmission or reception filter (e.g., transmit beam or receive beam), for example power level of a common channel or signal. Cells can be mapped or associated with RUs, DUs or CUs. The following are examples of mapping or associating cells with RUs, DUs, or CUs. This is not meant to be an exhaustive list.
A one-to-one association between a cell and an RU. A cell is associated with one RU and an RU is associated with one cell. This is illustrated by way of an example, in FIG. 21A.
A many-to-one association between cells and an RU. An RU is associated to a group of cells; a cell is associated to one RU (or part of an RU). This is illustrated, by way of an example, in FIG. 21B.
A one-to-many association between a cell and RUs. A cell is associated to a group of RUs, an RU is associated with one cell (or part of cell). This is illustrated, by way of an example, in FIG. 21C.
A one-to-one association between a cell and a DU. A cell is associated with one DU and a DU is associated with one cell. RUs belonging to a DU can be associated with a same cell.
A many-to-one association between cells and a DU. A DU is associated to a group of cells, a cell is associated to one DU (or part of a DU). The RUs within a DU can be associated to one or more cells. A cell can be associated to one or more RUs within a DU.
A one-to-many association between a cell and DUs. A cell is associated to a group of DUs, a DU is associated with one cell (part of a cell). RUs belonging to a DU can be associated with a same cell.
A one-to-one association between a cell and a CU. A cell is associated with one CU and a CU is associated with one cell. DUs and RUs belonging to a CU can be associated with a same cell.
A many-to-one association between cells and a CU. A CU is associated to a group of cells; a cell is associated to one CU (or part of a CU). The DUs within a CU can be associated to one or more cells. A cell can be associated to one or more DUs within a CU. The RUs within a CU can be associated to one or more cells. A cell can be associated to one or more RUs within a CU.
A one-to-many association between a cell and CUs. A cell is associated to a group of CUs; a CU is associated with one cell (part of a cell). DUs and RUs belonging to a CU can be associated with a same cell.

As a UE moves within a geographical area covered by the network, it can connect to the network through a different RU and/or a different DU and/or a different CU. In one example, a UE can connect to network through one RU. In one example, a UE can connect to the network through multiple, e.g., N RUs, in one example N=2. In one example, a UE can connect to the network through multiple, e.g., N RUs, and the N RUs belong to a same DU. In one example, a UE can connect to the network through multiple e.g., N RUs, and the N RUs belong to multiple, e.g., M DUs, in one example M=2. In one example, a UE can connect to the network through multiple e.g., N RUs, and the N RUs belong to multiple, e.g., M DUs, and the M DUs belong to a same CU. In one example, a UE can connect to the network through multiple e.g., N RUs, and the N RUs belong to multiple, e.g., M DUs, and the M DUs belong to multiple, e.g., K CUs, in one example K=2. In one example, one of the N RUs is referred to as a serving RU, wherein the remaining RUs can be regarded as non-serving RUs. In one example, one of the M DUs is referred to as a serving DU, wherein the remaining DUs can be regarded as non-serving DUs. In one example, one of the M DUs is referred to as a serving DU, and the RUs associated with the serving DU are referred to as serving RUs. In one example, one of the K CUs is referred to as a serving CU, wherein the remaining CUs can be regarded as non-serving CUs. In one example, one of the K CUs is referred to as a serving CU, and the DUs and/or RUs associated with the serving CU are referred to as serving DUs and/or RUs respectively.

In one example, a UE can connect to the network through multiple, e.g., N RUs, and the N RUs belong to a same cell. In one example, a UE can connect to the network through multiple e.g., N RUs, and the N RUs belong to multiple, e.g., Nc cells, in one example Nc=2. In one example, a UE can connect to the network through multiple, e.g., M DUs, and the M DUs belong to a same cell. In one example, a UE can connect to the network through multiple e.g., M DUs, and the M DUs belong to multiple, e.g., Mc cells, in one example Mc=2. In one example, a UE can connect to the network through multiple, e.g., K CUs, and the K CUs belong to a same cell. In one example, a UE can connect to the network through multiple e.g., K CUs, and the K CUs belong to multiple, e.g., Kc cells, in one example Kc=2.

In one example, a serving RU is associated with a serving cell. In one example, multiple serving RUs are associated with a serving cell. In one example, a serving DU is associated with a serving cell. In one example, multiple serving DUs are associated with a serving cell. In one example, a serving CU is associated with a serving cell. In one example, multiple serving CUs are associated with a serving cell.

In one example, as the UE moves throughout the geographical area covered by the network, it can change serving cell and/or serving RU and/or serving DU and/or serving CU according one or more of the following examples:
In one example, a change in serving cell involves no change in RU, e.g., the/a first serving cell and a second serving cell are served by a same RU (e.g., intra-RU mobility).
In one example, a change in serving cell involves a change in RU from a first RU to a second RU, and the first and second RUs are under a same DU and CU (e.g., intra-DU mobility).
In one example, a change in serving cell involves a change in RU and/or DU from a first RU/DU to a second RU/DU and the first RU/DU and the second RU/DU are under the same CU (e.g., inter-DU and intra-CU mobility).
In one example, a change in serving cell involves a change in RU and/or DU/or and CU from a first RU/DU/CU to a second RU/DU/CU (e.g., inter-CU mobility).

In one example, as the UE moves throughout the geographical area covered by the network, it doesn't change serving cell, but can connect to the network through an RU and/or DU and/or CU not belonging to a serving cell. In one example, as the UE moves through the network, the UE is indicated a new TCI state associated with a second cell, the serving cell is change to the second cell. In one example, the new TCI state is associated with a second RU and the second RU is associated with the second cell.

FIG. 22 illustrates a diagram of an example entity 2200 associated with spatial domain transmission filters (beams) according to embodiments of the present disclosure. For example, entity 2200 associated with spatial domain transmission filters (beams) can be implemented by the gNB 102 of FIG. 3. This example is for illustration only and other embodiments can be used without departing from the scope of the present disclosure.

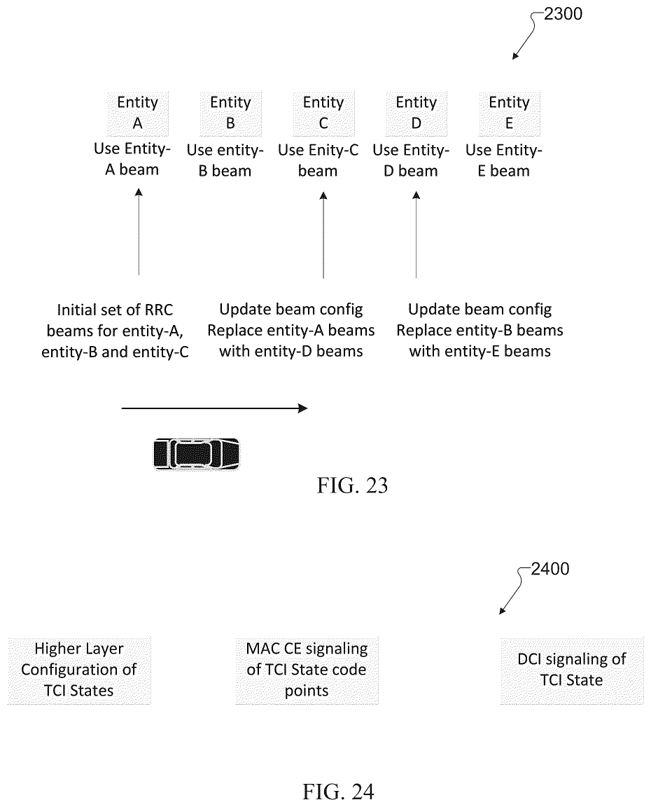

FIG. 23 illustrates a diagram of example UE mobility 2300 according to embodiments of the present disclosure. For example, UE mobility 2300 can be implemented by any of the UEs 111-116 of FIG. 1, such as the UE 111. This example is for illustration only and other embodiments can be used without departing from the scope of the present disclosure.

In the following examples an entity can include: a cell, a cell-part, a cell-group, an RU, an RU-part, an RU-group, a DU, a DU-part, a DU-group, a CU, a CU-part, a CU-group. An entity can be associated with N spatial domain transmission filters (N beams) as illustrated in FIG. 22. In one example, N=1. In one example, N is greater than 1. In one example, a common channel(s) of an entity, can be transmitted on one spatial domain transmission filter associated with the entity. In one example, a common channel(s) (e.g., common channel(s) carrying system information) of an entity, can be transmitted on a subset of spatial domain transmission filters associated with the entity. In one example, a common channel(s) of an entity, can be transmitted on spatial domain transmission filters associated with the entity. In one example, the common channel(s) of an entity is transmitted periodically. In one example, the common channel(s) of an entity are transmitted on demand, e.g., based on a condition or based on a signal from a UE.

In one example, a UE (e.g., in connected mode) is associated with a serving entity or entities, the UE additionally can monitor, measure or receive beams and/or common channels (e.g., common channels carrying system information) of additional entities (e.g., neighboring or adjacent entities to assist with mobility). Evaluate, for example, the scenario of FIG. 23, wherein a UE in connected mode is traversing the geographical area covered by the network. Initially, the UE starts at entity A, wherein entity A is configured as a serving entity, entities B and C are additional entities the UE is configured to monitor, measure, or receive their beams (e.g., based on reference signals and/or TCI states) and/or common channel(s). As the UE moves towards entity B, entity B can be configured/indicated as the serving entity (e.g., replacing entity A), the UE moves further towards entity C, now entity C can be configured/indicated as the serving entity (replacing entity B), furthermore, the list of additional entities to monitor, measure or receive can be updated to remove entity A and replace it by entity D. As the UE moves further to entity D, entity D becomes the serving entity (replacing entity C), and furthermore, the list of additional entities to monitor, measure or receive can be updated to remove entity B and replace it by entity E. In one example, the serving entity follows (or is that associated with) the indicated TCI state, wherein the indicated TCI state is a TCI state the UE uses to communicate with the network,

In a variant example, a UE (e.g., in connected mode), the UE can communicate with the network through an entity, the UE can be configured to monitor, measure or receive beams and/or common channels (e.g., common channels carrying system information) of additional entities (e.g., neighboring or adjacent entities to assist with mobility) in addition to the entity through which it communicates. Evaluate, for example, the scenario of FIG. 23, wherein a UE in connected mode is traversing the geographical area covered by the network. Initially, the UE starts at entity A, wherein entity A is the entity through which the UE communicates to the network, entities B and C are additional entities the UE is configured to monitor, measure, or receive their beams (e.g., based on reference signals and/or TCI states) and/or common channel(s). In one example, entity A, e.g., the entity in which the UE starts communicating with the network, e.g., in the entity in which the UE transitions to connected mode, is a serving entity. As the UE moves towards entity B, the UE communicates to the network through entity B (e.g., replacing entity A), the UE moves further towards entity C, now the UE communicates to the network through entity C (replacing entity B), furthermore, the list of additional entities to monitor, measure or receive can be updated to remove entity A and replace it by entity D. As the UE moves further to entity D, now the UE communicates to the network through entity D (replacing entity C), and furthermore, the list of additional entities to monitor, measure or receive can be updated to remove entity B and replace it by entity E. In one example, as the UE travels across the network, the serving entity is not changed. In one example, as the UE travels across the network the serving entity changes less frequently than then change of entity the UE uses to communicate with the network. In one example, the serving entity changes when the UE moves from an area covered by one CU to an area covered by another CU.

In one example, the information conveyed in the common channel(s) of an entity in a list of entities (e.g., the list of entities whose reference signals and/or common channels the UE is monitoring and/or receiving) can include one or more of the following:
Beam related information, which can be provided by reference signals and/or TCI states
Common DL configuration information of the corresponding entity. For example, DL control channel related information, which can include configuration information to assist the UE to receive and monitor DL control channel information from corresponding entity.
Common UL configuration information of the corresponding entity.

This information can seamlessly assist in the mobility of the UE as the UE moves to an entity and it becomes the serving entity, or the UE starts communicating through the entity, without disruption in communication between the UE and the network (e.g., the network 130).

There are a few aspects to evaluate in the previous example:
1. Configuration and update of the serving entity or entities, if needed.
2. Configuration and update of the additional entities.
3. Configuration of common channels of the additional entities.
4. Configuration of beams, e.g., for beam indication, of the additional entities.

In one example, the update of the serving entity or entities can be by RRC signaling and/or MAC CE signaling and/or L1 control signaling. In one example, there is no signaling to update the serving entity. In one example, there is an entity or entities through which the UE communicates with the network (e.g., serving entity or entities), wherein the entity or entities can be determined based on a beam indication, e.g., a beam indication determines one or more beams associated with one or more entities, and the UE uses the one or more beams to communicate with the network.

In one example, the update of the list of entities can be by RRC signaling and/or MAC CE signaling and/or L1 control signaling.

In one example, a UE is signaled additional reference signals (e.g., associated with additional entities) to monitor, measure or receive. In one example, a UE is signaled additional control channels (e.g., associated with additional entities) to monitor, measure or receive. In one example, the signaling is UE dedicated (or specific) signaling. In one example, the signaling is UE common signaling (e.g., UE-group common or cell common). In one example, the signaling can be RRC signaling and/or MAC CE signaling and/or L1 control signaling.

In the following system information can refer to system information for seamless mobility.

In one example, a UE “is indicated or determines” a set of entities to “monitor”.

In one example, “monitor” can refer to one or more of:
Measuring RS of an entity (e.g., RS transmitted by RU or TRP or RS of a cell) or neighboring entities or entities in a list can include:
   Information related to RS to monitor can be included in SI of serving entity or entities.
   Information related to RS to monitor can be included in SI of an entity or entries through which the UE is communicating with the network.
   Information related to RS to monitor can be included in SI of neighboring entity (e.g., UE first receives common channels neighboring entities then RS of neighboring entities)
   Information related to RS to monitor can be indicated using UE dedicated signaling.
   In one example, information related to RS can include one or more of: time and frequency resources, sequence or index of RS, and/or spatial domain filter and/or quasi-co-location information and/or antenna ports.
   In one example, the RS can be source RS of common channels (e.g., with SI) of the entity.
   In one example, the RS can be source RS of the entity.
   In one example measuring RS can include determining the link quality e.g., based on RSRP and SINR.
Receiving SI of neighbor entities (or entities in a list) can include
   Information related to common channels with SI to monitor can be included in SI of serving entity or entities.
   Information related to common channels with SI to monitor can be included in SI of an entity or entries through which the UE is communicating with the network.
   Information related to common channel with SI of neighboring cell can be indicated using UE dedicated signaling.
   In one example, information related to common channels can include one or more of: CORESETs and/or search spaces and/or radio network temporary identifiers (RNTIs) (e.g., for scrambling CRC) of PDCCHs associated with common channels, and/or time and/or frequency resources, and/or spatial domain filter and/or quasi-co-location information for receiving common channels and/or TCI state and/or channel coding parameters (e.g., modulation coding scheme (MCS) and/or transport block size (TBS) or common channels).
   In one example, receiving SI of neighboring can include decoding the corresponding channel (e.g., common channel) that carries the SI.

In one example, “is indicated or determines” neighboring entity or entities (or entity or entities to monitor) can refer to one or more of:
UE dedicated signaling indicates a neighboring entity or entities (or an entity or a list of entities to monitor)
   Dedicated signaling indicates a neighboring entity or entities (or an entity or a list of entities to monitor). Configuration parameters for common channels carrying SI and reference signals can be determined from SI or serving entity or of other entities the UE is monitoring.
   Dedicated signaling includes a neighboring entity or entities (or an entity or a list of entities to monitor) with common channel configuration and/or RS configuration. In one example, configuration information includes common channel configuration and no RS configuration. In one example, configuration information includes common channel configuration and common channel source RS configuration. In one example, configuration information includes common channel configuration and RS configuration for the entity or entities. In one example, configuration information includes common channel source RS configuration. In one example, configuration information includes RS configuration for the entity or entities.
UE determines a neighboring entity or entities (or an entity or a list of entities to monitor)
   Based on indicated TCI state(s) and a mapping or association or linkage between the TCI states and neighboring entities or entities to monitor.
   Based on activated TCI state(s) and a mapping or association or linkage between the TCI states and neighboring entities or entities to monitor.
   Based on measurement of RS of entity or entities monitored, additional (e.g., neighboring) entities can be monitored e.g., based on link quality of these RS exceeding a threshold and a mapping or association or linkage between the RS and entities to monitor.

In one example, “is indicated or determines” serving entity or entities can refer to one or more of:
Dedicated signaling indicates an entity or a list of entities as a serving entity or entities.
UE determines a serving entity or a list of entities
   Based on indicated TCI state(s) and a mapping or association or linkage between the TCI states and serving entities.
   Based on activated TCI state(s) and a mapping or association or linkage between the TCI states and serving entities.
   Based on measurement of RS of entity or entities monitored, a serving entity or entities can be determined e.g., based on link quality of these RS exceeding a threshold and a mapping or association or linkage between the RS and serving entities.

In one example, “is indicated or determines” entity or entities for communication with the network can refer to one or more of:
Dedicated signaling indicates an entity or a list of entities for communication with the network.
UE determines an entity or a list of entities for communication with the network
   Based on indicated TCI state(s) and a mapping or association or linkage between the TCI states and entities for communication with the network.
   Based on activated TCI state(s) and a mapping or association or linkage between the TCI states and entities for communication with the network.
   Based on measurement of RS of entity or entities monitored, an entity or entities for communication with the network can be determined e.g., based on link quality of these RS exceeding a threshold and a mapping or association or linkage between the RS and entities for communication with the network.

In one example, a UE (e.g., the UE 116) is associated with a serving entity or entities, or the UE communicates through one or more entities; the UE is additionally configured to receive common channels for a list of additional entities. In one example, a UE is configured or indicated a list of entities from which to receive common channels (e.g., common channels with system information). In one example, the signaling or configuration or indication is UE dedicated (or specific) signaling. In one example, the signaling or configuration or indication is UE common signaling (e.g., UE-group common or cell common). The configuration or indication of the list of entities can be by RRC signaling and/or MAC CE signaling and/or L1 control signaling. In one example, the UE is provided a configuration for the common channel(s) of entities of the list of entities. The configuration can include, CORESETs and/or search spaces and/or RNTIs (e.g., for scrambling CRC) of PDCCHs associated with common channels. The configuration can include, resources used for the common channel, MCS, TBS, payload and information content of the common channel, beam indication of the common channel. In one example, a UE monitors and receives control channels associated with an entity in the list of entities and the control channel includes configuration information for the associated common channel.

In one example, the UE is configured a beam indication(s) for each entity in the list, the UE uses the beam indication to receive the corresponding common channel(s) of the entity. In one example, the beam indication(s) is a reference signal(s), wherein the UE receives a configuration of a reference signal associated with the corresponding entity. In one example, the beam indication(s) is a TCI state(s), wherein the UE receives a configuration of a TCI state associated with the corresponding entity.

In one example, a UE is configured with N reference signals and/or M TCI states for each entity in the list. The UE measures the N reference signals of an entity and determines a reference signal and a corresponding beam to receive the common channel(s) of the corresponding entity. In one example, the determination of the reference signal is based on RSRP or SINR of reference signal and a corresponding configured threshold.

In one example, a UE is configured with N reference signals and/or M TCI states for each entity in the list. The UE measures the N reference signals of an entity. The UE reports the measurement to the network. Based on the measurement, the network can indicate a beam to receive the corresponding common channel(s) of the entity. In one example, the beam indication is a reference signal. In one example, the beam indication is a TCI state. In one example, the common channel(s) is transmitted in response to the measurement report of the UE (e.g., on demand transmission of the common channel(s) of an entity), and using the beam indicated to the UE. The transmission can be a one shot transmission, or transmission for K times, or transmission until an indication (e.g., acknowledgement) from the UE that the common channel(s) has been received.

In one example, a UE is associated with a serving entity or entities S, or the UE communicates with the network through entity or entities S; the UE is additionally configured to receive common channels for a list of additional entities. In one example, a UE is configured or indicated a list of entities from which to receive common channels. In one example, the signaling or configuration or indication is UE dedicated (or specific) signaling. In one example, the signaling or configuration or indication is UE common signaling (e.g., UE-group common or cell common). The configuration or indication of the list of entities can be by RRC signaling and/or MAC CE signaling and/or L1 control signaling. In one example, the UE is provided a configuration for the common channel(s) of entities of the list of entities. The configuration can include, CORESETs and/or search spaces and/or RNTIs (e.g., for scrambling CRC) of PDCCHs associated with common channels. The configuration can include, resources used for the common channel, MCS, TBS, payload and information content of the common channel, beam indication of the common channel. In one example, a UE monitors and receives control channels associated with an entity in the list of entities, and the control channel includes configuration information for the associated common channel.

In one example, a UE receives common channels associated with entity or entities S. In one example, common channel(s) associated with entity or entities S, include reference signals associated with the list of entities. In one example, the UE measures the reference signals of an entity in the list of entities and determines a reference signal and a corresponding beam to receive the common channel(s) of the corresponding entity. In one example, the determination of the reference signal is based on RSRP or SINR of reference signal and a corresponding configured threshold.

In one example, a UE receives common channels associated with entity or entities S. In one example, common channel(s) associated with entity or entities S, include reference signals associated with the list of entities. In one example, the UE measures the reference signals of an entity in the list of entities. The UE reports the measurement to the network. Based on the measurement, the network can indicate a beam to receive the corresponding common channel(s) of the entity. In one example, the beam indication is a reference signal. In one example, the beam indication is a TCI state. In one example, the common channel(s) is transmitted in response to the measurement report of the UE (e.g., on demand transmission of the common channel(s) of an entity), and using the beam indicated to the UE. The transmission can be a one shot transmission, or transmission for K times, or transmission until an indication (e.g., acknowledgement) from the UE that the common channel(s) has been received.

In one example, the configuration of common channels (e.g., with system information (SI)) associated with an entity (e.g., monitored by the UE) can be based on one or more of the following:
Common signaling (e.g., information such as system information (SI) conveyed on common channels). The common channels can be one or more of the following:
   Common signaling (channel(s)) of serving entit(ies).
   Common signaling (channel(s)) of entit(ies) through which the UE communicates with the network.
   Common signaling (channel(s)) of monitored neighboring entit(ies).
   In one example, common signaling is SIB signaling. In one example, common signaling is MAC CE signaling. In one example, common signaling is L1 control signaling.
UE dedicated signaling. Wherein, the UE dedicated signaling can be RRC signaling and/or MAC CE signaling and/or L1 control signaling.

In one example, the configuration of reference signal associated with an entity (e.g., monitored by the UE) can be based on one or more of the following:
Common signaling (e.g., information such as system information (SI) conveyed on common channels). The common channels can be one or more of the following:
   Common signaling (channel(s)) of serving entit(ies).
   Common signaling (channel(s)) of entit(ies) through which the UE communicates with the network.
   Common signaling (channel(s)) of monitored neighboring entit(ies).
   In one example, common signaling is SIB signaling. In one example, common signaling is MAC CE signaling. In one example, common signaling is L1 control signaling.
UE dedicated signaling. Wherein the UE dedicated signaling can be RRC signaling and/or MAC CE signaling and/or L1 control signaling.

In one example, a UE provides measurement reports to the network based on the reference signals it monitors.

In one example, the gNB (e.g., the BS 102) or network activates and/or indicates TCI states based on measurement reports.

In one example, the gNB or network can indicate serving entit(ies) and/or neighboring entit(ies) to monitor based on measurement reports. In one example, the gNB or network can indicate entit(ies) through which the UE communicates with the network and/or neighboring entit(ies) to monitor based on measurement reports.

In one example, there are multiple levels of common channels.
First level of common channels is at the sub-entity level. The common channel information applies to part of an entity. In one example, the first level of common channels is broadcast on part of an entity. For example, a sub-entity can be a subset of beams (including one case beam) of an entity.
Second level of common channels is at the entity level. The common channel information applies to an entity. In one example, the second level of common channels is broadcast on an entity
Third level of common channels is at the group-entity level. The common channel information applies to a group of entities. In one example, the third level of common channels is broadcast on a group of entities. In one example, a group of entities can be the entire network, e.g., network wide information.

In one example, a UE is configured reference signals, wherein a reference signal is used for beam indication. In one example, the reference signals are associated with a serving cell. In one example, the reference signals are associated with a serving RU. In one example, the reference signals are associated with a cell other than the serving cell(s) (e.g., non-serving cell). In one example, the reference signals are associated with an RU other than the serving RU(s) (e.g., non-serving RU).

In one example, a UE is configured reference signals, wherein a reference signal is used for beam indication. In one example, the reference signals are associated with a cell through which the UE communicates with the network. In one example, the reference signals are associated with a RU through which the UE communicates with the network. In one example, the reference signals are associated with a cell (e.g., neighboring cell) other than the cell(s) through which the UE communicates with the network. In one example, the reference signals are associated with an RU (e.g. neighboring RU) other than the RU(s) through which the UE communicates to the network.

A neighboring cell or a neighboring RU can be referred to as a neighboring entity.

In one following examples, a reference signal configuration can include one or more of the following:
Reference signal ID
Antenna port(s) of the reference signal.
Time domain resources for reference signal, including symbols and/or slots and/or subframes and/or frames in which the reference signal is transmitted, as well as periodicity type (aperiodic, or semi-persistent or periodic) and period and/or offset for periodic or semi-persistent reference signals.
Frequency domain resources, including PRBs and/or sub-carriers and/or BWPs in which the reference signal is transmitted.
Scrambling or spreading codes or sequences.
Transmit power or transmit power offset to a reference signal.
Spatial domain filter (beam) information, e.g., TCI state or spatial relation or reference to another reference signal used for beam information.

In one example, the configuration of reference signal associated with an entity (e.g., monitored by the UE) can be based on one or more of the following:
Common signaling (e.g., information such as system information (SI) conveyed on common channels). The common channels can be one or more of the following:
   Common signaling (channel(s)) of serving entit(ies).
   Common signaling (channel(s)) of entit(ies) through which the UE communicates with the network.
   Common signaling (channel(s)) of monitored neighboring entit(ies).
   In one example, common signaling is SIB signaling. In one example, common signaling is MAC CE signaling. In one example, common signaling is L1 control signaling.
UE dedicated signaling. Wherein the UE dedicated signaling can be RRC signaling and/or MAC CE signaling and/or L1 control signaling.

In one example, the configuration of the reference signals is through UE specific (i.e. UE dedicated) signaling.

In one example, the configuration of the reference signals is through common channel signaling. In one example, common channel signaling can include:
Common channel signaling associated with a cell. Wherein, the common channel signaling includes reference signal configuration as mentioned herein. In one example, the reference signals configured in a common channel of a cell, are the reference signals of the cell. In one example, the reference signals configured in a common channel of a cell are the reference signals of the cell and other cells (e.g., nearby or neighbor cells). In one example, the reference signals configured in a common channel of a cell are the reference signals of other cells (e.g., nearby or neighbor cells).
Common channel signaling associated with a part of a cell. Wherein, the common channel signaling includes reference signal configuration as mentioned herein. In one example, the reference signals configured in a common channel of a part of a cell, are the reference signals of the part of the cell. In one example, the reference signal configured in a common channel of a part of a cell are the reference signals of the part of the cell and other parts of cells (e.g., nearby or neighbor parts of cells). In one example, the reference signal configured in a common channel of a part of a cell are the reference signals of other parts of cells (e.g., nearby or neighbor parts of cells).
Common channel signaling associated with a cell-group. Wherein, the common channel signaling includes reference signal configuration as mentioned herein. In one example, the reference signals configured in a common channel of a cell-group, are the reference signals of the cell-group. In one example, the reference signals configured in a common channel of a cell-group are the reference signals of the cell-group and other cell-groups (e.g., nearby or neighbor cell-groups). In one example, the reference signals configured in a common channel of a cell-group are the reference signals of other cell-groups (e.g., nearby or neighbor cell-groups).
Common channel signaling associated with an RU. Wherein, the common channel signaling includes reference signal configuration as mentioned herein. In one example, the reference signals configured in a common channel of an RU, are the reference signals of the RU. In one example, the reference signals configured in a common channel of an RU are the reference signals of the RU and other RUs (e.g., nearby or neighbor RUs). In one example, the reference signals configured in a common channel of an RU are the reference signals of other RUs (e.g., nearby or neighbor RUs).
Common channel signaling associated with a part of an RU. Wherein, the common channel signaling includes reference signal configuration as mentioned herein. In one example, the reference signals configured in a common channel of a part of an RU, are the reference signals of the part of the RU. In one example, the reference signal configured in a common channel of a part of the RU are the reference signals of the part of the RU and other parts of RUs (e.g., nearby or neighbor parts of RUs). In one example, the reference signal configured in a common channel of a part of an RU are the reference signals of other parts of RUs (e.g., nearby or neighbor parts of RUs). In one example, a part of an RU, can be one or more beams served by the RU.
Common channel signaling associated with an RU-group. Wherein, the common channel signaling includes reference signal configuration as mentioned herein. In one example, the reference signals configured in a common channel of an RU-group, are the reference signals of the RU-group. In one example, the reference signal configured in a common channel of an RU-group are the reference signals of the RU-group and other RU-groups (e.g., nearby or neighbor RU-groups). In one example, the reference signals configured in a common channel of an RU-group are the reference signals of other RU-groups (e.g., nearby or neighbor RU-groups).
Common channel signaling associated with an entity. Wherein, the common channel signaling includes reference signal configuration as mentioned herein. In one example, the reference signals configured in a common channel of an entity, are the reference signals of the entity. In one example, the reference signals configured in a common channel of an entity are the reference signals of the entity and other entities (e.g., nearby or neighbor entities). In one example, the reference signals configured in a common channel of entity are the reference signals of other entities (e.g., nearby or neighbor entities). An entity can include: a cell, a cell-part, a cell-group, an RU, an RU-part, an RU-group, a DU, a DU-part, a DU-group, a CU, a CU-part, a CU-group.
Common channel signaling associated with a group of UEs. Wherein, the control channels are configured for a group of UEs.

In one example, a UE receives a reference signal configuration of an entity, by receiving a common channel of an entity (e.g., system information block (SIB) of an entity) that includes the reference signal configuration of the entity.

In one example, a UE receives a reference signal configuration of an entity, by receiving a dedicated configuration (e.g., dedicated RRC signaling) that includes the reference signal configuration of the entity. A reference signal is identified or determined by a reference signal ID for an entity and a corresponding entity ID. This is illustrated in TABLE 1.

TABLE 1
Example of identification of a reference signal.

| | | |
|---|---|---|
| Reference signal X | Reference signal ID or | ID or index of entity Y |
| | index for entity Y | |

In a variant example, a UE is configured a list of entities, e.g., {A, B, C, D, E . . . }, a reference signal is identified or determined by a reference signal ID or index, wherein the reference signal TD or index can be determined by: Reference signal ID or index=(Reference signal TD or index for entity Y)+(TD or index of entity Y)*N, wherein N is the number (or maximum number) of reference signals per entity.

In a variant example, a UE is configured a list of entities, e.g., {A, B, C, D, E . . . }, a reference signal is identified or determined by a reference signal ID or index, wherein the reference signal TD or index can be determined by: Reference signal TD or index=(Reference signal TD or index for entity Y)+(sum of reference signals per entity for entities before entity Y). This is illustrated, by way of example in TABLE 2, where five entities are configured {0, 1, 2, 3, 4}, entity 0 has n0 reference signals configured, entity 1 has n1 reference signals configured, entity 2 has n2 reference signals configured, entity 3 has n3 reference signals configured, and entity 4 has n4 reference signals configured.

TABLE 2
Example of identification of a reference signal

| | Reference signal (entity and reference signal |
|---|---|
| Reference signal ID | ID in entity) |
| 0 | Entity 0, RS 0 |
| 1 | Entity 0, RS 1 |
| . . . | |
| n0 − 1 | Entity 0, RS n0 − 1 |
| n0 | Entity 1, RS 0 |
| n0 + 1 | Entity 1, RS 1 |
| . . . | . . . |
| n0 + n1 − 1 | Entity 1, RS n1 − 1 |
| . . . | . . . |
| n0 + n1 + n2 + n3 | Entity 4, RS 0 |
| n0 + n1 + n2 + n3 + 1 | Entity 4, RS 1 |
| . . . | . . . |
| n0 + n1 + n2 + n3 + n4 − 1 | Entity 4, RS n4 − 1 |

In one example of the previous examples, A (the first entity in the list of entities) is a serving entity. In one example of the previous examples, A (the first entity in the list of entities) is an entity through which the UE communicates with the network (e.g., the network 130).

In one example, a UE can receive common channels of an entity (for example a serving entity), e.g., entity A. In one example, a UE can receive common channels of an entity (for example an entity through which a UE communicates with the network), e.g., entity A. In one example, a common channel of entity A includes reference signal configuration of other entities (for example adjacent or neighboring entities), e.g., entities {B, C, D, E, . . . }. In one example, a UE can receive a dedicated configuration (e.g., dedicated RRC signaling), wherein the dedicated configuration includes a reference signal configuration for entity A and for entities {B, C, D, E, . . . }.

In one example, the configuration includes a unique reference signal ID for each entity, including entity A.

In one example, the configuration includes two lists of reference signals, a first list for entity A, and a second list for entities {B, C, D, E, . . . }, the reference signals of each list has a unique reference signal ID. A reference signal is identified or determined by a reference signal ID within a list and a corresponding list ID (e.g., list 0 or list 1).

In variant example, a reference signal is identified or determined by a reference signal ID or index, wherein the reference signal ID or index can be determined by:

Reference signal ID or index=(Reference signal ID or index for list Y)+(ID or index of list Y)*N, wherein N is the number (or maximum number) of reference signals per list.

In a variant example, a reference signal is identified or determined by a reference signal ID or index, wherein the reference signal ID or index can be determined by: Reference signal ID or index=(Reference signal ID or index for list Y)+(sum of reference signals per list for lists before entity Y).

In a variant example of the mentioned herein examples, a first list is for entities {A, A1, A2, . . . }, and a second list is for entities {B, C, D, E . . . }.

In a variant example of the examples mentioned herein, there are N lists of reference signals configured, wherein a first list is for entities {A, A1, . . . }, a second list is for entities, {B, B1, B2, . . . }, . . . . In variant example, a list of reference signals is configured for each entity.

In one example, a UE or the network (e.g., a gNB) can use a reference signal to identify a beam. For example, the reference signal identity, as mentioned herein, can be used to indicate a beam. Channels or signals associated with the beam are received or transmitted using a spatial domain reception or transmission filter associated with the reference signal.

In one example, a reference signal is included in a TCI state or a spatial relation as a source reference signal or a reference for a spatial domain filter (beam). For example, the reference signal identity, as mentioned herein, can be included in or associated with a TCI state or spatial relation.

In the following a TCI state is used to refer generically to TCI state or spatial relation or other information element used for beam indication or spatial domain filter indication.

In one following examples, a TCI state configuration can include one or more of the following:
TCI state ID
Quasi-co-location Type
Source reference signal for quasi-co-location.
Pathloss reference signal
Power control parameters (e.g., P0, alpha and closed-loop index)
TAG (timing advance group) index

In one example, the configuration of TCI states associated with an entity (e.g., monitored by the UE) can be based on one or more of the following:
Common signaling (e.g., information such as system information (SI) conveyed on common channels). The common channels can be one or more of the following:
   Common signaling (channel(s)) of serving entit(ies).
   Common signaling (channel(s)) of entit(ies) through which the UE communicates with the network.
   Common signaling (channel(s)) of monitored neighboring entit(ies).
   In one example, common signaling is SIB signaling. In one example, common signaling is MAC CE signaling. In one example, common signaling is L1 control signaling.
UE dedicated signaling. Wherein the UE dedicated signaling can be RRC signaling and/or MAC CE signaling and/or L1 control signaling.

In one example, the configuration of the TCI states is through UE specific (i.e. UE dedicated) signaling.

In one example, the configuration of the TCI states is through common channel signaling. In one example, common channel signaling can include:
Common channel signaling associated with a cell. Wherein, the common channel signaling includes TCI state configuration as mentioned herein. In one example, the TCI states configured in a common channel of a cell, are the TCI states of the cell. In one example, the TCI states configured in a common channel of a cell are the TCI states of the cell and other cells (e.g., nearby or neighbor cells). In one example, the TCI states configured in a common channel of a cell are the TCI states of other cells (e.g., nearby or neighbor cells).
Common channel signaling associated with a part of a cell. Wherein, the common channel signaling includes TCI state configuration as mentioned herein. In one example, the TCI states configured in a common channel of a part of a cell, are the TCI states of the part of the cell. In one example, the TCI state configured in a common channel of a part of a cell are the TCI states of the part of the cell and other parts of cells (e.g., nearby or neighbor parts of cells). In one example, the TCI state configured in a common channel of a part of a cell are the TCI states of other parts of cells (e.g., nearby or neighbor parts of cells).
Common channel signaling associated with a cell-group. Wherein, the common channel signaling includes TCI state configuration as mentioned herein. In one example, the TCI states configured in a common channel of a cell-group, are the TCI states of the cell-group. In one example, the TCI states configured in a common channel of a cell-group are the TCI states of the cell-group and other cell-groups (e.g., nearby or neighbor cell-groups). In one example, the TCI states configured in a common channel of a cell-group are the TCI states of other cell-groups (e.g., nearby or neighbor cell-groups).
Common channel signaling associated with an RU. Wherein, the common channel signaling includes TCI state configuration as mentioned herein. In one example, the TCI states configured in a common channel of an RU, are the TCI states of the RU. In one example, the TCI states configured in a common channel of an RU are the TCI states of the RU and other RUs (e.g., nearby or neighbor RUs). In one example, the TCI states configured in a common channel of an RU are the TCI states of other RUs (e.g., nearby or neighbor RUs).
Common channel signaling associated with a part of an RU. Wherein, the common channel signaling includes TCI state configuration as mentioned herein. In one example, the TCI states configured in a common channel of a part of an RU, are the TCI states of the part of the RU. In one example, the TCI state configured in a common channel of a part of the RU are the TCI states of the part of the RU and other parts of RUs (e.g., nearby or neighbor parts of RUs). In one example, the TCI state configured in a common channel of a part of an RU are the TCI states of other parts of RUs (e.g., nearby or neighbor parts of RUs). In one example, a part of an RU, can be one or more beams served by the RU.
Common channel signaling associated with an RU-group. Wherein, the common channel signaling includes TCI state configuration as mentioned herein. In one example, the TCI states configured in a common channel of an RU-group, are the TCI states of the RU-group. In one example, the TCI state configured in a common channel of an RU-group are the TCI states of the RU-group and other RU-groups (e.g., nearby or neighbor RU-groups). In one example, the TCI states configured in a common channel of an RU-group are the TCI states of other RU-groups (e.g., nearby or neighbor RU-groups).
Common channel signaling associated with an entity. Wherein, the common channel signaling includes TCI state configuration as mentioned herein. In one example, the TCI states configured in a common channel of an entity, are the TCI states of the entity. In one example, the TCI states configured in a common channel of an entity are the TCI states of the entity and other entities (e.g., nearby or neighbor entities). In one example, the TCI states configured in a common channel of entity are the TCI states of other entities (e.g., nearby or neighbor entities). An entity can include: a cell, a cell-part, a cell-group, an RU, an RU-part, an RU-group, a DU, a DU-part, a DU-group, a CU, a CU-part, a CU-group.
Common channel signaling associated with a group of UEs. Wherein, the control channels are configured for a group of UEs.

In one example, a UE (e.g., the UE 116) receives a TCI state configuration of an entity, by receiving a common channel of an entity (e.g., system information block (SIB) of an entity) that includes the TCI state configuration of the entity. In one example, a UE receives a TCI state configuration of an entity, by receiving a dedicated configuration (e.g., dedicated RRC signaling) that includes the TCI state configuration of the entity. A TCI state is identified or determined by a TCI state ID for an entity and a corresponding entity ID. This is illustrated in TABLE 3.

TABLE 3
Example of identification of a TCI state.

| | | |
|---|---|---|
| TCI state X | TCI state ID or index for entity Y | ID or index of entity Y |

In a variant example, a UE is configured a list of entities, e.g., {A, B, C, D, E . . . }, a TCI state is identified or determined by a TCI state ID or index, wherein the TCI state ID or index can be determined by: TCI state ID or index=(TCI state ID or index for entity Y)+(ID or index of entity Y)*N, wherein N is the number (or maximum number) of TCI states per entity.

In a variant example, a UE is configured a list of entities, e.g., {A, B, C, D, E . . . }, a TCI state is identified or determined by a TCI state ID or index, wherein the TCI state ID or index can be determined by: TCI state ID or index=(TCI state ID or index for entity Y)+(sum of TCI states per entity for entities before entity Y). This is illustrated, by way of example in TABLE 4, where five entities are configured {0, 1, 2, 3, 4}, entity 0 has n0 TCI states configured, entity 1 has n TCI states configured, entity 2 has n2 TCI states configured, entity 3 has n3 TCI states configured, and entity 4 has n4 TCI states configured.

TABLE 4
Example of identification of a TCI state

| TCI state ID | TCI state (entity and TCI state ID in entity) |
|---|---|
| 0 | Entity 0, TCI state 0 |
| 1 | Entity 0, TCI state 1 |
| . . . | |
| n0 − 1 | Entity 0, TCI state n0 − 1 |
| n0 | Entity 1, TCI state 0 |
| n0 + 1 | Entity 1, TCI state 1 |
| . . . | . . . |
| n0 + n1 − 1 | Entity 1, TCI state n1 − 1 |
| . . . | . . . |
| n0 + n1 + n2 + n3 | Entity 4, TCI state 0 |
| n0 + n1 + n2 + n3 + 1 | Entity 4, TCI state 1 |
| . . . | . . . |
| n0 + n1 + n2 + n3 + n4 − 1 | Entity 4, TCI state n4 − 1 |

In one example of the previous examples, A (the first entity in the list of entities) is a serving entity. In one example of the previous examples, A (the first entity in the list of entities) is an entity through which the UE communicates with the network.

In one example, a UE can receive common channels of an entity (for example a serving entity), e.g., entity A. In one example, a UE can receive common channels of an entity (for example an entity through which a UE communicates with the network), e.g., entity A. In one example, a common channel of entity A includes TCI state configuration of other entities (for example adjacent or neighboring entities), e.g., entities {B, C, D, E, . . . }. In one example, a UE can receive a dedicated configuration (e.g., dedicated RRC signaling), wherein the dedicated configuration includes a TCI state configuration for entity A and for entities {B, C, D, E, . . . }.

In one example, the configuration includes a unique TCI state TD for each entity, including entity A.

In one example, the configuration includes two lists of TCI states, a first list for entity A, and a second list for entities {B, C, D, E, . . . }, the TCI states of each list has a unique TCI state ID. A TCI state is identified or determined by a TCI state ID within a list and a corresponding list ID (e.g., list 0 or list 1).

In variant example, a TCI state is identified or determined by a TCI state ID or index, wherein the TCI state ID or index can be determined by: TCI state ID or index=(TCI state ID or index for list Y)+(ID or index of list Y)*N, wherein N is the number (or maximum number) of TCI states per list. In a variant example, a TCI state is identified or determined by a TCI state ID or index, wherein the TCI state ID or index can be determined by: TCI state ID or index=(TCI state ID or index for list Y)+(sum of TCI states per list for lists before entity Y).

In a variant example of the examples mentioned herein, a first list is for entities {A, A1, A2, . . . }, and a second list is for entities {B, C, D, E, . . . }.

In a variant example of the examples mentioned herein, there are N lists of TCI states configured, wherein a first list is for entities {A, A1, . . . }, a second list is for entities, {B, B1, B2, . . . } . . . . In variant example, a list of TCI states is configured for each entity.

In one example, a UE or the network (e.g., a gNB) can use a TCI state to identify a beam. For example, the TCI state identity, as mentioned herein, can be used to indicate a beam. Channels or signals associated with the TCI state are received or transmitted using a spatial domain reception or transmission filter associated with the TCI state.

In one example, a TCI state configuration includes a source reference signal, wherein the source reference signal's identity is that of entity for which the TCI state is configured.

In one example, a TCI state configuration includes a source reference signal, and an entity of the source reference signal, wherein the source reference signal's identity is that of the entity.

In one example, a TCI state configuration includes a source reference signal, wherein the source reference signal's identity is a global identity is across multiple entities determined as mentioned herein.

In one example, a subset of the configured reference signals is activated for beam indication, wherein the reference signals can belong one or more entities. In one example, the activated reference signals are a set of RS codepoints, wherein a codepoint can include RS for DL receptions or RS for UL transmissions or RS for joint DL receptions and UL transmissions or a pair of RSs, one for DL receptions and the other for UL transmissions.

In one example, a subset of the configured entities is activated, and a subset of the configured reference signals of the activated entities is activated for beam indication. In one example, the activated reference signals are a set of RS codepoints, wherein a codepoint can include RS for DL receptions or RS for UL transmissions or RS for joint DL receptions and UL transmissions or a pair of RSs, one for DL receptions and the other for UL transmissions.

In one example, a subset of the configured TCI states is activated, wherein the TCI states can belong one or more entities. In one example, the activated TCI states are a set of TCI state codepoints, wherein a codepoint can include DL TCI state or UL TCI state or Joint TCI state or a pair of UL and DL TCI states.

In one example, a subset of the configured entities is activated, and a subset of the configured TCI states of the activated entities is activated. In one example, the activated TCI states are a set of TCI state codepoints, wherein a codepoint can include DL TCI state or UL TCI state or Joint TCI state or a pair of UL and DL TCI states.

In one example, a UE is indicated a reference signal (RS) for beam indication for UE dedicated channels. In one example, the indicated RS for beam indication is a RS ID or RS codepoint form the activated RSs or RS codepoints. In one example, the indicated RS for beam indication is a RS ID form the configured RSs.

In one example, a UE is indicated a TCI state for UE dedicated channels. In one example, the indicated TCI state is a TCI state ID or TCI state codepoint form the activated TCI states or TCI state codepoints. In one example, the indicated TCI state is a TCI state ID form the configured TCI states.

In one example, a UE is indicated a reference signal for beam indication for UE common channel(s) of an entity for the list of entities a UE is receiving or monitoring.

In one example, a UE is indicated a TCI state for UE common channel(s) of an entity for the list of entities a UE is receiving or monitoring.

In one example, the beam indication (e.g., reference signal or TCI state) of a serving entity is the same as the beam indication (e.g., reference signal or TCI state) of a UE dedicated channel.

In one example, a UE is indicated a reference signal for beam indication for UE common channel(s) of a serving entity.

In one example, a UE is indicated a reference signal for beam indication for UE common channel(s) of an entity through which the UE communicates with the network.

In one example, a UE is indicated a TCI state for UE common channel(s) of a serving entity.

In one example, a UE is indicated a TCI state for UE common channel(s) of an entity through which the UE communicates with the network.

Rel-17 introduced the unified TCI framework, where a unified or main or indicated TCI state is signaled to the UE. The unified o or main or indicated TCI state can be one of:
1. In case of joint TCI state indication, wherein a same beam or port/PG is used for DL and UL channels, a joint TCI state that can be used at least for UE-dedicated DL channels and UE-dedicated UL channels.
2. In case of separate TCI state indication, wherein different beams or ports/PGs are used for DL and UL channels, a DL TCI state that can be used at least for UE-dedicated DL channels.
3. In case of separate TCI state indication, wherein different beams or ports/PGs are used for DL and UL channels, a UL TCI state that can be used at least for UE-dedicated UL channels.

The unified (main or indicated) TCI state is TCI state of UE-dedicated reception on PDSCH/PDCCH or dynamic-grant/configured-grant based PUSCH and dedicated PUCCH resources. In this disclosure, a TCI state can be referred to as a spatial resource unit.

The unified TCI framework also applies to intra-cell beam management, wherein, the TCI states have a source RS that is directly or indirectly associated, through a quasi-co-location relation, e.g., spatial relation, with an SSB or port/PG of a serving cell (e.g., the TCI state is associated with a TRP of a serving cell). The unified TCI state framework also applies to inter-cell beam management, wherein a TCI state can have a source RS that can be directly or indirectly associated, through a quasi-co-location relation, e.g., spatial relation, with an SSB or port/PG of cell that has a physical cell identity (PCI) different from the PCI of the serving cell (e.g., the TCI state is associated with a TRP of a cell having a PCI different from the PCI of the serving cell).

Quasi-co-location (QCL) relation, can be quasi-location with respect to one or more of the following relations [38.214—section 5.1.5]:
Type A, {Doppler shift, Doppler spread, average delay, delay spread}
Type B, {Doppler shift, Doppler spread}
Type C, {Doppler shift, average delay}
Type D, {Spatial Rx parameter} or port/PG

In addition, quasi-co-location relation and source reference signal or port/PG can also provide a spatial relation for UL channels, e.g., a DL source reference signal or ports/PGs provides information on the spatial domain filter or port/PG to be used for UL transmissions, or the UL source reference signal or ports/PGs provides the spatial domain filter to be used for UL transmissions, e.g., same spatial domain filter for UL source reference signal and UL transmissions.

The unified (main or indicated) TCI state applies at least to UE dedicated DL and UL channels. The unified (main or indicated) TCI can also apply to other DL and/or UL channels and/or signals e.g. non-UE dedicated channel and sounding reference signal (SRS).

A UE is indicated a TCI state by MAC CE when the MAC CE activates one TCI state code point. The UE applies the TCI state code point after a beam application time from the corresponding HARQ-ACK feedback. A UE is indicated a TCI state by a DL related DCI format (e.g., DCI Format 1_1, or DCI format 1_2) or an UL related DCI format (e.g. format 0_1 or 0_2), wherein the DCI format includes a “transmission configuration indication” field that includes/indicates a TCI state code point out of the TCI state code points activated by a MAC CE. A DL related DCI format (or an UL related DCI format) can be used to indicate a TCI state when the UE is activated with more than one TCI state code points. The DL related DCI format can be with a DL assignment for PDSCH reception or without an DL assignment. Likewise, the UL related DCI format can be with a UL grant for PUSCH transmission or without an UL grant. A TCI state can also be indicated in a purpose designed channel or DCI Format for TCI state indication. A TCI state (TCI state code point) indicated/included in a DL related DCI format or UL related DCI format or purpose design channel or DCI Format for TCI state indication is applied after a beam application time from the corresponding HARQ-ACK feedback.

FIG. 7 illustrates an example of the protocol stack of NR networks including physical (PHY) layer, medium access control (MAC) layer, radio link control (RLC) layer, packet data convergence protocol (PDCD) layer, for control plane there is radio resource control (RRC) layer, and for user plane there is service data adaptation protocol (SDAP) layer.

There can be different mappings of the layers of the protocol stack to actual devices implementing these functionalities. In one example, layers of the protocol stack can be mapped to a single device. In another example, the layers of the protocol stack can be split across multiple devices. 3GPP [TR 38.801] evaluated different functional split points between a central unit (CU) containing the higher layers of the protocol stack and a distributed unit (DU) containing the lower layers of the protocol stack. The functional split options evaluated by 3GPP are illustrated in FIG. 8 (TR 38.801—FIG. 11.1.1-1). For example, with functional split option 2, a CU contains the RRC and PDCP layers, while a DU contains the RLC, MAC and PHY layers.

Multiple split options are also feasible, for example, in additional to the higher layer split between the CU and DU (e.g., functional split option 2), there can be a split within the DU. For example, the DU can be split into DU and remote unit (RU). The O-RAN alliance has been evaluated a lower layer functional split, where the lower PHY and the RF reside in a remote unit (RU), while the higher PHY and layers herein reside in the DU or CU. The lower level split being evaluated by the O-RAN alliance is similar to functional split option 7 of FIG. 8. There are various sub-options being evaluated for option 7 to define where the split occurs within the physical layer occurs. FIG. 9 illustrates an example protocol stack with two functional split points, the first between the CU and the DU and the second between the DU and the RU.

In NR/5G, a geographical area served by the network can be partitioned into cells as mentioned herein. For example, a cell can be associated with a synchronization signal, physical broadcast channel (PBCH) block (SS/PBCH block). Within a cell, other common channels and/or signals can be transmitted to users in the cell. In another example, a cell is served by one or more TRPs or by one or more RUs.

In NR/5G, a UE performs the cell search procedure to acquire time and frequency synchronization within a cell and to detect the physical layer Cell ID (PCI) of the cell. To perform cell search, the UE receives the following signals and channel: (1) the primary synchronization signal (PSS), (2) the secondary synchronization signal (SSS) and (3) the physical broadcast channel (PBCH). A PSS/SSS/PBCH block (SS/PBCH block) is referred to as SSB and includes 4 consecutive symbols, and 20 resource blocks (240 subcarriers), as illustrated in FIG. 10.

SSBs are organized in groups or bursts of up to N SSBs, transmitted within half a frame, each SSB within the group or burst has an index i, where i=0, 1, . . . , N−1, within each group or burst of SSBs, the SSBs are time-division multiplexed and arranged in increasing order of i, with increasing time. For carrier frequencies less than or equal to 3 GHz, N=4. For carrier frequencies in FR1 that are larger than 3 GHz, N=8. For carrier frequencies in FR2, N=64. The SSB indices actually transmitted are provided by ssb-PositionsInBurst in system information block one (SIB1) or in ServingCellConfigCommon.

SSBs are transmitted periodically, where the allowed periodicities are {5, 10, 20, 40, 80, 160} ms. In addition to cell search, SSBs can also be used for beam management related procedures, such as new beam acquisition, beam measurements, and beam failure detection and recovery. Each SSB with index i can be associated with a spatial domain filter (or beam).

NR introduced a physical random access channel (PRACH) to be used, among other cases, when the UE wants to communicate with the network (e.g., the network 130) and doesn't have uplink resources. For example, the physical random access channel can be used during initial access. The PRACH includes a preamble format comprising one or more preamble sequences transmitted in a PRACH Occasion (RO).

NR supports four different preamble sequence lengths:
Sequence length 839 used with sub-carrier spacings 1.25 kHz and 5 kHz with unrestricted or restricted sets.
Sequence length 139 used with sub-carrier spacings 15 kHz, 30 kHz, 60 kHz and 120 kHz with unrestricted sets.
Sequence length 571 used with sub-carrier spacing 30 kHz with unrestricted sets.
Sequence length 1151 used with sub-carrier spacing 15 kHz with unrestricted sets.

RACH preambles are transmitted in time-frequency resources PRACH Occasions (ROs). Each RO determines the time and frequency resources in which a preamble is transmitted, the resources allocated to an RO in the frequency domain (e.g., number of PRBs) and the resource allocated to an RO in the time domain (e.g., number of OFDMA symbols or number of slots), depend on the preamble sequence length, sub-carrier spacing of the preamble, sub-carrier spacing of the PUSCH in the UL BWP, and the preamble format. Multiple PRACH Occasions can be FDMed in one-time instance. This is indicated by higher layer parameter msg1-FDM. The time instances of the PRACH Occasions are determined by the higher layer parameter prach-ConfigurationIndex, and Tables 6.3.3.2-2, 6.3.3.2-3, and 6.3.3.2-4 of TS 38.211 v18.1.0.

SSBs are associated with ROs. The number of SSBs associated with one RO can be indicated by higher layer parameters such as ssb-perRACH-OccasionAndCB-PreamblesPerSSB and ssb-perRACH-Occasion. The number of SSBs per RO can be {⅛,¼,½,1,2,4,8,16}. When the number of SSBs per RO is less than 1, multiple ROs are associated with the same SSB index. SS/PBCH block indexes provided by ssb-PositionsInBurst in SIB1 or in ServingCellConfigCommon are mapped to valid PRACH occasions in the following order [38.213 v18.1.0]:
First, in increasing order of preamble indexes within a single PRACH occasion.
Second, in increasing order of frequency resource indexes for frequency multiplexed PRACH occasions.
Third, in increasing order of time resource indexes for time multiplexed PRACH occasions within a PRACH slot.
Fourth, in increasing order of indexes for PRACH slots.

The association period starts from frame 0 for mapping SS/PBCH block indexes to PRACH Occasions.

A random access procedure can be initiated by a PDCCH order, by the MAC entity, or by RRC.

There are two types of random access procedures, type-1 random access procedure and type-2 random access procedure.

Type-1 random access procedure also known as four-step random access procedure (4-step RACH), is as illustrated in FIG. 11;
In step 1, the UE transmits a random access preamble, also known as Msg1, to the gNB (e.g., the BS 102). The gNB attempts to receive and detect the preamble.
In step 2, the gNB upon receiving the preamble transmits a random access response (RAR), also known as Msg2, to the UE including, among other fields, a time adjustment (TA) command and a RAR uplink grant for a subsequent PUSCH transmission.
In step 3, the UE after receiving the RAR, transmits a PUSCH transmission scheduled by the grant of the RAR and time adjusted according to the TA received in the RAR. Msg3 or the PUSCH scheduled by the RAR UL grant can include the RRC setup request message.
In step 4, the gNB upon receiving the RRC setup request message, allocates downlink and uplink resources that are transmitted in a downlink PDSCH transmission to the UE.

After the last step, the UE can proceed with reception and transmission of data traffic.

Type-1 random access procedure (4-step RACH) can be contention based random access (CBRA) or contention free random access (CFRA). The CFRA procedure ends after the random access response, the following messages are not part of the random access procedure. For CFRA, in step 0, the gNB indicates to the UE the preamble to use.

Rel-16, introduced a new random access procedure; Type-2 random access procedure, also known as 2-step random access procedure (2-step RACH), is as illustrated in FIG. 12, that combines the preamble and PUSCH transmission into a single transmission from the UE to the gNB, which is known as MsgA. Similarly, the RAR and the PDSCH transmission (e.g. Msg4) are combined into a single downlink transmission from the gNB to the UE, which is known as MsgB.

In NR/5G, as a UE in RRC_CONNECTED mode moves around, the UE can connect to the network through different cells or different beams. There are two types of network controlled mobility procedures for UEs in RRC_CONNECTED mode: (1) Cell Level Mobility, also referred to as handover, that requires RRC signaling to be triggered and the UE changes its serving cell from a source serving cell to a target serving cell, and (2) Beam Level Mobility, that includes intra-cell beam level mobility and inter-cell beam level mobility and doesn't require explicit RRC signaling to be triggered. Alternatively, (2) can be PG-based mobility, as illustrated in FIG. 13. While the user moves from a location A to another location B, the set of PGs is updated from {PG2, PG3, PG4} to {PG1, PG2}. Consequently, a seamless beam-based (as opposed to cell-based) mobility is feasible especially for RRC-connected UEs.

To improve handover procedures, 3GPP introduced several handover enhancements which include:
Dual Active Protocol Stack (DAPS): The source gNB connection is maintained, i.e., a UE continues DL data reception from the source gNB and UL data transmission to the source gNB, after reception of the RRC message for handover, and until the source gNB is released after successful random access to the target gNB.
Conditional Handover (CHO): RRC configures handover parameters, however, the handover procedure is not executed by the UE until certain condition(s) are met at the UE. The UE evaluates the execution condition(s) upon receiving the CHO configuration, and stops evaluating the execution condition(s) once a handover is executed.
L1/L2 Triggered Mobility (LTM). The gNB prepares and provides candidate cell(s) configuration(s) to the UE. The physical layer provides measurement reports that include reference signal received power (RSRP) of SS/PBCH blocks of candidate cell(s). Based on the measurement reports, the gNB can change the serving cell to a target cell through a cell switch command signaled via MAC CE. The UE (e.g., the UE 116) switches to the target cell following the cell switch command. The benefit of cell switch command is to reduce handover latency.

This disclosure evaluates aspects related to antenna port activation and indication and beam activation and indication for seamless mobility as a user in RRC-CONNECTED mode moves across the network, moving from one cell to the next. An antenna port or a beam can be indicated by a TCI state ID or reference signal ID or spatial relation ID, a TCI state ID or reference signal ID or spatial relation ID can be for example, an antenna port ID. In one example, an antenna port or TCI state or reference signal or spatial relation represents indication for a channel with one-input and one-output. This framework, uses the multi-variate TCI state (mv-TCI state) for seamless mobility, thus providing a low latency low overhead framework to transfer users between cells as the user is moving across the coverage area of a network.

As mentioned herein, a geographical area served by a network is partitioned into cells. Cells can be mapped to or associated with RUs, DUs or CUs. A UE can connect to the network through one or more RUs associated with a serving cell. Or depending on propagation channel conditions, a UE can connect through RUs not associated with the serving cell. As a UE moves within the geographical area covered by the network, the cell through which the UE connects to the network changes, and hence the RU(s) through which the UE connects to the network change. For example, for dedicated channels or signals, a change in RU can be signaled to the UE as a change in a spatial domain filter (beam or port/PG), the UE communicates to the network through a first RU using a first spatial domain filter (beam or port/PG) as illustrated in FIG. 14, the UE is then signaled a second spatial domain transmission filter (beam or port/PG) associated with a second RU to communicate to the network through the second RU. There are a few aspects to evaluate here; first, how does the UE determine the spatial domain filters (beams or port/PGs) of the second RU, this includes configuration and activation of such beams or port/PGs, also taking into account that the UE can be continuously moving hence new beams or port/PGs are continuously being configured and activated for new RUs (or cells served by those RUs) the UE is moving closer to. Second, how is the UE signaled a change in a spatial domain transmission filter (beam or port/PG) from the first RU to the second RU, evaluated latency and overhead aspects. Third, as the UE moves to RUs associated with new cells, a serving cell change (or switch or handover) can take place, it is desirable to have such cell switch occur in a seamless way with minimum disruption to UE traffic and with high resilience and reliability. In one example, there is no cell switch command, but the UE switches from a first RU associated with a first cell to a second RU associated with a second cell by switching beams, i.e., through a beam indication command as included in FIG. 14. In one example, a UE can communicate with the network through multiple cells and RUs. For example, the UE can be indicated multiple beams at the same time, and uses the indicated beams for reception and transmission.

As the UE moves throughout the geographical area served by the network, the TRP or RU through which the UE communicates changes, based on the UE's location within the geographical area as illustrated in FIG. 15. In FIG. 15, as an example, a UE moves from cell 2, where the UE communicates through the TRP or RU of cell 2, to cell 5 where the UE communicates through the TRP or RU of cell 5. In one example, there is no cell change or switch when the UE communicates through the TRP or RU of cell 5, a beam indication to the UE is used to indicate a beam associated with the TRP or RU of cell 5 through which the UE communicates. In another example, as a beam is indicated for cell 5, the serving cell is switched to cell 5. The UE continues to move to cell 7, where the UE communicates through the TRP or RU of cell 7. In one example, there is no cell change or switch when the UE communicates through the TRP or RU of cell 7, a beam indication to the UE is used to indicate a beam associated with the TRP or RU of cell 7 through which the UE communicates. In another example, as a beam is indicated for cell 7, the serving cell is switched to cell 7.

FIG. 16, illustrates one example of mobility for the UE of FIG. 15. The UE transitions to the connected mode in cell 2. The UE can be configured with beams associated with the cells in the neighborhood of the UE. For example, these can be beams associated with cell-1, cell-3 and cell-5 in addition to cell-2. A configuration with a beam is used, for example, to mean one or more of the following:
Configuration with a reference signal (e.g., CSI-RS or SSB) used for beam measurement, wherein the reference signal is associated with a spatial domain filter corresponding to a beam.
Configuration with a reference signal (e.g., CSI-RS or SSB) used for beam indication, wherein the reference signal is associated with a spatial domain filter corresponding to a beam.
Configuration with a TCI state or spatial relation information used for beam indication, wherein the TCI state or spatial relation information can include a reference signal for (1) quasi-co-location (QCL) (e.g., QCL Type A or Type B or Type C or Type D), or (2) spatial relation information/beam indication, and the reference signal is associated with a spatial domain filter or QCL type corresponding to a beam.

The UE can provide measurement reports for the configured beams (e.g., measurement reference signals). Based on measurements/measurement reports, the network (e.g., gNB), and/or the UE can activate a subset of beams (e.g., reference signals or TCI states as mentioned herein). Furthermore, based on the measurements/measurement reports, the network (e.g., gNB), and/or the UE can indicate and/or activate one or more beams (e.g., reference signals or TCI states as mentioned herein). As the UE moves, the configured beams can be updated. For example, as the UE moves closer to cell 5 and into cell 5, configured beams can be added for cell 4 and cell 7, and configured beams can be removed for cell 1 and cell 3. Based on the updated configuration of beams and measurement reports, beams are activated or deactivated, and new beams can be indicated to UE through which the UE communicates with the network. For example, as the UE moves closer to cell 5, the indicated beam (e.g., TCI state or reference signal) can be associated with cell 5. In a variant example, a UE can be simultaneously indicated two beams for cell 2 and cell 5. As the UE moves closer to cell 7 and into cell 7, configured beams can be added for cell 8 and cell 9, and configured beams can be removed for cell 2 and cell 4. Based on the updated configuration of beams and measurement reports, beams are activated or deactivated, and new beams can be indicated to UE through which the UE communicates with the network. For example, as the UE moves closer to cell 7, the indicated beam (e.g., TCI state or reference signal) can be associated with cell 7. In a variant example, a UE can be simultaneously indicated two beams for cell 5 and cell 7. In this example, the UE changes the cell (e.g., serving cell) (or TRP or RU) through which it communicates to the network based on beam measurement and reporting and beam indication (e.g., beam-based mobility).

In the example of FIG. 16, the configuration (e.g., initial configuration and/or addition and/or removal) of beams (e.g., measurement reference signals, or beam indication reference signals or TCI states or spatial resource units), can be following the examples of this disclosure based on (1) UE-dedicated or UE-specific signaling (e.g., RRC signaling or MAC CE signaling or L1 control signaling), or (2) UE-common (e.g., to a group of UEs or UEs in a cell or associated with an entity), using e.g., SIB signaling (e.g., common channels from the cell the UE is communicating with the network through or a neighbor cell), or RRC signaling or MAC CE signaling or L1 control signaling.

In one example, the reference signal for beam indication when the UE is in connected mode (e.g., when the UE is within a cell or when the UE is moving between cells (mobility)) can be separate (e.g., has separate configuration) from the reference signal for initial beam acquisition, e.g., when the UE is transitioning to the connected mode.

In one example, the reference signal for beam indication when the UE is in connected mode (e.g., when the UE is within a cell or when the UE is moving between cells (mobility)) can be from the same configuration as the reference signal for initial beam acquisition, e.g., when the UE is transitioning to the connected mode.

In NR, there are different levels of abstraction for beam indication and antenna port indication, which adds unnecessary complexity to MIMO and beam indication. To simplify beam and/or antenna port indication, a spatial resource unit is regarded as the basic unit, wherein the spatial resource unit, is a one-port channel, with one-input and one-output. “An antenna port is defined such that the channel over which a symbol on the antenna port is conveyed can be inferred from the channel over which another symbol on the same antenna port is conveyed” [TS 38.211]. A UE can be indicated with one or more spatial resource units. In the case of seamless mobility, the spatial resource units can belong to different cells.

For application of a spatial resource unit, the spatial resource unit can be first activated, and then indicated. The activation of a spatial resource unit allows the UE time to measure the spatial resource unit and be ready to use it when it is indicated. The indication of the spatial resource unit is when the UE is signaled to use (e.g., for transmission or reception) the spatial resource unit. A UE can be configured multiple spatial resource units, in different cells. As the UE moves through the network, the configured spatial resource units can be updated as UE moves away from some cells and towards other cells. The multiple spatial resource units can be in a same set, or in different sets, for example one set for DL and/or joint spatial resource units and one set for UL spatial resource units. The UE can then be activated one or more of the spatial resource units. The spatial resource units can be activated in a single set or in multiple sets. The UE can then be indicated one or more spatial resource units from the activated spatial resource units. In a variant example, there is no activation of spatial resource units, the configured spatial resource units can be directly indicated.

In this disclosure a spatial resource unit is defined as a reference signal (e.g., a reference signal with one antenna port) or an antenna port of a reference signal of a cell or RU. A spatial resource unit is identified by an ID (e.g., spatial resource unit ID). In one example, one set of spatial resource units is configured or re-configured across multiple cells or RUs. In another example, different sets of spatial resource units are configured or re-configured for different cells or RUs, the spatial resource unit can contain an ID of a cell or RU, and an ID of spatial resource unit within the set of spatial resource units configured for the cell or RU. A spatial resource unit can be referred to as a TCI state, hence, a spatial resource unit ID can be referred to as a TCI state ID. A spatial resource unit can be referred to as an antenna port (or a port), hence, a spatial resource unit ID can be referred to as an antenna port ID or port ID. A spatial resource unit can be referred to as a reference signal, hence, a spatial resource unit ID can be referred to as a reference signal ID.

In this disclosure signaling methods are evaluated for activation and indication of spatial resource units for seamless mobility for different cells or RU. The signaling overhead of these methods are evaluated.

The present disclosure relates to a NR/5G and/or 6G communication system.

This disclosure evaluates aspects related to mobility in a network for user in connected mode using the multi-variate TCI state framework and spatial resource units, to reduce latency and overhead of signaling associated with mobility, reduce disruption time due to mobility and improve reliability and resilience. The following aspects are evaluated:
Configuration and re-configuration of spatial resource units (e.g., reference signals or antenna ports or TCI states) for seamless mobility across multiple cells or RUs.
Joint and separate activation and indication of spatial resource unit across multiple cells or RUs.
Signaling aspects (e.g., using combinatorial index or field-map) for activation and indication of spatial resource units across multiple cells or RUs.

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

In the following, both FDD and TDD are evaluated as a duplex method for DL and UL signaling. In addition, full duplex (XDD) operation is possible, e.g., sub-band full duplex (SBFD) or single frequency full duplex (SFFD).

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure evaluates several components that can be used in conjunction or in combination with one another, or can operate as standalone schemes.

In this disclosure, RRC signaling (e.g., configuration by RRC signaling) includes (1) common information provided by common signaling, e.g., this can be system information block (SIB)-based RRC signaling (e.g., SIB1 or other SIB) or (2) RRC dedicated signaling that is sent to a specific UE wherein the information can be common/cell-specific information or dedicated/UE-specific information wherein the information can be common/cell-specific information or dedicated/UE-specific information or (3) UE-group RRC signaling.

In this disclosure MAC CE signaling can be UE-specific e.g., to one UE or can be UE common (e.g., to a group of UEs or to UEs in a cell or all UEs in a cell). MAC CE signaling can be DL MAC CE signaling or UL MAC CE signaling. MAC CE signaling can be DL MAC CE signaling or UL MAC CE signaling.

In this disclosure L1 control signaling includes: (1) DL control information (e.g., DCI on PDCCH or DL control information on PDSCH) and/or (2) UL control information (e.g., UCI on PUCCH or PUSCH). L1 control signaling can be UE-specific e.g., to one UE or can be UE common (e.g., to a group of UEs or UEs in a cell or all UEs in a cell).

In this disclosure, configuration can refer to configuration by semi-static signaling (e.g., RRC or SIB signaling). In one example, a configuration can be applicable to multiple transmission instances, until a new configuration is received and applied.

In this disclosure, indication can refer to indication by dynamic signaling (e.g., L1 control (e.g., DCI Format) or MAC CE signaling). In one example, an indication can be for an associated occasion(s) (e.g., an occasion or multiple occasions associated with the indication).

In this disclosure a list with N elements can be denoted as L(i), where i can take N values, and L(i) can correspond to the element or entry associated with index i. In one example, i can take N arbitrary values. In one example, i=0, 1, . . . , N−1. In one example, i=1, 2, . . . , N. In one example, i is an identity of an element or entry in the list.

In the present disclosure, the term “activation” describes an operation wherein a UE receives and decodes first information provided by a first signal from the network (or gNB) and, based on the first information, the UE determines a starting point in time. The starting point can be a present or a future slot/subframe or symbol and the exact location is either implicitly or explicitly indicated, or is otherwise defined in the system operation or is configured by higher layers. Upon successfully decoding the first information, the UE responds according to an indication provided by the first information. The term “deactivation” describes an operation wherein a UE receives and decodes second information provided by a second signal from the network (or gNB) and, based on the second information from the signal, the UE determines a stopping point in time. The stopping point can be a present or a future slot/subframe or symbol and the exact location is either implicitly or explicitly indicated, or is otherwise defined in the system operation or is configured by higher layers. Upon successfully decoding the second information, the UE responds according to an indication provided by the second information. The first signal can be same as the second signal or the first information can be same as the second information, wherein a first part of the information can be associated with an “activation” operation and with first UEs or with first parameters for transmissions/receptions by a UE, and a second part of the information can be associated with a “deactivation” operation and with second UEs or with second parameters for transmissions/receptions by the UE. For example, the second information can be absent, and deactivation can be implicitly derived. For example, when a UE has received an activation information in a previous indication, and is not included among UEs with activation information in a next indication, the UE can determine the latter indication as an implicit deactivation indication.

In this disclosure, a time unit, for example, can be a symbol or a slot or sub-frame or a frame. In one example, a time-unit can be multiple symbols, or multiple slots or multiple sub-frames or multiple frames. In one example, a time-unit can be a sub-slot (e.g., part of a slot). In one example, a time-unit can be specified in units of time, e.g., microseconds, or milliseconds or seconds, etc.

In this disclosure, a frequency-unit, for example, can be a sub-carrier or a resource block (RB) or a sub-channel, wherein a sub-channel is a group of RBs, or a bandwidth part (BWP). In one example, a frequency-unit can be multiple sub-carriers, or multiple RBs or multiple sub-channels. In one example, a frequency-unit can be a sub-RB (e.g., part of a RB). A frequency-unit can be specified in units of frequency, e.g., Hz, or kHz or MHz, etc.

Terminology such as TCI, TCI states, SpatialRelationInfo, target RS, reference RS, and other terms is used for illustrative purposes and is therefore not normative. Other terms that refer to same functions can also be used.

A “reference RS” (e.g., reference source RS) corresponds to a set of characteristics of a DL beam or an UL TX beam, such as a direction, a precoding/beamforming, a number of ports, and so on. For instance, the UE can receive a source RS index/ID in a TCI state assigned to (or associated with) a DL transmission (and/or UL transmission), the UE applies the known characteristics of the source RS to the assigned DL transmission (and/or UL transmission). The source RS can be received and measured by the UE (in this case, the source RS is a downlink measurement signal such as NZP CSI-RS and/or SSB) with the result of the measurement used for calculating a beam report (e.g., including at least one L1-RSRP/L1-SINR accompanied by at least one CRI or SSBRI). As the NW/gNB receives the beam report, the NW can be better equipped with information to assign a particular DL (and/or UL) TX beam to the UE. Optionally or alternatively, the source RS can be transmitted by the UE (in this case, the source RS is an uplink measurement signal such as SRS). As the NW/gNB receives the source RS, the NW/gNB can measure and calculate the needed information to assign a particular DL (or/and UL) TX beam to the UE, for example in case of channel reciprocity.

In this disclosure, a spatial resource unit or beam or PG management reference signal refers to a reference signal, a UE can use for beam or PG management procedure. A beam or PG management procedure can include:
Initial beam or PG acquisition for identifying a spatial filter or a beam or a beam pair (or port/PG pair) between two devices (e.g., UE and gNB/TRP or between two UEs) during channel setup or link establishment. This includes initial beam (port) sweeping (within a PG) to identify a beam (or port) pair between the two devices. This can also include identifying a beam or a beam pair (or port/PG pair) between a UE and new gNB/TRP in case of handover.
Spatial filter or beam or PG maintenance for refining and tracking the beam or PG as the UE moves around or the channel conditions change. This includes spatial filter or beam or PG measurement and reporting, and spatial resource unit or beam or port/PG indication signaling.
Spatial filter or beam or PG failure detection and recovery, an emergency-only procedure for determining when a beam has failed, and identifying a new beam to use instead. Beam failure events are typically rare and, in the unlikely event that a beam fails, beam recovery should be reliable and fast and before the link fails.

In one example, spatial resource unit beam or PG management reference signals, also referred to as reference signals in this document can include:
A SS/PBCH block, which includes one or more synchronization signals carrying a cell ID (or a gNB/TRP ID or a RU ID), and a channel carrying minimum system information or part of the minimum system information, wherein the minimum system information is the information required by the UE to access the network (e.g., the network 130). In one example, the SS/PBCH block is not associated with PCI. In one example, the SS/PBCH is associated with PCI. In one example, the SS/PBCH block is a non-cell defining (NCD) SS/PBCH block. In one example, the SS/PBCH block is a cell defining (CD) SS/PBCH block.
LP-SS, low-power synchronization signal. In one example, LP-SS which includes one or more synchronization signals carrying a cell ID (or a gNB/TRP ID or a RU ID). In one example, LP-SS is based on on-off keying modulation. In one example, LP-SS is received or transmitted on a low power radio separate from the main radio. In one example, the LP-SS is not associated with PCI. In one example, the LP-SS is associated with PCI.
Channel state information reference signal (CSI-RS). In one example, the CSI-RS is not associated with a PCI. In one example, the CSI-RS is associated with PCI. In one example, the CSI-RS is QCLed with another CSI-RS. In one example, the CSI-RS is associated with PCI. In one example, the CSI-RS is QCLed with SS/PBCH block. In one example, the CSI-RS is QCLed with LP-SS. In one example, the CSI-RS has no source RS, e.g., the CSI-RS is the root of the QCL relation. In one example, the CSI-RS has one antenna port. In one example, the CSI-RS has more than one antenna port.

In one example, the CSI-RS and/or LP-SS and/or SS/PBCH block (e.g., NCD-SS/PBCH block) is transmitted from multiple RUs or multiple TRPs with single frequency network (SFN) properties. In one example, the same time and frequency resources and a same sequence is used to transmit CSI-RS and/or LP-SS and/or SS/PBCH block from multiple RUs or from multiple TRPs.

In one example of this disclosure, a reference signal can be configured with one antenna port. In one example, an entity for spatial domain (or spatial relation) indication (e.g., a spatial domain resource unit) is a reference signal with one antenna port.

In one example of this disclosure, a reference signal can be configured with N antenna ports. In one example, an entity for spatial domain (or spatial relation) indication (e.g., a spatial domain resource unit) is an antenna port of a reference signal. In one example, an entity for spatial domain (or spatial relation) indication (e.g., a spatial domain resource unit) is a reference signal.

In one example, an entity for spatial domain (or spatial relation) indication (e.g., a spatial domain resource unit) is a TCI state. Wherein, a TCI state can include:
A TCI state ID
One or more QCL information elements. Wherein, a QCL information element can include
   Reference signal ID (e.g., reference signal configured with one antenna port)
   One or more QCL Types. (e.g., QCL Type-A or Type-B or Type-C, and/or QCL Type-D)

In one example of this disclosure, the reference signal for spatial resource unit or for beam or PG management can include more than one reference signal.
A first reference signal for spatial filter or beam or PG management e.g., for initial spatial resource unit or beam or PG acquisition for initial access.
A second reference signal for spatial filter or beam or PG management e.g., for initial spatial resource unit or beam or PG acquisition for mobility (e.g., handover).
A third reference signal for spatial filter or beam or PG management e.g., for spatial resource unit or beam or PG maintenance (e.g., spatial resource unit or beam or PG tracking and/or spatial resource unit or beam or PG refinement)
A fourth reference signal for spatial filter or beam or PG management e.g., for spatial resource unit beam or PG failure detection.
A fifth reference signal for spatial filter or beam or PG management e.g., for spatial resource unit or beam or PG failure recovery.

In one example, more than one of the reference signals mentioned herein can be same. For example, the first and the second reference signals can be the same. For another example, the first and the second the fourth reference signals can be the same. For another example, the second reference signal and the third reference signal can be the same, for example, the UE uses a same reference signal for mobility and for beam maintenance.

In one example, there is one reference signal for spatial filter or beam or PG management. In one example, a reference signal can be used for spatial resource unit or beam or PG management and for other purposes such as tracking or channel state information (CSI) acquisition.

In one example, a network can be deployed, wherein the network includes CUs, DUs and RUs. In one example, one CU can serve one or multiple DUs and one DU serve one or multiple RUs as illustrated in FIG. 17. In FIG. 17 FIG. 17A, the CU, DU and RU can be separate entities. In FIG. 17 FIG. 17B, the CU and DU are included in a same entity that is separate from the RU. In FIG. 17 FIG. 17C, the DU and RU are included in a same entity that is separate from the CU. In one example, the CU, DU and RU are included in the same entity.

In one example, an RU (or O-RU) is functionally equivalent to a port or a PG (with QCL properties as described herein), and hence can be replaced with the term, “port or PG”. In the rest of the disclosure, the term RU is used for illustration purpose only, hence can be replaced with any functionally equivalent term such as a port or PG.

Likewise, the term spatial resource unit or beam can be functionally equivalent to a port or a PG (with QCL TypeD or spatial filter as described herein), and hence can be replaced with the term, “port or PG”. In the rest of the disclosure, the term beam is used for illustration purpose only, hence can be replaced with any functionally equivalent term such as a port or PG.

In one example, an RU can be connected to N DUs, as illustrated in FIG. 18. In one example, N=1. In one example, N=2. In one example, an RU can send or receive information from one DU at a time (e.g., in one slot or in one symbol). In one example, an RU can send or receive information simultaneously from multiple DUs. In one example of FIG. 18, an RU is equipped with multiple panels (e.g., N panels) and each panel can serve a different cell or sector, and the UE sends and receives information associated with each panel from a corresponding DU associated with a corresponding cell or sector. In one example of FIG. 18, an RU can be associated with cell A, the RU can send or received data to or from multiple DUs associated with different cells. For example, a first DU is associated with cell A, a second DU is associated with cell B, etc. In one example, a UE can have cell B as its serving cell, and hence anchored (e.g., having RLC and/or MAC and/or scheduler) in the second DU, and yet transmit or receive data on RU A for cell A, e.g., where cell A is a non-serving cell for the UE. This is illustrated in FIG. 19. Hence, a variant of FIG. 17 is to have RUs connected to multiple DUs to support the case where an RU communicates with a UE anchored in a DU with serving cell different from the serving cell of the RU.

FIG. 24 illustrates a diagram of example spatial resource units 2400 according to embodiments of the present disclosure. For example, spatial resource units 2400 can be implemented by the gNB 102 of FIG. 2. This example is for illustration only and other embodiments can be used without departing from the scope of the present disclosure.

In the examples of this disclosure a spatial resource unit can one of: (1) A DL spatial resource unit for reception of DL channels and/or signals at the UE and for transmission of DL channels and/or signals at the gNB (e.g., the BS 102). (2) An UL spatial resource unit for transmission of UL channels and/or signals at the UE and for reception of UL channels and/or signals at the gNB. (3) A joint spatial resource unit for reception/transmission of DL/UL channels and/or signals at the UE and for transmission/reception of DL/UL channels and/or signals at the gNB. As mentioned herein, a spatial resource unit can be a TCI state, or reference signal or an antenna port of a reference signal, or antenna port group of a reference signal.

In the examples of this disclosure a spatial resource unit code point can include one or more of (1) DL spatial resource unit, (2) an UL spatial resource unit, (3) a joint spatial resource and (4) a pair of DL spatial resource unit and UL spatial resource unit. A spatial resource unit codepoint can be for one or more TRPs or RUs or cells. A spatial resource unit code point can be a TCI state code point or a reference signal code point, or a reference signal-antenna port code point.

In the examples of this disclosure, a spatial resource unit or spatial resource unit code point is used as an object for beam indication or spatial domain filter indication, other objects for beam indication can be used (e.g., reference signal index, spatial relation information, TCI state etc.).

As illustrated in FIG. 24, the spatial resource units can be:
Configured or re-configured by higher layers. In one example, the configuration of spatial resource units, establish the spatial resource units that can be used for a beam or spatial domain filter, it can establish an association between a beam/spatial domain filter and a corresponding spatial resource unit.
Activated. The activation of a spatial resource units allows the UE to perform measurements on the spatial resource unit so that it is ready to be used for beam indication, when the UE is instructed or indicated to do so. In some examples, of this disclosure, there can be no activation of spatial resource units and spatial resource units are directly indicated.
Indicated. The indicated spatial resource unit can be applied to a spatial domain filter/beam to use for transmission or reception of data. The indicated spatial resource unit is associated to a channel, and is used for a spatial filter to receive or transmit the channel.

In one example, a UE is configured/updated through higher layer RRC signaling with one or more sets S1 of spatial resource units with L elements or of TCI States with L elements or of reference signals, e.g., for beam indication with L elements.

In one example S1 has one set, wherein S1 can include
DL, UL and/or joint spatial resource units.
Spatial resource units of multiple cells, e.g., serving cell (or RU) and neighboring (e.g., candidate) cells or RUs

As the UE (e.g., the UE 116) moves within the coverage area of the network, the configured spatial resource units can be updated to remove spatial resource units of cells (or RUs) the UE is moving away from, and add spatial resource units of cells or RUs the UE is moving towards. In one example, the update of the configured spatial resource units can be by dedicated RRC signaling as aforementioned. In one example, the update of the configured spatial resource units can be by common RRC signaling (e.g., SIB) as described herein.

In one example S1 has two sets, e.g., S11 and S12, wherein S11 includes DL and/or joint spatial resource units, and S12 includes UL spatial resource units. S11 and S12 includes spatial resource units of multiple cells, e.g., serving cell (or RU) and neighboring (e.g., candidate) cells or RUs.

As the UE moves within the coverage area of the network, the configured spatial resource units can be updated to remove spatial resource units of cells (or RUs) the UE is moving away from, and add spatial resource units of cells or RUs the UE is moving towards. In one example, the update of the configured spatial resource units can be by dedicated RRC signaling as aforementioned. In one example, the update of the configured spatial resource units can be by common RRC signaling (e.g., SIB) as described herein.

In one example S1 has two sets, e.g., S11 and S12, wherein S11 includes DL and/or UL and/or joint spatial resource units for a serving cell (or RU), and S12 includes DL and/or UL and/or joint spatial resource units for multiple neighboring (e.g., candidate) cells or RUs.

As the UE moves within the coverage area of the network, the configured spatial resource units can be updated to remove spatial resource units of cells (or RUs) the UE is moving away from, and add spatial resource units of cells or RUs the UE is moving towards. In one example, if the UE moves towards a candidate cell or RU, such that the signal quality from the candidate cell is better than that of the current serving cell, set S11 can be updated with the spatial resource units of the candidate cell to replace that of the current serving cell, the spatial resource units of the current serving cell can become included in set S12. In one example, the update of the configured spatial resource units can be by dedicated RRC signaling as aforementioned. In one example, the update of the configured spatial resource units can be by common RRC signaling (e.g., SIB) as described herein.

In one example S1 has three sets, e.g., S11, S12, and S14, wherein:
S11 includes DL and/or joint spatial resource units for a serving cell (or RU), and
S12 includes UL spatial resource units for a serving cell (or RU), and
S14 includes DL and/or joint spatial resource units for multiple neighboring (e.g., candidate) cells or RUs.

In one example S1 has three sets, e.g., S11, S12, and S15, wherein:
S11 includes DL and/or joint spatial resource units for a serving cell (or RU), and
S12 includes UL spatial resource units for a serving cell (or RU), and
S15 includes UL spatial resource units for multiple neighboring (e.g., candidate) cells or RUs.

In one example S1 has three sets, e.g., S11, S12 and S16, wherein:
S11 includes DL and/or joint spatial resource units for a serving cell (or RU), and
S12 includes UL spatial resource units for a serving cell (or RU), and
S16 includes DL and/or joint spatial resource units and/or UL spatial resource units for multiple neighboring (e.g., candidate) cells or RUs.

In one example S1 has three sets, e.g., S13, S14 and S15, wherein:
S13 includes DL, UL and/or joint spatial resource units for a serving cell (or RU), and
S14 includes DL and/or joint spatial resource units for multiple neighboring (e.g., candidate) cells or RUs, and
S15 includes UL spatial resource units for multiple neighboring (e.g., candidate) cells or RUs.

As the UE moves within the coverage area of the network, the configured spatial resource units can be updated to remove spatial resource units of cells (or RUs) the UE is moving away from, and add spatial resource units of cells or RUs the UE is moving towards. In one example, if the UE moves towards a candidate cell or RU, such that the signal quality from the candidate cell is better than that of the current serving cell, sets S11, S12 and S13 can be updated with the spatial resource units of the candidate cell to replace that of the current serving cell, the spatial resource units of the current serving cell can become included in sets S14, S15 and S16. In one example, the update of the configured spatial resource units can be by dedicated RRC signaling as aforementioned. In one example, the update of the configured spatial resource units can be by common RRC signaling (e.g., SIB) as described herein.

In one example S1 has four sets, e.g., S11, S12, S13 and S14, wherein:
S11 includes DL and/or joint spatial resource units for a serving cell (or RU), and
S12 includes UL spatial resource units for a serving cell (or RU), and
S13 includes DL and/or joint spatial resource units for multiple neighboring (e.g., candidate) cells or RUs, and
S14 includes UL spatial resource units for multiple neighboring (e.g., candidate) cells or RUs.

As the UE moves within the coverage area of the network, the configured spatial resource units can be updated to remove spatial resource units of cells (or RUs) the UE is moving away from, and add spatial resource units of cells or RUs the UE is moving towards. In one example, if the UE moves towards a candidate cell or RU, such that the signal quality from the candidate cell is better than that of the current serving cell, sets S11 and S12 can be updated with the spatial resource units of the candidate cell to replace that of the current serving cell, the spatial resource units of the current serving cell can become included in sets S13 and S14. In one example, the update of the configured spatial resource units can be by dedicated RRC signaling as aforementioned. In one example, the update of the configured spatial resource units can be by common RRC signaling (e.g., SIB) as described herein.

In one example S1 has N sets, e.g., S11, S12, . . . S1N, wherein N is the number of serving cell (or RU) and candidate or neighboring cells (or RUs).
S11 includes DL and/or UL and/or joint spatial resource units for a first cell or RU, e.g., serving cell (or RU),
S12 includes DL and/or UL and/or joint spatial resource units for a second cell (or RU), e.g., a first neighboring or candidate cell (or RU),
. . .
S1N includes DL and/or UL and/or joint spatial resource units for a Nth cell (or RU), e.g., a (N−1) neighboring or candidate cell (or RU).

As the UE moves within the coverage area of the network, the configured spatial resource units can be updated to remove cells (or RUs) and their corresponding spatial resource units the UE is moving away from, and add cells (or RUs) and their corresponding spatial resource units the UE is moving towards. In one example, the update of the configured spatial resource units can be by dedicated RRC signaling. In one example, the update of the configured spatial resource units can be by common RRC signaling (e.g., SIB) as described herein.

In one example S1 has M sets, e.g., S11, S12, . . . S1M, wherein M=2N, and wherein N is the number of serving cell (or RU) and candidate or neighboring cells (or RUs).
S11 includes DL and/or joint spatial resource units for a first cell or RU, e.g., serving cell (or RU),
S12 includes UL spatial resource units for a first cell or RU, e.g., serving cell (or RU)
S13 includes DL and/or joint spatial resource units for a second cell (or RU), e.g., a first neighboring or candidate cell (or RU),
S13 includes UL spatial resource units for a second cell (or RU), e.g., a first neighboring or candidate cell (or RU),
. . .
S1(M−1) includes DL and/or joint spatial resource units for a Nth cell (or RU), e.g., a (N−1) neighboring or candidate cell (or RU),
S1M includes UL spatial resource units for a Nth cell (or RU), e.g., a (N−1) neighboring or candidate cell (or RU).

As the UE moves within the coverage area of the network, the configured spatial resource units can be updated to remove cells (or RUs) and their corresponding spatial resource units the UE is moving away from, and add cells (or RUs) and their corresponding spatial resource units the UE is moving towards. In one example, the update of the configured spatial resource units can be by dedicated RRC signaling. In one example, the update of the configured spatial resource units can be by common RRC signaling (e.g., SIB) as described herein.

In a variant of the herein example, the spatial resource units of multiple cells (e.g., serving and neighboring or candidate cells) can be configured such as:
Some cells have a single set of spatial resource units, e.g., for DL and UL and/or joint spatial resource units.
Some cells have two sets of spatial resource units, e.g., a first set for DL and/or joint spatial resource units, the second set for UL spatial resource units.

In the examples mentioned herein, a spatial resource unit can include a reference signal as a source reference signal for quasi-co-location or for spatial relation, the reference signal can be used to identify the spatial filter to use for the spatial resource unit. In the examples mentioned herein, a spatial resource unit can include a reference signal and an antenna port of the reference signal as a source reference signal for quasi-co-location or for spatial relation, the antenna port of the reference signal can be used to identify the spatial filter to use for the spatial resource unit. In one example, a reference signal can have one antenna port. In one example, a reference signal can have more than one antenna ports.

A spatial resource unit can be associated with a cell (or RU), e.g., indication of a spatial relation for a cell or RU based on:
The configuration of the spatial resource unit includes an identifier for the cell or RU, e.g., spatial resource unit configuration includes a physical cell identity (PCI), or the spatial resource unit configuration includes an identifier for the RU.
The spatial resource unit is configured in a set, and the set is associated with a cell or RU. In one example, the association can be by inclusion of an identifier for the cell or RU in the configuration of the set.
The spatial resource unit configuration includes a reference signal, and the reference signal is associated with a cell (or RU). In one example, the reference signal can be SS/PBCH block. In one example, reference signal can be channel state information reference signal (CSI-RS), e.g., CSI-RS for tracking (tracking reference signal—TRS, or CSI-RS for beam management, or CSI-RS for CSI). In one example, reference signal can be sounding reference signal. The association of the reference signal with a cell or RU can be based on:
   The configuration of the reference signal includes an identifier for the cell or RU, e.g., reference signal configuration includes a physical cell identity (PCI), or the reference configuration includes an identifier for the RU.
   The reference signal is configured on the resources of a cell or associated with an RU. For example, one or more of the following parameters is included in the configuration of the reference signal, sub-carrier spacing (SCS), cyclic prefix, and absolute frequency of point A (a reference frequency identifying a frequency of a carrier or a cell), wherein the parameters mentioned herein can identify a cell.
   The reference signal includes an identity of a cell, for example, the reference signal (e.g., SS/PBCH) includes physical cell identity.
   The reference signal is configured in a set, and the set is associated with a cell or RU. In one example, the association can be by inclusion of an identifier for the cell or RU in the configuration of the set. In another example, the identification can be inclusion of sub-carrier spacing (SCS), cyclic prefix, and absolute frequency of point A (a reference frequency identifying a frequency of a carrier or a cell).
   The reference signal has (is indicated, activated or configured) a spatial resource unit, and the spatial resource unit is associated with a cell (or RU).

In the examples mentioned herein, a spatial resource unit can be a TCI state.

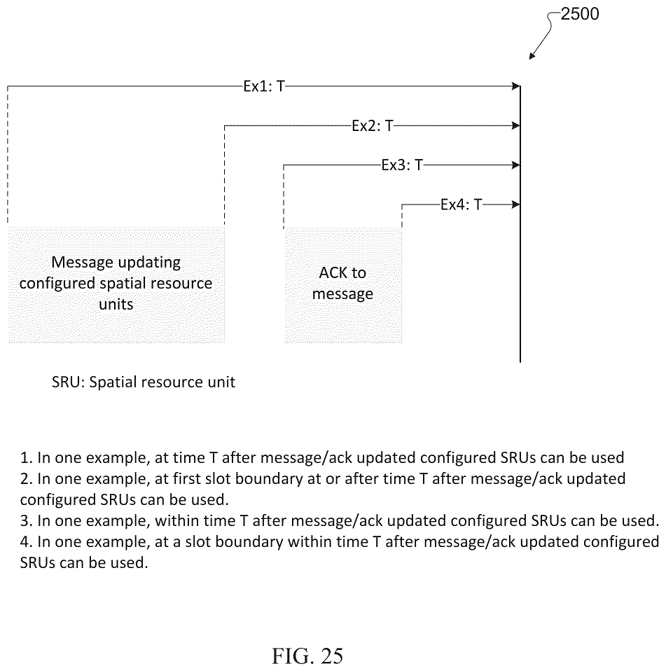

FIG. 25 illustrates a diagram of example spatial resource unit update timings 2500 according to embodiments of the present disclosure. For example, spatial resource unit update timings 2500 can be implemented by the gNB 102 and/or any of the UEs 111-116 of FIG. 1. This example is for illustration only and other embodiments can be used without departing from the scope of the present disclosure.

In the examples mentioned herein, the updated set of configured spatial resource units can become available or be used (e.g., for activation and/or indication) based on a time T from the message updating the spatial resource units as illustrated in FIG. 25. In one example, the time T is from the start of the RRC or SIB message carrying the updated configured spatial resource units. In one example, the time T is from the end of the RRC or SIB message carrying the updated configured spatial resource units. In one example, the time T is from the start of the acknowledgment (e.g., on PUCCH or PUSCH) of the RRC message carrying the updated configured spatial resource units. In one example, the time T is from the end of the acknowledgment (e.g., on PUCCH or PUSCH) of the RRC message carrying the updated configured spatial resource units. In one example, the updated configured spatial resource units can be used (e.g., for activation and/or for indication) starting at time T determined as mentioned herein. In one example, the updated configured spatial resource units can be used (e.g., for activation and/or for indication) at a first slot boundary at or after time T determined as mentioned herein. In one example, the updated configured spatial resource units can be used (e.g., for activation and/or for indication) no later than time T determined as mentioned herein. In one example, the updated configured spatial resource units can be used (e.g., for activation and/or for indication) at a slot boundary no later than time T determined as mentioned herein. Time T can be configured and/or updated by RRC and/or MAC CE and/or L1 control (e.g., DCI Format).

If the spatial resource unit applies to multiple carriers and/or bandwidth parts with different sub-carrier spacing and/or UL and DL directions have different sub-carrier spacings
In one example, time T is determined by a value associated with or configured for the largest sub-carrier spacing.
In one example, time T is determined by a value associated with or configured for the smallest sub-carrier spacing.
In one example, the slot boundary is determined by a value associated with or configured for the largest sub-carrier spacing.
In one example, slot boundary is determined by a value associated with or configured for the smallest sub-carrier spacing.

In the examples mentioned herein, the spatial resource unit configuration can be provided by system information block (SIB). In one example, SIB can provide one or more sets of spatial resource units for serving cell and for neighboring (or candidate) cells.

In one example, the SIB information for a cell, can include set(s) of spatial resource units for the cell and for neighboring (e.g., candidate cells). The set(s) of spatial resource units can be according to the examples mentioned herein.

In one example, the SIB information for a cell, can include set(s) of spatial resource units for the cell. The UE can receive SIB information from more than one cell, to determine the configuration of the spatial resource units of more than one cell, respectively. In one example, a UE can be configured a list of neighboring (or candidate) cells to receive SIB from, and receive corresponding spatial resource unit configuration.

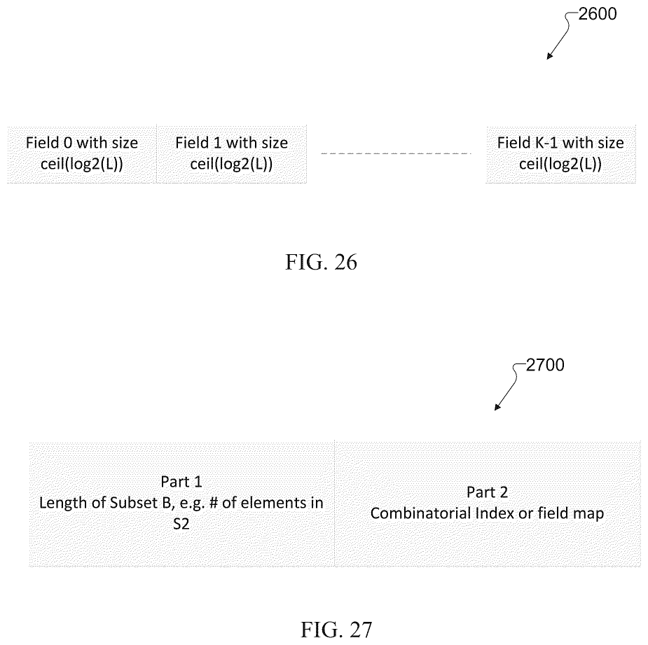

FIG. 26 illustrates a diagram of an example message 2600 for activation according to embodiments of the present disclosure. For example, message 2600 can be transmitted by the gNB 102 of FIG. 2. This example is for illustration only and other embodiments can be used without departing from the scope of the present disclosure.

FIG. 27 illustrates a diagram of an example message 2700 for activation according to embodiments of the present disclosure. For example, message 2700 can be transmitted by the gNB 103 of FIG. 1. This example is for illustration only and other embodiments can be used without departing from the scope of the present disclosure.

Subset(s) S2 are activated from set(s) S1. In one example, the activation of subset(s) S2 is by higher layer signaling, e.g., MAC CE signaling or RRC signaling. In one example, the activation of subset(s) S2 is by L1 control (e.g., DCI) signaling.

In one example S1 has one set, with DL, UL and/or joint spatial resource units, across multiple cells, e.g., serving cell (or RU) and neighboring (e.g., candidate) cells or RUs. In one example, set S1 has L1 elements. In one example, subset S2 with K2 elements is activated from set S1. To activate subset S2 the following examples can be evaluated as described in U.S. Provisional Patent Application No. 63/687,131, filed on Aug. 26, 2024, (herein “the '131 application”) which is incorporated by reference in its entirety.

In one example, to activate K2 elements from set S1 with L1 elements, a message, as illustrated in FIG. 26, with K2 fields is used such that the size of each is ┌log₂ L1┐ bits, and indicates one of the L1 elements of set S1. The size of the message is K2┌log₂ L1┐. In one example, if K2=8 and L1=256, the size of the message activating subset S2 is 64 bits.

In one example, When selecting K2 elements from set S1 with L1 elements, there are

$$( \begin{matrix}L 1 \\ K 2\end{matrix} )$$

choices. A unique combinatorial index can be found for subset S2 {a₀, a₁, . . . , a_{K2-1}}, where aₖ₂ for k=0, 1, . . . , K2−1, corresponds to an element of set S1 (e.g., an index of an element in set S1 in the range 0, 1, . . . , L−1). If a₀, a₁, . . . , a_{K2-1} are arrange in subset S2 such that a₀>a₁> . . . >a_{K2-1}, the index of subset S2 is given by:

$${\sum }_{k = 0}^{K 2 - 1} 〈 \begin{matrix}{a}_{k} \\ K 2 - k\end{matrix} 〉 , where$$

$$〈 \begin{matrix}x \\ y\end{matrix} 〉 = \{ \begin{matrix}( \begin{matrix}x \\ y\end{matrix} ) & x \geq y \\ 0 & otherwise\end{matrix}$$

$$( \begin{matrix}x \\ y\end{matrix} ) = \frac{x !}{( x - y ) ! y !}$$

In one example, the size of the message activating subset B1 is

$$⌈ {log}_{2} ( \begin{matrix}L 1 \\ K 2\end{matrix} ) ⌉$$

bits. In one example, if K2=8 and L1=256, the size of the message activating subset S2 is 49 bits.

In one example, the message activating subset S2 can have one part as described in the '131 application.

In one example, the message activating subset S2 can include two parts as described in the '131 application, for example, a first part indicating the number elements to be activated, and possibly the first of these elements, and a second part indicating the remaining elements, e.g., as a field map or combinatorial index as illustrated in FIG. 27.

In one example, the activated elements (e.g., spatial resource units) of S2 can belong to a same cell. In one example, the activated elements (e.g., spatial resource units) of S2 can belong to up N cells (or RUs). In one example, N can depend on a UE capability. In one example, the N cells or RUs with activated spatial resource units includes the cells or RUs with indicated spatial resource units. In one example, the N cells or RUs with activated spatial resource units includes at least one of the cells or RUs with indicated spatial resource units. In one example, the N cells or RUs with activated spatial resource unit includes a serving cell or RU.

In one example S1 has two set, a first set S11 with DL and/or joint spatial resource units, across multiple cells, e.g., serving cell (or RU) and neighboring (e.g., candidate) cells or RUs, a second set S12 with UL spatial resource units, across multiple cells, e.g., serving cell (or RU) and neighboring (e.g., candidate) cells or RUs. In one example, set S11 has L11 elements, and set S12 has L12 elements.

In one example, subset S21 with K21 elements (spatial resource units) is activated from set S11, subset S22 with K22 elements is activated from set S12. To activate subset S2 the following examples can be evaluated as described in the '131 application,
A field-map similar to that shown in FIG. 26 is used to activate the elements (spatial resource units) of each subset S21 and S22 from the corresponding sets S11 and S12.
A combinatorial index as mentioned herein is used to activate the elements (spatial resource units) of each subset S21 and S22 from the corresponding sets S11 and S12.

In one example, the activation of subset S21 and S22 can be in the same message. In one example, the activation of subset S21 and S22 can be in separate messages. In one example, activation of S21 and/or S22 can be one part as described in the '131 application. In one example, the message activating subset S21 and/or S22 can include two parts as described in the '131 application, for example, when S21 and S22 are activated in a same message, the first part can include the number of elements (spatial resource units) activated in each set, and the second part can include the resource elements being activated as field-map and/or as a combinatorial index.

In one example, the activated elements (e.g., spatial resource units) of S21 and/or S22 can belong to a same cell. In one example, the activated elements (e.g., spatial resource units) of S21 and/or S22 can belong to up N cells (or RUs). In one example, N can depend on a UE capability. In one example, the N cells or RUs with activated spatial resource units includes the cells or RUs with indicated spatial resource units. In one example, the N cells or RUs with activated spatial resource units includes at least one of the cells or RUs with indicated spatial resource units. In one example, the N cells or RUs with activated spatial resource unit includes a serving cell or RU.

In one example subset S2 with K2 elements (spatial resource unit code-points) is activated from S11 and S12, wherein the spatial resource unit code-point can include
Element (spatial resource unit) from set S11 for DL and/or joint spatial resource unit.
Element (spatial resource unit) from set S12 for UL spatial resource unit.
A pair of elements (spatial resource units), one from S11 for DL and/or joint spatial resource units and one from S12 for UL spatial resource unit.

To activate subset S2 the following examples can be evaluated as described in the '131 application.
A field-map or combinatorial index from the following sets S11, S12 and S1a, where S1a is the set of order pairs of set S11 and set S12 as described in the '131 application. In a variant example, only order pairs that correspond to pairs of spatial resource units in a same cell or RU are kept in S1a, others removed, and the indexing is over the spatial resource units that remain in set S1a.
In a variant example, a first field-map or combinatorial index from Sets (S11+S12), and a second field-map or combinatorial index from set S1a as described in the '131 application.
In a variant example, a first field-map or combinatorial index from Set S11, a second field-map or combinatorial index from Set S12 and a third field-map or combinatorial index from set S1a as described in the '131 application.
A super-set S11+ includes set S11 and an empty element E1. A super-set S12+ includes set S12 and an empty element E2. Set S1c is the set of order pairs of set S11+ and set S12+ as described in the '131 application. In a variant example, only order pairs that correspond to pairs of spatial resource units in a same cell or RU or with the empty element are kept in S1c, others are removed, and the indexing is over the spatial resource units that remain in set S1c. In one example, the order pair corresponding to empty elements (E1, E2) is removed as described in the '131 application. A field-map or combinatorial index from set S1c provides the activated elements of subset S2 as described in the '131 application.

In one example, the message activating subset S2 can have one part as described in the '131 application.

In one example, the message activating subset S2 can include two parts as described in the '131 application.

In one example, the activated elements (e.g., spatial resource units) of S2 can belong to a same cell. In one example, the activated elements (e.g., spatial resource units) of S2 can belong to up N cells (or RUs). In one example, N can depend on a UE capability. In one example, the N cells or RUs with activated spatial resource units includes the cells or RUs with indicated spatial resource units. In one example, the N cells or RUs with activated spatial resource units includes at least one of the cells or RUs with indicated spatial resource units. In one example, the N cells or RUs with activated spatial resource unit includes a serving cell or RU.

In one example S1 has two sets, a first set S11 with DL and/or UL and/or joint spatial resource units, across one cell, e.g., a serving cell (or RU), a second set S12 with DL, UL and/or joint spatial resource units, across multiple cells, e.g., neighboring (e.g., candidate) cells or RUs. In one example, set S11 has L11 elements, and set S12 has L12 elements.

In one example subset S2 with K2 elements (spatial resource unit code-points) is activated from S11 and S12, wherein sets S11 and S12 are concatenated together to form a set S1p with size L11+L12, for example, the elements of S1p can be indexed first over S11 and then over S12, or vice versa. A field map or a combinatorial index of elements of S1p can indicate the elements of S2. In one example, the message activating subset S2 can have one part. In one example, the message activating subset S2 can include two parts, e.g., a first part indicating the size of the second part or the number of elements in subset S2. In one example, the activated elements (e.g., spatial resource units) of S2 can belong to a same cell. In one example, the activated elements (e.g., spatial resource units) of S2 can belong to up N cells (or RUs). In one example, N can depend on a UE capability. In one example, the N cells or RUs with activated spatial resource units includes the cells or RUs with indicated spatial resource units. In one example, the N cells or RUs with activated spatial resource units includes at least one of the cells or RUs with indicated spatial resource units. In one example, the N cells or RUs with activated spatial resource unit includes a serving cell or RU.

In one example subset S2 with K2 elements (spatial resource unit code-points) is activated from S11 and S12. Two field-maps from S11 and S12 or two combinatory indices from S11 and S12 or a field-map from S11 or S12 and a combinatorial index from S12 or S11 or one field-map from either S11 or S12, or one combinatorial index from either S11 or S12 can indicate the elements of S2. In one example, the message activating subset S2 can have one part. In one example, the message activating subset S2 can include two parts, e.g., a first part indicating the size of the second part or the number of elements in subset S2 (e.g., number of elements from S11 and number of elements from S12). In one example, the activated elements (e.g., spatial resource units) of S2 can belong to a same cell. In one example, the activated elements (e.g., spatial resource units) of S2 can belong to up N cells (or RUs). In one example, N can depend on a UE (e.g., the UE 116) capability. In one example, the N cells or RUs with activated spatial resource units includes the cells or RUs with indicated spatial resource units. In one example, the N cells or RUs with activated spatial resource units includes at least one of the cells or RUs with indicated spatial resource units. In one example, the N cells or RUs with activated spatial resource unit includes a serving cell or RU.

In one example, subset S21 with K21 elements (spatial resource units) is activated from set S11, subset S22 with K22 elements is activated from set S12. A field-map and/or combinatorial index is used to indicate the activated elements for S21 and for S22. In one example, the activation of subset S21 and S22 can be in the same message. In one example, the activation of subset S21 and S22 can be in separate messages. In one example, activation of S21 and/or S22 can be one part. In one example, the message activating subset S21 and/or S22 can include two parts e.g., a first part indicating the size of the second part or the number of elements in subset S21 or S22. In one example, the activated elements (e.g., spatial resource units) of S22 can belong to a same cell. In one example, the activated elements (e.g., spatial resource units) of S2 can belong to up N cells (or RUs). In one example, N can depend on a UE capability. In one example, the N cells or RUs with activated spatial resource units includes the cells or RUs with indicated spatial resource units. In one example, the N cells or RUs with activated spatial resource units includes at least one of the cells or RUs with indicated spatial resource units.

In one example S1 has four sets, first set, a first set S11 with DL and/or joint spatial resource units, across one cell, e.g., a serving cell (or RU), a second set S12 with UL spatial resource units, across one cell, e.g., a serving cell (or RU), a third set S13 with DL and/or joint spatial resource units, across multiple cells, e.g., neighboring (e.g., candidate) cells or RUs, a fourth set S14 with UL spatial resource units, across multiple cells, e.g., neighboring (e.g., candidate) cells or RUs. In one example, set S11 has L11 elements, set S12 has L12 elements, set S13 has L13 elements, and set S14 has L14 elements.

In one example subset S2 with K2 elements (spatial resource unit code-points) is activated from S11, S12, S13 and S14, a one or more field maps and/or one or more combinatorial indices of following:
A field map or a combinatorial index of a set including S11, S12, pair of elements of S11 and S12, S13, S14, pair of elements of S13 and S14. In one example, the pair of elements correspond to elements (spatial resource units) from the same set.
A field map or a combinatorial index of a set including pair of elements of S11+ and S12+, and a pair of elements of S13+ and S14+. Where, S11+=S11+E1 (empty element), S12+=S12+E2 (empty element), S13+=S13+E3 (empty element), S14+=S14+E4 (empty element). In one example, the pair of elements correspond to elements (spatial resource units) from the same cell, or an element from a cell with an empty element. In one example, pair (E1, E2) is removed. In one example, pair (E3, E4) is removed. In one example, pair (E1, E2) is kept. In one example, pair (E3, E4) is kept.
Two field-maps or two combinatorial indices or a field map and combinatorial index:
   A field map or a combinatorial index of a set including S11, S12, pair of elements of S11 and S12.
   A field map or a combinatorial index of a set including pair of elements of S11+ and S12+. Where, S11+=S11+E1 (empty element), S12+=S12+E2 (empty element). In one example, pair (E1, E2) is removed. In one example, pair (E1, E2) is kept.
   A field map or a combinatorial index of a set including S13, S14, pair of elements of S13 and S14. In one example, the pair of elements correspond to elements (spatial resource units) from the same cell.
   A field map or a combinatorial index of a set including pair of elements of S13+ and S14+. Where, S13+=S13+E3 (empty element), S14+=S14+E4 (empty element). In one example, pair (E3, E4) is removed. In one example, pair (E3, E4) is kept. In one example, the pair of elements correspond to elements (spatial resource units) from the same cell.
A combination of four field-maps or combinatorial indices:
   A field map or a combinatorial index from set S11.
   A field map or a combinatorial index from set S12.
   A field map or a combinatorial index from set S13.
   A field map or a combinatorial index from set S14.
A combination of three field-maps or combinatorial indices:
   A field-map or a combinatorial index from set S11 and S12 including pairs from set S11 and S12 as described herein, and a field-map or combinatorial index from set S13, and a field-map or combinatorial index from set S14.
   A field-map or a combinatorial index from set S13 and S14 including pairs from set S13 and S14 as described herein, and a field-map or combinatorial index from set S11, and a field-map or combinatorial index from set S12.

In the herein examples, a field-map or a combinatorial index from set S1x and S1y (e.g., x=1 or 3, y 2 or 4 respectively), can be replaced by:
A field map or a combinatorial index from set S1x+S1y, and a field map or a combinatorial index from set from set of pairs of elements from S1x and S1y.
A field map or a combinatorial index from set S1x, a field map or a combinatorial index from set S1y and a field map or a combinatorial index from set from set of pairs of elements from S1x and S1y.

In one example, two subsets S21 and S22 with K21 and K22 elements respectively can be activated for S2. In one example, S21 is activated from elements of S11 and S12 or pairs of elements of S11 and S12, e.g. for serving cell, as mentioned herein. In one example, S22 is activated from elements of S13 and S14 or pairs of elements of S13 and S14, e.g. for neighboring cell, as mentioned herein.

In one example, four sets S21, S22, S23 and S24 with K21, K22, K23 and K24 elements respectively can be activated for S2. In one example, S21 is activated from elements of S11 as mentioned herein. In one example, S22 is activated from elements of S12 as mentioned herein. In one example, S23 is activated from elements of S13 as mentioned herein. In one example, S24 is activated from elements of S14 as mentioned herein.

In one example, three sets S21, S22 and S23 with K21, K22 and K23 elements respectively can be activated. In one example, S21 and S22 are activated from elements of S11 and S12, respectively, as mentioned herein, and S23 is activated from elements of S13 and S14 or pairs of elements of S13 and S14 as mentioned herein. In one example, S21 is activated from elements of S11 and S12 or pairs of elements of S11 and S12 as mentioned herein, and S22 and S23 are activated from elements of S13 and S14, respectively.

In one example, the activation of multiple subsets (e.g., S21, S22, . . . ) can be in the same message. In one example, the activation of multiple subsets (e.g., S21, S22 . . . ) can be in separate messages. In one example, activation of S2 (or multiple S2 subsets) can be one part. In one example, the message activating subset S2 (or multiple S2 subsets) can include two parts e.g., a first part indicating the size of the second part or the number of elements in subset(s). In one example, the activated elements (e.g., spatial resource units) of S2 can belong to a same cell. In one example, the activated elements (e.g., spatial resource units) of S2 can belong to up N cells (or RUs). In one example, N can depend on a UE capability. In one example, the N cells or RUs with activated spatial resource units includes the cells or RUs with indicated spatial resource units. In one example, the N cells or RUs with activated spatial resource units includes at least one of the cells or RUs with indicated spatial resource units. The second part can include the TCI states being activated as field-map and/or as a combinatorial index

In one example S1 has N sets, wherein N is the number of serving cell (or RU) and candidate or neighboring cells (or RUs):
a first set S11 with DL or UL and/or joint spatial resource units, for a first cell or RU,
a second set S12 with DL, UL and/or joint spatial resource units, for a second cell or RU,
. . .
A Nth set S1N with DL, UL and/or joint spatial resource units, for a Nth cell or RU

In one example, set S11 has L11 elements, set S12 has L12 elements, . . . set S1N has L1N elements. In one example, L11, L12, . . . L1N are equal. In one example, L12, L13, . . . L1N are equal (in one example, excluding first cell (e.g., serving cell) or RU). In one example, L11, L12, . . . L1N can be different.

In one example subset S2 with K2 elements (spatial resource unit code-points) is activated from S11, S12, . . . S1N, a one or more field maps and/or one or more combinatorial indices of following:
A field map or a combinatorial index of a set including S11, S12, . . . S1N.
A combination of two field-maps or combinatorial indices. A first field map or combinatorial index of set S11. A second field map or combinatorial index of a set including S12, S13, . . . S1N
A combination of J field-maps or combinatorial indices. A first field map or combinatorial index of set S1a₀. A second field map or combinatorial index of set S1a₁ . . . . A Jth field map or combinatorial index of set S1aⱼ₋₁. Wherein, S1aᵢ∈{S11, S12, . . . , S1N} and i=0, 1, . . . , J−1. In one example, S1aᵢ includes S11. In one example, S1aᵢ doesn't includes S11. In one example, J can equal N. In one example, the maximum value of J can equal N. In one example, maximum value of J depends on a UE capability.

In one example, two subsets S21 and S22 with K21 and K22 elements respectively can be activated for S2. In one example, S21 is activated from elements of S11, as mentioned herein. In one example, S22 is activated from elements of S12, S13, . . . , S1N. For S22, the activated elements can be indicated by:
A field map or a combinatorial index of a set including S12, S13, . . . S1N.
A combination of J field-maps or combinatorial indices. A first field map or combinatorial index of set S1a₀. A second field map or combinatorial index of set S1a₁ . . . . A Jth field map or combinatorial index of set S1aⱼ₋₁. Wherein, S1aᵢ∈{S12, S13, . . . , S1N} and i=0, 1, . . . , J−1. In one example, J can equal N−1. In one example, the maximum value of J can equal N−1. In one example, maximum value of J depends on a UE capability.

In one example, J sets 521, S22, . . . S2J with K21, K22, . . . K2J elements respectively can be activated for S2. In one example, S2a is activated from elements of S1aᵢ as mentioned herein. Wherein, S1aᵢ∈{S11, S12, . . . , S1N} and i=1, 2, . . . , J. In one example, S1aᵢ includes S11. In one example, S1aᵢ doesn't includes S11. In one example, J can equal N. In one example, the maximum value of J can equal N. In one example, maximum value of J depends on a UE capability.

In one example, the activation of multiple subsets (e.g., S21, S22, . . . ) can be in the same message. In one example, the activation of multiple subsets (e.g., S21, S22 . . . ) can be in separate messages. In one example, activation of S2 (or multiple S2 subsets) can be one part. In one example, the message activating subset S2 (or multiple S2 subsets) can include two parts e.g., a first part indicating the size of the second part or the number of elements in subset(s), for example the number of elements activated for each subset (or cell). In one example, the activated elements (e.g., spatial resource units) of S2 can belong to a same cell. In one example, the activated elements (e.g., spatial resource units) of S2 can belong to up P cells (or RUs). In one example, P can depend on a UE capability. In one example, the P cells or RUs with activated spatial resource units includes the cells or RUs with indicated spatial resource units. In one example, the P cells or RUs with activated spatial resource units includes at least one of the cells or RUs with indicated spatial resource units.

In one example, S1 has M sets, wherein, M=2N and N is the number of serving cell (or RU) and candidate or neighboring cells (or RUs):
a first set S11 with DL and/or joint spatial resource units, for a first cell or RU,
a second set S12 with UL spatial resource units, for a first cell or RU
a third set S13 with DL, UL and/or joint spatial resource units, for a second cell or RU,
a fourth set S14 with UL spatial resource units, for a second cell or RU,
. . .
A M−1th set S1(M−1) with DL and/or joint spatial resource units, for a Nth cell or RU
A Mth set S1M with UL spatial resource units, for a Nth cell or RU

In one example, set S11 has L11 elements, set S12 has L12 elements, . . . set S1M has L1M elements. In one example, L11, L12, . . . L1M are equal. In one example, L11, L13, . . . L1(M−1) are equal to a first value (e.g., for DL and/or joint spatial resource units), and L12, L14, . . . L1M are equal to a second value (e.g., for UL spatial resource units). In one example, L13, L15, . . . L1(M−1) are equal to a first value (e.g., for DL and/or joint spatial resource units excluding first cell or RU), and L14, L16, . . . L1M are equal to a second value (e.g., for UL spatial resource units excluding first cell or RU). In one example, L11, L12, . . . L1M can be different.

In one example subset S2 with K2 elements (spatial resource unit code-points) is activated from S11, S12, S13 . . . S1M, a one or more field maps and/or one or more combinatorial indices of following:
A field map or a combinatorial index of a set including S11, S12, pair of elements of S11 and S12, S13, S14, pair of elements of S13 and S14, . . . , S1(M−1), S1M, pair of elements of S1(M−1) and S1M. In a variant example, pairs of elements can correspond spatial resource elements of different cells, e.g., elements of S1(2i) and S1(2j−1) can be paired together, where i≠j.
A field map or a combinatorial index of a set including pair of elements of S11+ and S12+, and a pair of elements of S13+ and S14+, . . . an pair of elements of S1(M−1)+ and S1M+. Where, S11+=S11+E1 (empty element), S12+=S12+E2 (empty element), . . . S1M+=S1M+EM (empty element). In a variant example, pairs of elements can correspond spatial resource elements of different cells, e.g., elements of S1(2i) and S1(2j−1) can be paired together, where i≠j. In one example, pair (E1, E2) is removed. In one example, pair (E3, E4) is removed. In one example, pair (E1, E2) is kept. In one example, pair (E3, E4) is kept . . . .
A combination of two field-maps or combinatorial indices. A first field map or combinatorial index of set S11 and S12, e.g., a field map or a combinatorial index of a set including S11, S12, pair of elements of S11 and S12, or a field map or a combinatorial index of a set including pair of elements of S11+ and S12+, as mentioned herein. A second field map or combinatorial index of a set including S13, S14, . . . S1M, e.g., a field map or a combinatorial index of a set including S13, S14, pair of elements of S13 and S14, . . . , S1(M−1), S1M, or a field map or a combinatorial index of a set including pair of elements of S13+ and S14+, . . . an pair of elements of S1(M−1)+ and S1M+.
A combination of J field-maps or combinatorial indices. A first field map or combinatorial index of set S1(2a₀−1) and S1(2a₀), e.g., a field map or a combinatorial index of a set including S1(2a₀−1), S1(2a₀), pair of elements of S1(2a₀−1) and S1(2a₀), or a field map or a combinatorial index of a set including pair of elements of S1(2a₀−1)+ and S1(2a₀)+, as mentioned herein . . . . A Jth field map or combinatorial index of set S1(2aⱼ₋₁−1) and S1(2aⱼ₋₁), e.g., a field map or a combinatorial index of a set including S1(2aⱼ₋₁−1), S1(2aⱼ₋₁), pair of elements of S1(2aⱼ₋₁−1) and S1(2aⱼ₋₁), or a field map or a combinatorial index of a set including pair of elements of S1(2aⱼ₋₁−1)+ and S1(2aⱼ₋₁)+, as mentioned herein. Wherein, aᵢ ∈{1, 2, . . . , M/2}, and i=0, 1, . . . , J−1. In one example, aᵢ includes 1. In one example, aᵢ doesn't includes 1. In one example, J can equal M/2. In one example, the maximum value of J can equal M/2. In one example, maximum value of J depends on a UE capability.
A combination of J field-maps or combinatorial indices. A first field map or combinatorial index of set S1a₀. A second field map or combinatorial index of set S1a₁ . . . . A Jth field map or combinatorial index of set S1aⱼ₋₁. Wherein, aᵢ∈{1, 2, . . . , N} and i=0, 1, . . . , J−1. In one example, S1aᵢ includes S11 and 512. In one example, S1aᵢ doesn't includes S11 or 512. In one example, J can equal M. In one example, the maximum value of J can equal M. In one example, maximum value of J depends on a UE capability. In one example, for a cell or RU j, elements (e.g., spatial resource units) are activated from set S1(2j−1) and set S1(2j).
In a variant example, some cells or RUs, e.g., cell j, has one field-map or combinatorial index from a combined set of S1(2j−1) and S1(2j), and other cells, e.g., cell k, has two field-maps or combinatorial indices from set S1(2k−1) and set S1(2k) respectively.

In the herein examples, a field-map or a combinatorial index from set S1x and S1y (e.g., x=1 or 3, y 2 or 4, . . . respectively), can be replaced by:
A field map or a combinatorial index from set S1x+S1y, and a field map or a combinatorial index from set from set of pairs of elements from Six and S1y.
A field map or a combinatorial index from set S1x, a field map or a combinatorial index from set S1y and a field map or a combinatorial index from set from set of pairs of elements from S1x and S1y.

In one example, two subsets S21 and S22 with K21 and K22 elements respectively can be activated for S2. In one example, S21 is activated from elements of S11 and S12 or pairs of elements of S11 and S12 as mentioned herein. In one example, S22 is activated from elements of S13 and S14 or pairs of elements of S13 and S14, . . . , S1(M−1) and S1M or pairs of elements of S1(M−1) and S1M as mentioned herein.

In one example, J sets S21, S22, . . . S2J with K21, K22, . . . K2J elements respectively can be activated for S2. A first subset is activated from set S1(2a₀−1) and S1(2a₀), e.g., a field map or a combinatorial index of a set including S1(2a₀−1), S1(2a₀), pair of elements of S1(2a₀−1) and S1(2a₀), or a field map or a combinatorial index of a set including pair of elements of S1(2a₀−1)+ and S1(2a₀)+, as mentioned herein . . . . A Jth subset is activated from elements set S1(2aⱼ₋₁−1) and S1(2aⱼ₋₁), e.g., a field map or a combinatorial index of a set including S1(2aⱼ₋₁−1), S1(2aⱼ₋₁), pair of elements of S1(2aⱼ₋₁−1) and S1(2aⱼ₋₁), or a field map or a combinatorial index of a set including pair of elements of S1(2aⱼ₋₁−1)+ and S1(2aⱼ₋₁)+, as mentioned herein. Wherein, aᵢ∈{1, 2, . . . , M/2}, and i=0, 1, . . . , J−1. In one example, aᵢ includes 1. In one example, aᵢ doesn't includes 1. In one example, J can equal M/2. In one example, the maximum value of J can equal M/2. In one example, maximum value of J depends on a UE capability.

In one example, J sets S21, S22, . . . S2J with K21, K22, . . . K2J elements respectively can be activated for S2.

A first subset is activated from elements of set S1a₀. A second subset is activated from elements of set S1aᵢ . . . . A Jth subset is activated from elements of set S1aⱼ₋₁. Wherein, at E {1, 2, . . . , N} and i=0, 1, . . . , J−1. In one example, S1aᵢ includes S11 and S12. In one example, S1aᵢ doesn't includes S11 or S12. In one example, J can equal M. In one example, the maximum value of j can equal M. In one example, maximum value of J depends on a UE capability. In one example, for a cell or RU j, elements (e.g., spatial resource units) are activated from set S1(2j−1) and set S1(2j).

In a variant example, some cells or RUs, e.g., cell j, has one subset activated from a combined set of S1(2j−1) and S1(2j), and other cells, e.g., cell k, has two subset activated from set S1(2k−1) and set S1(2k) respectively.

In one example, the activation of multiple subsets (e.g., S21, S22, . . . ) can be in the same message. In one example, the activation of multiple subsets (e.g., S21, S22 . . . ) can be in separate messages. In one example, activation of S2 (or multiple S2 subsets) can be one part. In one example, the message activating subset S2 (or multiple S2 subsets) can include two parts e.g., a first part indicating the size of the second part or the number of elements in subset(s), for example the number of elements activated for each subset (or cell). In one example, the activated elements (e.g., spatial resource units) of S2 can belong to a same cell. In one example, the activated elements (e.g., spatial resource units) of S2 can belong to up N cells (or RUs). In one example, N can depend on a UE capability. In one example, the N cells or RUs with activated spatial resource units includes the cells or RUs with indicated spatial resource units. In one example, the N cells or RUs with activated spatial resource units includes at least one of the cells or RUs with indicated spatial resource units.

In one example, a message activating spatial relation units, can be a single part message. In one example, a message activating spatial relation units, can be a two-part message, for example, the first part can be a message that determines the size and/or contents of the second part. The part can include the following information:
Number of activated elements (spatial resource units).
Number of cells or RU with activated elements (spatial resource units).
Number of activated elements (spatial resource units) per cell or RU.
Number of activated elements (spatial resource units) across cells or RUs to which the message applies.

In one example, the indication of S3 is by higher layer signaling, e.g., MAC CE signaling or RRC signaling. In one example, the indication of S3 is by L1 control (e.g., DCI) signaling. In one example, the activation of subset S2 and the indication of S3 are in a same signal. In one example, the activation of subset S2 and the indication of S3 is by higher layer signaling, e.g., MAC CE signaling or RRC signaling. In one example, the activation of subset S2 and the indication of S3 is by L1 control (e.g., DCI) signaling.

In one example, spatial resource units can be indicated from M cells or RUs. In one example, M depends on UE capability. In one example, M includes a serving cell or RU (e.g., cell or RU with index 0 or index 1). In one example, M=1. In one example, M=2.

In one example, separate indication messages are used for each cell or RU. In one example, a first indication message is used for indication of spatial resource units of a serving cell or RU (e.g., cell or RU with index 0 or index 1). In one example, a second indication message is used for indication of spatial resource units of a candidate (e.g., neighboring) cell or RU. In one example, a joint indication messages can be used for cells or RUs.

In one example, a message indicating spatial relation units, can be a single part message. In one example, a message indicating spatial relation units, can be a two-part message, for example, the first part can be a message that determines the size and/or contents of the second part. The part can include the following information:
Number of indicated elements (spatial resource units).
Number of cells or RU with indicated elements (spatial resource units).
Number of indicated elements (spatial resource units) per cell or RU.
Number of indicated elements (spatial resource units) across cells or RUs to which the message applies.

In one example, indicated elements (spatial resource units) are from activated elements (spatial resource units). In one example, indicated elements (spatial resource units) are from configured elements (spatial resource units).

In one example, the indicated spatial resource units can become be applied (e.g., for a spatial filter for reception and transmission) based on a time T from the message indicating the spatial resource units. In one example, the time T is from the start of the message carrying the indicated spatial resource units. In one example, the time T is from the end of the message carrying the indicated spatial resource units. In one example, the time T is from the start of the acknowledgment (e.g., on PUCCH or PUSCH) of the message carrying the indicated spatial resource units. In one example, the time T is from the end of the acknowledgment (e.g., on PUCCH or PUSCH) of the message carrying the indicated spatial resource units. In one example, the indicated spatial resource units can be used (e.g., for a spatial filter for reception and transmission) starting at time T determined as mentioned herein. In one example, the indicated spatial resource units can be used (e.g., for a spatial filter for reception and transmission) at a first slot boundary at or after time T determined as mentioned herein. In one example, the indicated spatial resource units can be used (e.g., for a spatial filter for reception and transmission) no later than time T determined as mentioned herein. In one example, indicated spatial resource units can be used (e.g., for a spatial filter for reception and transmission) at a slot boundary no later than time T determined as mentioned herein. Time T can be configured and/or updated by RRC and/or MAC CE and/or L1 control (e.g., DCI Format).

If the spatial resource unit applies to multiple carriers and/or bandwidth parts with different sub-carrier spacing and/or UL and DL directions have different sub-carrier spacings
In one example, time T is determined by a value associated with or configured for the largest sub-carrier spacing.
In one example, time T is determined by a value associated with or configured for the smallest sub-carrier spacing.
In one example, the slot boundary is determined by a value associated with or configured for the largest sub-carrier spacing.
In one example, slot boundary is determined by a value associated with or configured for the smallest sub-carrier spacing.

In one example, a value for T is configured and can be used for indicated spatial resource units in a serving cell or RU or a candidate (e.g., neighboring) cell or RU. In one example, a first value for T is used for indicated spatial resource units in a serving cell or RU. In one example, a second value for T is used for indicated spatial resource units in a candidate (e.g., neighboring) cell or RU.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive configuration information related to transmission configuration indication (TCI) states,
receive configuration information related to measurement reference signals (RSs) for N cells, where N is >1,
receive information indicating associations of the TCI states to subsets of the N cells, respectively, and
receive a first TCI state from the TCI states, wherein:
the first TCI state indicates a spatial relation associated with a first cell from the N cells, and
the first cell is a serving cell;
a processor operably coupled to the transceiver, the processor configured to:
determine a first subset of cells, from the subsets of the N cells, based on the first TCI state, and
perform measurement of RSs associated with the determined first subset,
wherein the transceiver is further configured to transmit a report based on the measured RSs.

2. The UE of claim 1, wherein:
the transceiver is further configured to receive a second TCI state from the TCI states,
the second TCI state indicates a spatial relation associated with a second cell, and
the processor is further configured to determine the second cell as the serving cell.

3. The UE of claim 1, wherein the transceiver is further configured to:
receive configuration information for (i) a control resource set (CORESET) and (ii) a search space set for receiving a physical downlink control channel (PDCCH) of a second cell,
receive the PDCCH from the second cell, and
receive a physical downlink shared channel (PDSCH) scheduled by the PDCCH, wherein the PDSCH includes a system information block (SIB) of the second cell.

4. The UE of claim 1, wherein:
the configuration information related to the TCI states includes configuration information for TCI states of a second cell indicating a spatial relation associated with the second cell,
the configuration information related to the measurement RSs includes configuration information for measurement RSs of the second cell, and
the configuration information for the TCI states of the second cell and the configuration information for measurement RSs of the second cell are included in a system information block (SIB) of the second cell.

5. The UE of claim 1, wherein:
the configuration information related to the TCI states includes configuration information for TCI states of a second cell indicating a spatial relation associated with the second cell,
the configuration information related to the measurement RSs include configuration information for measurement RSs of the second cell, and
the configuration information for the TCI states of the second cell and the configuration information for measurement RSs of the second cell are included in a system information block (SIB) of the first cell.

6. The UE of claim 1, wherein:
the transceiver is further configured to receive a list of cells, and
the first subset of the N cells is determined based on the list.

7. The UE of claim 1, wherein:
the transceiver is further configured to receive a message to activate TCI states in a second subset of the N cells,
the message includes two parts: a first part and a second part,
the first part includes information about a number of activated TCI states and corresponding cells, and
the second part includes a list of activated TCI states.

8. A base station (BS), comprising:
a transceiver configured to:
transmit configuration information related to transmission configuration indication (TCI) states,
transmit configuration information related to measurement reference signals (RSs) for N cells, where N is >1,
transmit information indicating associations of the TCI states to subsets of the N cells, respectively, and
transmit a first TCI state from the TCI states, wherein:
the first TCI state indicates a spatial relation associated with a first cell from the N cells, and
the first cell is a serving cell; and
a processor operably coupled to the transceiver, the processor configured to determine a first subset of cells from the subsets of the N cells based on the first TCI state,
wherein the transceiver is further configured to receive a report based on the measured RSs.

9. The BS of claim 8, wherein:
the transceiver is further configured to transmit a second TCI state from the TCI states,
the second TCI state indicates a spatial relation associated with a second cell, and
the processor is further configured to determine the second cell as the serving cell.

10. The BS of claim 8, wherein the transceiver is further configured to:
transmit configuration information for (i) a control resource set (CORESET), and (ii) a search space set for receiving a physical downlink control channel (PDCCH) of a second cell,
transmit the PDCCH from the second cell, and
transmit a physical downlink shared channel (PDSCH) scheduled by the PDCCH, wherein the PDSCH includes a system information block (SIB) of the second cell.

11. The BS of claim 8, wherein:
the configuration information related to the TCI states includes configuration information for TCI states of a second cell indicating a spatial relation associated with the second cell,
the configuration information related to the measurement RSs includes configuration information for measurement RSs of the second cell, and
the configuration information for the TCI states of the second cell and the configuration information for measurement RSs of the second cell are included in a system information block (SIB) of the second cell.

12. The BS of claim 8, wherein:
the configuration information related to the TCI states includes configuration information for TCI states of a second cell indicating a spatial relation associated with the second cell,
the configuration information related to the measurement RSs include configuration information for measurement RSs of the second cell, and
the configuration information for the TCI states of the second cell and the configuration information for measurement RSs of the second cell are included in a system information block (SIB) of the first cell.

13. The BS of claim 8, wherein:
the transceiver is further configured to transmit a list of cells, and
the first subset of the N cells is determined based on the list.

14. The BS of claim 8, wherein:
the transceiver is further configured to transmit a message to activate TCI states in a second subset of the N cells,
the message includes two parts: a first part and a second part,
the first part includes information about a number of activated TCI states and corresponding cells, and
the second part includes a list of activated TCI states.

15. A method of operating a user equipment (UE), the method comprising:
receiving configuration information related to transmission configuration indication (TCI) states;
receiving configuration information related to measurement reference signals (RSs) for N cells, where N is >1;
receiving information indicating associations of the TCI states to subsets of the N cells, respectively;
receiving a first TCI state from the TCI states, wherein:
the first TCI state indicates a spatial relation associated with a first cell from the N cells, and
the first cell is a serving cell;
determining a first subset of cells from the subsets of the N cells based on the first TCI state;
performing measurement of RSs associated with the determined first subset; and
transmitting a report based on the measured RSs.

16. The method of claim 15, further comprising:
receiving a second TCI state from the TCI states, wherein the second TCI state indicates a spatial relation associated with a second cell; and
determining the second cell as the serving cell.

17. The method of claim 15, further comprising:
receiving configuration information for (i) a control resource set (CORESET) and (ii) a search space set for receiving a physical downlink control channel (PDCCH) of a second cell;
receiving the PDCCH from the second cell; and
receiving a physical downlink shared channel (PDSCH) scheduled by the PDCCH, wherein the PDSCH includes a system information block (SIB) of the second cell.

18. The method of claim 15, wherein:
the configuration information related to the TCI states includes configuration information for TCI states of a second cell indicating a spatial relation associated with the second cell,
the configuration information related to the measurement RSs includes configuration information for measurement RSs of the second cell, and
the configuration information for the TCI states of the second cell and the configuration information for measurement RSs of the second cell are included in a system information block (SIB) of the second cell.

19. The method of claim 15, wherein:
the configuration information related to the TCI states includes configuration information for TCI states of a second cell indicating a spatial relation associated with the second cell,
the configuration information related to the measurement RSs include configuration information for measurement RSs of the second cell, and
the configuration information for the TCI states of the second cell and the configuration information for measurement RSs of the second cell are included in a system information block (SIB) of the first cell.

20. The method of claim 15, further comprising:
receiving a message to activate TCI states in a second subset of the N cells,
wherein the message includes two parts: a first part and a second part,
wherein the first part includes information about a number of activated TCI states and corresponding cells, and
wherein the second part includes a list of activated TCI states.
